(19) United States
(12) Patent Application Publication
(10) Pub. No.: US 2019/0052701 A1
(43) Pub. Date: Feb. 14, 2019

(54) SYSTEM, METHOD AND PLATFORM FOR USER CONTENT SHARING WITH LOCATION-BASED EXTERNAL CONTENT INTEGRATION

(71) Applicant: Yogesh Rathod, Mumbai (IN)

(72) Inventor: Yogesh Rathod, Mumbai (IN)

(21) Appl. No.: 16/101,612

(22) Filed: Aug. 13, 2018

Related U.S. Application Data
(62) Division of application No. 15/068,578, filed on Mar. 12, 2016.
Application No. 15/068,578 is a continuation of application No. PCT/IB2013/058565, filed on Sep. 15, 2013.

(51) Int. Cl. H04L 29/08; H04L 29/06; G06F 17/30; H04L 12/58

(52) U.S. Cl. CPC H04L 67/10; H04L 67/42; H04L 67/22; H04L 51/046; G06F 17/30867

(57) ABSTRACT

A methods, systems, device, server, network, platform and apparatus for enabling user to share one or more types of user created, selected or generated contents with one or more external sources content integration. In one embodiment, a system and method are provided in which an input interface to access user-selection of user content to be shared via the content sharing platform and user-selection of a specific external content item, from one or more sources, distinct from said user content and selectable by a given user from said plurality of different specifically selectable external content items, wherein said specific user-selected external content item comprises a specific locally sourced content item selectable by said given user amongst distinctly locally sourced content items corresponding with said location and an integration engine operated by a digital data processor to integrate said specific external content item with said user content to output a sharable integrated content item; and an output interface to share said sharable integrated content item via the content sharing platform on behalf of said given user.

### COPYRIGHTS INFORMATION

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever. The applicant acknowledges the respective rights of various Intellectual property owners.

### FIELD OF INVENTION

The present invention relates generally to enabling communication among anybody-to-anybody, anywhere, anytime any device for anything based on plurality of innovative ways including based on structured updated status, structured requests, structured shared contents & structured search queries determining connectable users for enabling users to establish connections, presenting associate links of applications, services, objects, interfaces & multimedia types of contents and conducting activities, actions, events, transactions, communications, collaborations, workflows & tasks, matchmaking algorithms including identifying user interactions with related entities and presenting prospective connections and associate links of applications, services, objects, interfaces & multimedia types of contents to each interacted users or entities with each other interacted users or entities and enabling to establishing connections and enabling to conducting activities, actions, events, transactions, communications, collaborations, workflows & tasks among connected users & methods and contexts including locations, profile data, date(s) & time(s), date & time ranges, type(s) of activities, actions, events, transactions, communications, collaborations, workflows & tasks, selected or matched or preferred or suggested contextual connectable users and/or interacted entities or users based on match matching of each other's structured updated status & selective user data and any combination thereof. User can post structured updated status and/or request(s) and/or system automatically post structured updated status and/or request(s) based on monitoring, tracking & storing of one or more activities, actions, events, transactions, communications, collaborations, interactions, sharing, participations, workflows, tasks, senses, behavior, current or check-in location(s) or place(s) for identifying, determining, suggesting & presenting prospective, candidate, suggested, ranked, updated connections or connectable users to user and enabling user to search, match, filter, identify, access & select from presented list(s) of connections or connectable users and dynamically access, select, attach, detach, order, sort, share associate links of one or more applications, services, interfaces, objects, lists, profiles, user data, user profile objet, groups, social networks, contacts, social graphs, activities scream, multimedia types of contents & databases for conducting one or more activities, actions, events, transactions, communications, collaborations, interactions, sharing, participations, workflows & tasks with connected, selected & related users.

In another embodiment messaging and/or communications is/are enabled among users of network(s) based on matchmaking preferences, auto matchmaking, similar product and/or service users or customers, user's current activities, actions, senses, locations, transactions, events, places, languages, match making preferences, searching, selections, user inputs, user connections, contacts, relationships, affiliation, like minded users. Present invention enables user to communicate with anybody and not restricted to communicate with only known connections and contacts. This type of system is dedicated to users who want to connect, communicate, collaborate & participate with anybody i.e. other users or like-minded users who are also like to connect, communicate, collaborate & participate with anybody based on plurality types of contexts, factors, rules, multidimensional environments, searching & match making algorithms, data analysis, data mining & text analysis, criteria, functions, keywords, locations, qualifications, income ranges, current places & locations, languages and user data. When user starts the system that means they want to and like to communicate with any other users of network(s). Platform take care of disclosing of user identity, user's real profile, payment information, not like minded users, languages of text, text filtration, monitoring user's activities including message contents or words of message and automatically determining matchmaking, removal or blocking of unwanted users from communications sessions, channels or networks or platforms.

### BACKGROUND OF THE INVENTION

At present some social networks enables users to provide or post updated status based on suggested keywords, named entities, nodes of networks and enable to auto fill-ups or auto complete keywords. User can post updated status and connected or related users of user can view and access updated status. U.S. Pat. No. 8,521,661 teaches generating a list of candidate connections include objects, entities, concepts or other users not connected to the user in the social networking system and predicting the likelihood of a connection between the user and each candidate connection, the likelihood calculated responsive to historical user data within the social networking system, wherein predicting the likelihood comprises using a machine learning algorithm, the machine learning algorithm trained using historical data collected about user interactions in the social networking system. Abstract of U.S. Pat. No. 8,521,661 discloses that “to enhance the experience of the users of a social networking system while increasing value to the social networking system, embodiments of the invention suggest that a user takes an action within the social networking system, where the suggestion is based on the likelihood that the user will perform the suggested action as well as the value to the social networking system if the user does so. In one embodiment, the suggested action may include any interaction within the social networking system, such as joining a group, becoming a fan of a non-user entity, liking an object or an advertisement, confirming attendance at an event, sending a message to another user, tagging a user in an image, or any other type of interaction a user may perform within the social networking system. In another embodiment, the suggested action is for the user to form a new connection or request a new connection with another user of the social networking system. In other embodiments, the suggested action may include a user forming a connection with or requesting a new connection with an object, event, advertisement, entity or concept within the social networking system. The suggestions may be provided to a user in a certain portion of an interface, such as a portion of a web page that contains other content. Alternatively, the suggestions may be provided responsive to an action by the user, such as the submission of a search query, accepting or sending a connection request, liking or commenting on an item, posting or answering a question on a social network.”

At present users are using pluralities of instant messengers for communicating with connected or related users. Some instant messengers also enable users to search available unknown users for messaging or communicating with them.

None of the instant messenger enables users to connect, communicate and messaging among and/or with any other user(s) of instant messenger network(s) based on plurality of automatically and/or expert mediated and/or execution and using of one or more types of methods, modules, functions and/or instructions and/or determined context, semantic syntax, ontology, taxonomy, categories, user(s) requirements or real time or on demand sending of dynamic free form and/or structured request, domain or subject specific keywords database, artificial intelligence, categories, multi-dimensional environment, formatting, indexing, processing and analyzing & mining user data, keywords of or associate with messages, contents & user activities for communicating with particular types of users of network(s).

None of the prior arts enabling users that present invention enables user(s) or group(s) of users to post structured updated status and/or requests based on inputting & selecting pre-created or updated or collaboratively updated generalized or standardized parts of structured updated status and/or requests including types of activities, actions, events, transactions, purposes, user actions, named entities, nodes, items, objects, fields, rules, syntax, locations, keywords, categories, date(s) & time(s) and enabling 115 sever(s) to receive, store, process structured updated status and/or requests and/or user data and/or automatically monitor track, record, store & process user's activities, actions, events, transactions, interactions, senses, behavior, communications, collaborations, sharing, participations, workflows, tasks & requirements and/or enabling to search, match, determine, select & present prospective, suggested, candidate, matched, relevant & contextual connections or connectable user(s) and dynamically presented or suggested or associated or attached links including link(s) of application(s), service(s), object(s), interface(s) & multimedia type(s) of content(s) to user(s) or entity/entities of network(s) and enable user(s) or entity/entities of network(s) to dynamically establishing connections and/or dynamically conducting one or more activities, actions, events, transactions including e-commerce transactions & deals, interactions, communications, collaborations, sharing, searching, presentations, participations, workflows & tasks with one or more selected user(s) or entity/entities of network(s) from presented prospective, suggested, candidate, matched, relevant & contextual connections or connectable user(s) based on provided or associated or presented or suggested one or more or group(s) of links of application(s), service(s), object(s), interface(s) & multimedia type(s) of content(s).

Present invention enables user to connect with input, selection, purpose, activity specific other contextual users which are note in user's connection or contact list and are not able to directly connect, collaborate & communicate with them. User or request can determine requirement of connection types or send requirement request to server or server can monitors, tracks, detects, identifies, senses updates & stores user's activities, actions, events, senses, transactions, interactions, behavior, locations & user data and determine connections based on said user(s) related or associate data and/or request(s) data and connect user or requestor with other users or requestors to enabling them to conduct plurality types of activities, actions, transactions, events, interactions, registering, accessing, messaging, communication, sharing, searching, collaboration and participating activities of each other. User can earn and/or purchase points, ranks & weights based on various types of factors, rules, policies & criteria and can connect particular number of times for particular number of users having particular ranks & weights for particular number and/or times of sessions.

Therefore, it is with respect to these considerations and others that the present invention has been made.

No prior art enables user of instant messenger or any types of communication interface to communicate, messaging and connect with real time and on demand requested users of network based on user's request data.

### OBJECT OF THE INVENTION

The principal object of the present invention is to enabling user to post structured updated status and/or requests based on inputting & selecting pre-created or updated or collaboratively updated generalized or standardized parts of structured updated status and/or requests including types of activities, actions, events, transactions, purposes, user actions, named entities, nodes, items, objects, fields, rules, syntax, locations, keywords, categories, date(s) & time(s) and enabling 115 sever(s) to receive, store, process structured updated status and/or requests and/or user data and/or automatically monitor track, record, store & process user's activities, actions, events, transactions, interactions, senses, behavior, communications, collaborations, sharing, participations, workflows, tasks & requirements and/or enabling to search, match, determine, select & present prospective, suggested, candidate, matched, relevant & contextual connections or connectable user(s) and dynamically presented or suggested or associated or attached links including link(s) of application(s), service(s), object(s), interface(s) & multimedia type(s) of content(s) to user(s) or entity/entities of network(s) and enable user(s) or entity/entities of network(s) to dynamically establishing connections and/or dynamically conducting one or more activities, actions, events, transactions including e-commerce transactions & deals, interactions, communications, collaborations, sharing, searching, presentations, participations, workflows & tasks with one or more selected user(s) or entity/entities of network(s) from presented prospective, suggested, candidate, matched, relevant & contextual connections or connectable user(s) based on provided or associated or presented or suggested one or more or group(s) of links of application(s), service(s), object(s), interface(s) & multimedia type(s) of content(s).

The other principal object of the present invention is to enable user(s) to dynamically connect with other users of network(s) based on dynamic request(s); dynamically receiving request(s); dynamically determine connection(s) or user(s); dynamically present request(s) specific accessible link(s) of connection(s) or user(s) and/or enable requestor user(s) to dynamically connect with determined connections or user(s) and/or dynamically connect requestor user(s) with determined connections or user(s) and/or connect requestor user(s) with determined connections or user(s); dynamically present requestor user(s) and/or connected user(s) specific resource(s); and enable user(s) to dynamically communicate, request, collaborate, participate with connected users and/or resources associate with connected user(s) of user(s) via accessed, installed, subscribed, invoked, selected, connected, executed & used resource(s).

The other principal object of the present invention is to determining potential or prospective or candidate connections for user; generating a list of potential or prospective or candidate connections not connected to the user; presenting a list of potential or prospective or candidate connections not connected to the user; enable user to make new connections and/or connect from a list of potential or prospective or candidate connections not connected to the user.

The other principal object of the present invention is to enable user and/or potential or prospective or candidate connections to select, attach, set, apply, associate, share, send, present potential or prospective or candidate actions with one or more candidate connections not connected to the user; present list of actions associated with each potential or prospective or candidate connections not connected to the user; and enabling user to access one or more user actions associate with each potential or prospective or candidate connections not connected to the user(s).

The other principal object of the present invention is to enable user to register, create, define, generate, update, customize, store one or more accessible user(s) object(s) link(s) or user(s) link(s) or link(s) including search, match, select, purchase, download, customize, install, subscribe, update, attach, associate, integrate, upload one or more applications, services, objects, user actions, functions, controls, forms, interfaces, one or more types of multimedia contents including text, video, voice, images, photos, URLs or links & documents, all or selective user data including user generated data, shared data, received data, activities stream, user profile, user connections and one or more types of resources and apply access privacy settings & preferences; enable user to send, post, publish, advertise, broadcast, synchronize, present, provide, share accessible user(s) object(s) link(s) or user(s) link(s) or link(s); enable other users to access said user(s) object(s) link(s) or user(s) link(s) or link(s) to take one or more actions including view, access, share user contents including provided user data, comments, reviews, blogs, shard data, applications, services, objects, participate with activities, conduct e-commerce transactions, connect, communicate, collaborate with user, share with user, add to contacts or connections, like or dislike user(s).

The other principal object of the present invention is to enable user to define how to connect user by other users; enable other users to connect users based on definition; and enable connected users to communicate, collaborate, share, send and/or receive messages or contents, make new connections, conduct one or more types of activities, actions, events, transactions, tasks, workflow & participate with each other.

The other principal object of the present invention is to enable user to define for presenting links of other users or enable user to define for enabling other users to connect with user; enable user to connect with other users based on definition; and enable connected users to communicate, collaborate, share, send and/or receive messages or contents, make new connections, conduct one or more types of activities, actions, events, transactions, tasks, workflow & participate with each other.

The other principal object of the present invention is to enabling user(s) to connect with other users or group(s) of users for one or more type(s) of purpose(s); connecting user(s) to other user(s) based on type(s) of purpose(s); presenting, associating or attaching purpose(s) specific link(s); enabling user(s) to use or access purpose(s) specific said link(s); and enable user(s) to purpose(s) specific participation with connected users.

The other principal object of the present invention is to monitor, track, detect, sense, input, access, search, match, filter, select, update, infer, identify entities who interact with user and entities to whom user interact with them or user interacted entities; identifying, searching, matching, receiving, importing, detecting or recognizing or sensing, inputting, selecting and/or storing and/or updating and/or processing information about user interactions with other entities

The other principal object of the present invention is to search, match, select, add, update, invite, import, process, remove, attach, detach, sort, rank, determine, identify one or more or one or more set(s) or group(s) of connections based on updated user interaction(s) data and/or user data; present, provide, update, add, remove, attach, detach, send, publish, share, synchronize, store, process, format, bookmark, allow to access said one or more or one or more set(s) or group(s) of connections and/or information about said one or more or one or more set(s) or group(s) of connections; enable user to search, match, filter, sort, rank, bookmark, share, select & connect with other user(s) and/or connect user(s) with other user(s) and/or automatically connect user(s) with other user(s); and enable user(s) to conduct plurality types of activities, actions, events, transactions, workflows, tasks, participations, presentation of information, communications, collaborations, providing & receiving of services, taking one or more user actions and sharing with each other.

The other principal object of the present invention is to storing & updating prospective or candidate parts of structured updated status/request(s) and enabling user(s) to provide updated status/request(s) based on selecting and/or inputting from parts of structured updated status/request(s) comprising: storing & updating prospective part of updated status/request(s) including keywords, categories, nodes, items, objects, commands, date & time ranges, named entities including brand names & contacts, types of activities, actors, actions, purposes, contents, interest, events, status & transactions, grammar, parts, profile fields, values, properties & metadata, location names, rules, values, numbers, fields & associate values or ranges and syntax language; enabling user to input, select, draft, edit, update & provide updated status/request(s) based on searching, matching, filtering, selecting from parts of structured updated status/request(s) or suggested parts of structured updated status/request(s) and/or automatically identifying, updating & preparing updated status/request(s) based on monitored, tracked, detected, sensed, recognized, identified & stored user's activities, actions, events, interactions, locations, places & transactions via automatically searching, matching, filtering, selecting, sequencing or ordering from parts of structured updated status/request(s); verifying and/or validating syntax of updated status/request(s) including matching keywords with parts of structured updated status/request(s), sequences or order of keywords, existing of master keywords of structured updated status/request(s) in/at global database(s), syntax, grammar & spellings of updated status/request(s), minimum and/or maximum ranges or values, associate rules and auto correcting errors & providing errors, solutions & suggestions; and enabling user to post, auto post, suggest, share, publish, broadcast, advertise, send to selected, synchronize, update, provide, save, discard updated status/request(s).

The other principal object of the present invention is to presenting real-time interface for viewing, accessing, sharing, synchronizing, identifying, selecting, send invitation for adding to contacts & connecting, creating and/or inviting and/or adding to groups or social networks arranging, sorting, ordering, ranking, connecting, conducting one or more activities, actions, events, transactions, communications, collaborations, searching, sharing, participations, workflow & tasks with/from/to/in/at/on/by/via presented connectable users and prospective connections among them and/or connected users and associate selective or permitted data related to communications, participations, sharing, collaborations, activities, actions, events, transactions, workflow & tasks based on one or more criteria, rules, filters, search & matchmaking queries comprising enabling user(s) to input, select, update one or more search criteria, match making preferences, filters, categories, keywords, lists, fields & associate value(s) or rang(s) of value(s), location(s), date(s) & time(s) or date & time range(s), select past, present or current or line & prospective or future type, type of users or connectable users or entities, user contacts or connections, named entities, nodes, activities, actions, events, transactions, communications, collaborations, participations, sharing, workflow & tasks; present set(s) or group(s) of identified, portable, accessible link(s) or object(s) or interface(s) of connectable & connected users or entities and indication of connections and/or prospective connections among them and associate indications of conductions of and/or enablement via associate or provided or presented links for conducting of one or more types of activities, actions, events, transactions, communications, collaborations, participations, sharing, workflow & tasks among them; and enabling user to navigate, browse, explore, search, match, filter, attach, detach, monitor, track, subscribe, link, map, store, share, synchronize, advertise, publish, post, send, send to, refer, suggest, tag, sort, rank, creating group(s) or social network(s), mining or analyzing data, present based on selected view type(s), save or update selective, bookmark, rearrange, order, orchestrate, choreograph, sequence, make one or more types of formation, add or update or provide comments, reviews, ranks, notes, one or more types of multimedia content(s), accessible links of applications, services, objects, interfaces & multimedia types of content(s), real-time update, visually view or make connections or suggested connections or mapping or linking, connect, disconnect, invite to add them to contacts, auto and/or manually select for presenting of advertisement(s) in real-time, view & access associate data & links of applications, services, objects, interfaces & multimedia type(s) of content(s) related to or conduct one or more types of activities, actions, events, transactions, communications, collaborations, participations, sharing, workflow & tasks, providing support, identifying prospective customers, make offers or deals or participate in offers or deals, assign, monitor, track, manage, plan, schedule workflow, tasks & jobs, view updated status & activities, actions, events, transactions, communications, collaborations & workflow, present or update or push information or data, present and/or receive structured forms including survey forms, create, add member(s) and/or link(s), invite for & access workspace(s), purchase, bid & order & access from/to/via/in/on/at/within/by said presented or selected one or more or set(s) or group(s) of identified, portable, accessible link(s) or object(s) or interface(s) of connectable, prospective connections & connected users or entities and associate data related to one or more types of activities, actions, events, transactions, communications, collaborations, participations, sharing, workflow & tasks and/or associate or presented or attached or updated or suggested links.

The other principal object of the present invention is to enabling user(s) to input, select, update one or more search criteria, match making preferences, filters, categories, keywords, lists, fields & associate value(s) or rang(s) of value(s), location(s), date(s) & time(s) or date & time range(s), select past, present or current or line & prospective or future type, type of users or connectable users or entities, user contacts or connections, named entities, nodes, activities, actions, events, transactions, communications, collaborations, participations, sharing, workflow & tasks; enabling user to provide, select, update & input name of button and attach or associate or integrate or package with button selected or updated connectable users from said searched, matched, presented, identified, suggested, selected & matched list or set of connectable users;

enabling user to configure, customize, add or update metadata, apply privacy settings & preferences of access, update & generate button(s); presenting accessible button(s); enabling user to search, match, select, sort, group(s), categories, filter accessible button(s) and post, share, synchronize, publish, broadcast, advertise, making them searchable, enable for subscription based on one or more types of payment models, send, send to one or more selected and/or group(s) of connected or related users; and enabling viewing or receiving or subscriber users to search, match, sort, filter, select, purchase, subscribe, customize, use, stores, host, re-share, distribute, access, attach & integrate button(s) with one or more web sites, web pages, applications, services, servers, devices, databases & networks.

The other principal object of the present invention is to enabling user(s) and/or group(s) of user(s) and/or server(s) and/or system(s) to manually and/or automatically adding, drafting, inputting, selecting, editing, updating, ordering, sequencing, orchestrating, choreographing, real-time modifying programming instructions based on standardized syntax for programming of user's plurality types of connections needs; storing, updating, saving, processing, formatting standardized syntax based programming instructions; verifying, validating, compiling, detecting & present or correcting errors or suggesting for errors for standardized syntax based programming instructions; executing, running, implementing standardized syntax based programming instructions; determining, searching, matching, identifying, selecting, purchasing, ranking, ordering, sorting, presenting programmed instruction(s) specific connections or connectable users & connected users; enabling user(s) to connect with presented connectable users or connections including prospective connections; and enabling user(s) to access one or more links associate with one or more connectable users or connections including prospective connections and/or one or more type(s) of purposes, updated status, requests, activities, actions, events, transactions, communications, collaborations, participations, sharing, workflows & tasks.

The other principal object of the present invention is to providing user instant messenger which enables user to communicate and connect with any other users of network based on plurality of automatically and/or manually determined conditions, criteria, rules, factors, match making, preferences, filtration, categorization of users based on user's multidimensional data, user profile, user's activities, actions, events, transactions, free form of user's dynamic & real time requirement of connections, messaging and communications. User can input, search, match, select, select from text, use auto fill-up text, structured syntax or commands, list of pre-created keywords or sentences, templates for selecting and/or inputting and posting, requesting, publishing user's requirement of communications, messaging and connections. For example user input requirement that “I want to communicate and connect with Samsung Galaxy s4 users” and system automatically determined match users and availability of matched users who are using Samsung Galaxy s4 based on that users profile, user data, user's activities, actions, events, transactions, senses, behavior, interactions, locations, places, languages, identified mobile device(s) of user, user's social graph, user's generate data and any data related to user(s) and/or connected user(s) of user and connecting requested user(s) with said matched users.

The other principal object of the present invention is to enable to connecting anybody to anybody or any digital object to any other digital object based on plurality of contexts for conducting plurality types of activities, actions, transactions, events, interactions, registering, accessing, messaging, communication, sharing, searching, collaboration and participating activities of each other.

The other object of the present invention is to connecting nearly all users of internet and smart phones based on associate plurality types of contexts, need, requirements, locations, date & time, availability, matching user data and/or request data with other users' data and/or requests data for conducting plurality types of activities, actions, transactions, events, interactions, registering, accessing, messaging, communication, sharing, searching, collaboration and participating activities of each other.

### DETAIL DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “receiving” requests, structured updated status, links, responses, communications and any types of multimedia contents from a device or component includes receiving the requests, structured updated status, links, responses, communications, and any types of multimedia contents indirectly, such as when forwarded by one or more other devices or components. Similarly, “sending” an item, requests, structured updated status, links, responses, communications, and any types of multimedia contents to a device or component includes sending the items, requests, structured updated status, links, responses, communications, and any types of multimedia contents indirectly, such as when forwarded by one or more other devices or components.

As used herein, the term “client application” refers to an application that runs on a client computing device. A client application may be written in one or more of a variety of languages, such as ‘C’, ‘C++’, ‘C#’, ‘J2ME’, Java, ASP.Net, VB.Net and the like. Browsers, email clients, text messaging clients, calendars, and games are examples of client applications. A mobile client application refers to a client application that runs on a mobile device.

As used herein, the term “network application” refers to a computer-based application that communicates, directly or indirectly, with at least one other component across a network. Web sites, email servers, messaging servers, and game servers are examples of network applications.

Briefly stated, the present invention is directed towards enabling connecting with anybody to anybody based on matching user's structured updated status, request(s) & user data with other user's structured updated status, request(s) and user data and connecting matched, relevant, contextual users for establishing communication links or communication sessions among structured updated status and/or automatically identified and/or request(s) specific connected users for conducting plurality types of activities, actions, transactions, events, interactions, registering, accesses, messaging, communication, sharing, searching, collaboration and participating activities of one or more connected users.

Mechanisms of the invention may enabling user to post structured updated status and/or requests based on inputting & selecting pre-created or updated or collaboratively updated generalized or standardized parts of structured updated status and/or requests including types of activities, actions, events, transactions, purposes, user actions, named entities, nodes, items, objects, fields, rules, syntax, locations, keywords, categories, date(s) & time(s) and enabling 115 sever(s) to receive, store, process structured updated status and/or requests and/or user data and/or automatically monitor track, record, store & process user's activities, actions, events, transactions, interactions, senses, behavior, communications, collaborations, sharing, participations, workflows, tasks & requirements and/or enabling to search, match, determine, select & present prospective, suggested, candidate, matched, relevant & contextual connections or connectable user(s) and dynamically presented or suggested or associated or attached links including link(s) of application(s), service(s), object(s), interface(s) & multimedia type(s) of content(s) to user(s) or entity/entities of network(s) and enable user(s) or entity/entities of network(s) to dynamically establishing connections and/or dynamically conducting one or more activities, actions, events, transactions including e-commerce transactions & deals, interactions, communications, collaborations, sharing, searching, presentations, participations, workflows & tasks with one or more selected user(s) or entity/entities of network(s) from presented prospective, suggested, candidate, matched, relevant & contextual connections or connectable user(s) based on provided or associated or presented or suggested one or more or group(s) of links of application(s), service(s), object(s), interface(s) & multimedia type(s) of content(s). Mechanisms of the invention may also enable user to access dedicate interface, web site, web page, application, service, apparatus, method, system, object, plug-in, integrated button, device, network, platform, framework, database, server for dynamically establishing structured updated status, request(s) or purpose specific connection(s) and/or automatically determined and present prospective connection(s) based on monitoring, tracking & storing of user's activities, actions, events, transactions, behavior, senses, communications, collaborations, participations, workflows & tasks with other user(s) of one or more networks, web sites, applications, services, servers, devices, databases for messaging, communication, collaboration, ask questions, provide answers, provide human services, provide and/or receive search results, share contents, collaboratively conduct searching, matching, payments, purchasing, consulting, and like.

In one embodiment present invention enabling user(s) to send request(s) data 401 for connecting with other users of network(s); determining user(s) of network(s) based on request(s) data; and enabling requestor user(s) and determined user(s) of network(s) to connecting, communicating, collaborating, sharing, searching, creating social network(s), participating with activities of and messaging with each other(s).

In one embodiment network(s) may comprises communication, messaging & social network(s), users of networks, internet network, platforms, applications, services, web services, web sites, devices, databases, communication channels, peer to peer networks, visitors or guest users, set or pool or group(s) of registered and/or unregistered users.

In one embodiment enabling user to update or provide additional details or provider requested additional details for one or more request(s).

In one embodiment request(s) data 401 may comprises user input(s) and/or user selections of/from keyword(s), user selections via one or more types of controls including list, combo box, check box, radio button, auto-fill keyword(s), template(s), script(s), pre-created or user created or system created or 3^{rd} parties or experts created list(s), criteria, conditions, rules, search syntax, characters, words, phrases, sentence, commands, dictionaries, thesaurus, semantic syntax, structured query language (SQL) query, message, content, data structure, suggested or alternative request data or keywords, dynamically or auto generated list based on users senses, current locations & events, auto detecting users from video or voice, voice to text, digital pen to text, rich text format, video or image to text, match making preferences, privacy settings, ontologies, query or question, categories, taxonomies, structured data, database fields, database, user properties, attributes, context data, user profile, user connections or contacts, social graph data, user activities, actions, events, transactions, senses, behavior, interactions, locations, languages related data, list or contact list(s) of connected or related users, list or data of providers of products and/or services, brands, users, companies, organizations, schools, collages, class & year of schools and or collages, users of particular web sites, products, applications, services, devices, social networks, communications, search engines, e-commerce web sites and any types of entities and identification data, language selections, metadata, invitations, multi media types of data including image, video, photo, text, URL or Link, audio, music, icon, graphic, application, document, database, record of database, object, binary instruction and settings including connecting users with other users for particular request data as per schedule, connect me at particular date and/or time or ranges for particular request data, limiting number of connected users for particular request data, use my present or current locations & places, use my selective profile or user data or connected users data and any combination thereof.

In one embodiment determining of user(s) may base on request(s) data of one or more user(s) and/or plurality types of requestor user(s)' data and/or connected user(s) of requestor user(s)' data and/or data of user(s) of network(s) and/or invitations and/or privacy settings, security policies, refights & privileges or permissions & preferences, past determined users, ranked or bookmarked users by requestor(s) and requestors of network(s).

In one embodiment request(s) data may suggested and provided by one or connected or related users and/or users of network(s) and/or expert(s) and/or 3^{rd} parties' providers.

In one embodiment inviting or sending request message(s) or link(s) to one or more to non-users or non-members or sources to downloading, installing, using or accessing online and/or offline and/or subscribing and/or integrating and/or joining or registering with anybody, anywhere, anytime, any device for anything communication, participating with one or more types of activities, features, web sites, applications, services, databases, servers, devices, social networking & messaging network(s) based on user(s) request(s) and/or user(s) references.

In one embodiment requesting, determining, connecting may conducting in real time and/or near real time.

In one embodiment requesting, determining, connecting, posting and sending or posting or publishing of contents to auto matched & connected users in one step.

In one embodiment enabling user(s) to post or share or publish or synchronize data or send inputted, drafted, edited, updated, selected instant message(s) and send request of matched users for connecting and communicating with them via single button.

In one embodiment enabling user(s) to directly use & access anybody, anywhere, anytime, any device for anything application(s), feature(s), button(s), service(s), web site(s), interface(s) via registration.

In one embodiment enabling user(s) to directly use & access anybody, anywhere, anytime, any device for anything application(s), feature(s), button(s), service(s), web site(s), interface(s) without registration.

In one embodiment enabling user(s) to send request first and then select or determine users from list of auto presented or determined users for connections and communications.

In one embodiment enabling user(s) to search, match, select, draft, save, edit, add, update and post one or more request(s) data.

In one embodiment enabling user(s) to communicate, connect and messaging with user(s) related to one or more request(s).

In one embodiment enabling user(s) to switch two or more request(s) specific connected or matched user(s) for communications and messaging.

In one embodiment dynamically adding or removing, presenting or hiding, maximizing or restoring or minimizing, cascading, ordering, opening closing & invoking send & received messages or contents or applications presentation interface based on switching.

In one embodiment dynamically and real time determining, updating and adding matched users for communication, participating, connecting and messaging with requestor(s) for each request.

In one embodiment dynamically and real time determining, updating and adding matched users are based on message contents, user availability, updating user(s) activities and user data.

In one embodiment enabling user to set privacy settings to limit number of users are connected for each request.

In one embodiment enabling user to dynamically and/or real time add, invite and remove users from each communication session for each request.

In one embodiment enable user to connecting with other users of network(s).

In one embodiment limiting number of users who can connect with user.

In one embodiment enabling user to bookmark user(s) and/or invite or sent request for connection to user(s) for creating new connection(s) and/or add to contact(s) and/or provide rank(s), comments and categories to user(s) for commutation, messaging, chatting, calling, sending SMS, instant messaging, e-mailing, referring, asking for availability, request for detail or selective user data, participating with activities, creating social networks or groups and connecting for one or more purposes, tasks, workflow, questioning & answering, sending and/or receiving updates and like.

In one embodiment user may comprises general user, user of network, registered user, un-registered user, connected or related user, visitor, group(s) of user(s), expert(s), administrator(s), web site(s), search engines, social networks, peer to peer networks, web page(s), application(s), web service(s), database(s), communication channels, device(s), server(s), automated source(s), automated destination(s), sensor(s), products and services providers, developers of applications & services, provider of data & contents and any types of entities including company, shop, mall, building, tree, organization, trust, government, press & media, and users on behalf of other user.

In one embodiment processing request data may comprising formatting, indexing text data mining including text categorization, text clustering, concept/entity extraction, production of granular taxonomies, sentiment analysis, document summarization, and entity relation modeling (i.e., learning relations between named entities), text analytics including information retrieval, lexical analysis to study word frequency distributions, pattern recognition, tagging/annotation, information extraction, data mining techniques including link and association analysis, visualization, and predictive analytics to turn text into data for analysis via application of natural language processing (NLP) and analytical methods, analysis of data including process of inspecting, cleaning, transforming, and modeling data with the goal of discovering useful information, suggesting conclusions, and supporting decision making, converting to appropriate format including language, voice to text, text to voice, structured data, identify text data in image or video, validating & verifying text language and syntax of text, spell or grammar checking, determining, matching, identifying users or receivers for connecting requester(s) with matched user(s) of network(s) based on plurality types of factors including matching sender user's profile, user data, activities, actions, interactions, behavior, purpose, locations, events & transactions data, location, message(s) contents with prospective receiving users or users of network(s)' data, preferences, privacy settings, profile, location, activities, actions, interactions, behavior, purpose, locations, events & transactions data, calculating points & ranks earned by sender(s) and/or prospective receivers or users of network(s) for identifying & determining targeted receiving users or users of network(s) for connecting requestor with matched or determined users of network(s), identifying availability and presence information of prospective receivers or determined users of network(s), dynamically identifying current or updated priorities and limits of receiving messages of prospective receivers or determined users of network(s), applying privacy settings and preferences, associating metadata including keywords, categories, semantic syntax, ontologies, context data and system data including date & time.

In one embodiment message or contents of sender may comprises one or more types of media including text, keywords, list, image, video, voice, photo, URL or link, audio, document, object, application, database, data record, template, forms and search result.

In one embodiment processing message(s) or content(s) may comprises formatting, indexing, text data mining including text categorization, text clustering, concept/entity extraction, production of granular taxonomies, sentiment analysis, document summarization, and entity relation modeling (i.e., learning relations between named entities), text analytics including information retrieval, lexical analysis to study word frequency distributions, pattern recognition, tagging/annotation, information extraction, data mining techniques including link and association analysis, visualization, and predictive analytics to turn text into data for analysis, via application of natural language processing (NLP) and analytical methods, encrypting, decrypting, compressing, uncompressing, analysis of data including process of inspecting, cleaning, transforming, and modeling data with the goal of discovering useful information, suggesting conclusions, and supporting decision making, converting to appropriate format including language, voice to text, text to voice, structured data, identify text data in image or video, validating & verifying text language and syntax of text, spell or grammar checking, applying privacy settings and preferences, associating metadata including keywords, categories, semantic syntax, ontologies, context data and system data including date & time, associating or attaching or presenting contextual advertisements with message(s) or content(s), identifying and make available message associate link(s) associated or referred applications, services, objects, contents, data, functions, interfaces, & features.

In one embodiment enabling to integrate, embedded and access anybody, anywhere, anytime, any-device for anything connecting, communicating, participating & messaging interface with/to/at/in/on/by 3^{rd} parties web sites, web pages, applications, clients, services, devices and networks via web services, application programming interface (APIs), software development kit (SDK), web site, web page, buttons, plug-ins and any types of communication interfaces.

In one embodiment real time updating user's connections with other users' for messaging, communications, and participations based on adding or updating or removing of request data.

In one embodiment earning points by user(s) may base on rank provided by other users of network(s), availability of user, rank of user's contents provided by other user(s) of network(s), number of times user connected with other users of network(s), number of times other users connected with user and total duration of communication, messaging & participation sessions of user with other users of network(s), purchasing of points by user(s) and receiving of points by user(s) from other users of network(s).

In one embodiment applying a set of theories, methodologies, processes, architectures, and technologies to transform raw data including user's all types of data into meaningful and useful information for business purposes.

In one embodiment enabling advertisers to preparing, presenting and providing in-line or in-text advertisements based on request data and/or message(s) and/or content(s) and/or user data.

In one embodiment enable to creating and updating of social graph of user(s) and/or network(s) and storing & updating information about and information associate with connections between/among nodes including connected users, identities, named entities or objects, applications, services, profile objects, type of contents.

In one embodiment information about connections between/among nodes may include monitoring, tracking, sensing, identifying, detecting, recording, storing, indexing, processing, structuring, formatting connected users activities, actions, transactions, contacts, events, interactions, senses, responses, requests, messages, communications, shared contents, behavior, locations, user generated content or data.

In one embodiment charging for advertisement(s) may base on various models including cost per connection, cost per click, cost per actions, cost per impression and/or are based on number of users connected, number of users provide ranks & comments, number of user take one or more types of actions including view message(s), provide rank, click on message associate link(s), buy product(s) and/or service(s), register or install or subscribe or view or visit to/with advertiser's web site, feature(s) of web site, application, service, contents & web pages, respond or reply or share or refer to message(s), bookmark advertiser or message or content of advertiser(s) or add advertiser to user's persistent connections or contacts, number of times and length of duration of communications session(s) with connected users or prospective customers or customers or clients, total amount of purchases.

In one embodiment enabling advertiser(s) to bid for connecting with users or customers or prospective customers for particular keywords, categories, user request data, wherein sever matched advertisement criteria including keywords, phrases, categories, location, language with user's data & request(s) data and prioritizing in connecting requestors or users or customers or prospective customers with advertisers or administrators or sales representatives of advertisers based on highest or updated or competitive bid(s).

In one embodiment providing searching to users of network(s) to search & match users of network(s) may base on one or more search criteria and preferences and enable to select from searched users of network for establishing connection with them based on invitation and/or purchasing selected connections or subscribing connections for dynamically search, match, use & access connections.

In one embodiment purchasing selected connections or subscribing access rights of connecting set of users may comprises using subscribed or purchased selected connections for particular number of times, for particular type of activities, for advertising, marketing & conducting e-commerce transactions, access connection for particular period of time or duration and access as per one or associated, defined, customized rules, policies, agreements, permissions, access rights & privileges, subscription models & privacy settings

In one embodiment enabling advertiser(s) to bid for presenting advertisement to users or customers or prospective customers for particular keywords, categories at one or more advertisement spaces or in-line with messages, wherein sever matched advertisement criteria including keywords, phrases, categories, location, language with user's data & user's request(s) data and prioritizing in presenting advertisement(s) to requestor(s) or user(s) or customer(s) or prospective customer(s) based on highest or updated or competitive bid(s).

In one embodiment enable user(s) to send request(s) for connecting with other users from pool of users; receiving request(s) from user(s) for connecting with other user(s); determining connection(s) based on request(s); and connecting determined user(s) with requestor(s).

In one embodiment enabling connected users to conduct plurality types of activities, actions, events, interactions, workflow, tasks, transactions, registrations, participations including communications, messaging, sharing, accessing, linking, broadcasting, presenting, subscribing, making new connections, searching, matchmaking, selections, inputting, requesting, providing services, viewing, instructing, suggesting, publishing, participating with one or more activities, and collaboration with one or more connected users.

In one embodiment enabling user to send request or send invitation to said one or more determined connected users for adding said one or more users to contact or connection list.

In one embodiment enabling user(s) to send request(s) from one or more 3^{rd} parties' web sites, web pages, portals, platforms, applications, clients, services, web services, devices, networks, servers, social networks and databases.

In one embodiment enabling user(s) to connect with determined user(s) of one or more 3^{rd} parties' web sites, web pages, portals, platforms, applications, clients, services, web services, devices, networks, servers, social networks and databases.

In one embodiment request may comprising user input(s) and/or user selections of/from keyword(s), user selections via one or more types of controls including list, combo box, check box, radio button, auto-fill keyword(s), template(s), script(s), pre-created or user created or system created or 3^{rd} parties or experts created list(s), criteria, conditions, rules, search syntax, characters, words, phrases, sentence, commands, dictionaries, thesaurus, semantic syntax, structured query language (SQL) query, message, content, data structure, suggested or alternative request data or keywords, dynamically or auto generated list based on users senses, current locations & events, auto detecting users from video or voice, voice to text, digital pen to text, rich text format, video or image to text, match making preferences, privacy settings, ontologies, query or question, categories, taxonomies, structured data, database fields, database, user properties, attributes, context data, user profile, user connections or contacts, social graph data, user activities, actions, events, transactions, senses, behavior, interactions, locations, languages related data, list or contact list(s) of connected or related users, list or data of providers of products and/or services, brands, users, companies, organizations, schools, collages, class & year of schools and or collages, users of particular web sites, products, applications, services, devices, social networks, communications, search engines, e-commerce web sites and any types of entities and identification data, language selections, metadata, invitations, multi media types of data including image, video, photo, text, URL or Link, audio, music, icon, graphic, application, document, database, record of database, object, binary instruction and settings including connecting users with other users for particular request data as per schedule, connect me at particular date and/or time or ranges for particular request data, limiting number of connected users for particular request data, use my present or current locations & places, use my selective profile or user data or connected users data and any combination thereof.

In one embodiment requestor(s) or user(s) or connected user(s) may comprises general user, user of network, registered user, un-registered user, connected or related user, visitor, group(s) of user(s), expert(s), administrator(s), web site(s), search engines, social networks, peer to peer networks, web page(s), digital point or pixel or particular area or coordinator of device or interface, application(s), web service(s), database(s), communication channels, device(s), server(s), automated source(s), automated destination(s), sensor(s), products and services providers, developers of applications & services, provider of data & contents and any types of entities including company, shop, mall, building, tree, organization, trust, government, press & media, and users on behalf of other user.

In one embodiment determining connections may base on request(s) comprising matching request(s) data and/or requestor's(s) data with data of pool of users.

In one embodiment user data may comprises user profile, user generated data, shared data, user inputted, selected & disclose data, user activities, actions, events, behavior, current location(s) & place(s), transactions, interactions, senses and multidimensional environment related data and/or connected or related or associate users' data.

In one embodiment user data may comprises content(s) or database(s) of web site(s) and/or server(s) of web site(s), application associate data, database(s), resources, device associate data, web service associate data, data of social network, data, resources, digital contents and index data of search engines, data provided, updated, inputted, synchronized, shared, published by registered and/or un-registered users, connected users, 3^{rd} parties providers, developers, partners, service providers, connected users, experts, automated sources.

In one embodiment determining connections may base on request(s) comprising searching, matching, filtering, selecting, associating, developing, customizing, installing, attaching, associating, integrating, loading, executing, running, processing, indexing, formatting, verifying, validating, syntax checking, intuiting, orchestrating, monitoring, tracking, subscribing, using, accessing, connecting, collaborating, communicating, applying, setting, calling, invoking one or more methods, systems, procedures, formulas, processes, analysis, modules, data, triggers, object-orientated technologies, routines, programming instructions or binary instructions, match making algorithms, business processes, data mining, data analysis, text analysis, applications, objects, functions, scripts, commands, privacy settings, preferences, security or privacy policies, rights & privileges, rules, (application program interface) APIs, (software development kit) SDKs, plug-ins, communication interfaces or channels or links or networks, web services, human services, devices, databases, networks, users, humans, experts for matching requestor(s) with other users of network(s).

In one embodiment determining connections may base on request(s) comprising user(s) availability, points or levels or weights or ranks earned or purchased or possess by user(s), number of sessions, number of users connected, number of contacts or connections, selections or determining of users for request(s) specific connections by experts or administrators or users of networks or connected users of user, current or past location(s) of user, language(s) of user(s), user(s) device, user(s) clients, type(s) of membership(s) including premium, paid, subscribers, subscriptions, enterprise, seller, expert, volunteer, sponsored, advertised, general, guest, registered user, non-member or non-registered member & gift based members, user's social graph, connected or related or connected users of connected users of user, user's updated data, profile data, lists, categories, keywords, database, privacy settings, preferences, rights & privileges, user's current activities, actions, transactions, senses, locations, places, events, date & time, interactions, behavior, status, availability, nearness, participations and any combination thereof.

In one embodiment presenting advertisement(s) before or pre, while and after or post connecting users with request(s) to one or more types (s) interface(s) or client(s) or device(s) or application(s) of connected and request user(s).

In one embodiment sending, receiving, determining and connecting can take place in real time or near real time.

In one embodiment registering and/or identifying user(s) with anybody to anybody connection network(s) and/or platform(s) and/or application(s) and/or service(s) and/or web site(s) and/or web page(s) and/or server(s) and/or device(s); enabling user(s) to determine types of connections required and/or monitoring, tracking, detecting, identifying, accepting, collecting, organizing, filtering, orchestrating, recognizing, sensing, recording, indexing, processing and formatting user's one or more activities, actions, events, transactions, requests, search queries, preferences, privacy settings, match making preferences, interactions, behavior, senses, location, places, current location or place, communication, messaging, viewing, collaboration, access, connections, searching, sharing, processing, selections, inputs, tasks, workflows from/with/via/by/to/in/at/within one or more sources, applications, services, objects, profiles, web sites, web pages, sensors, devices, databases, servers, networks, social networks, peer to peer networks; enabling user(s) to send or update request for connecting requestor user(s) with other registered and/or identified user(s) of network(s) and/or automatically send or update request(s) to enabling user(s) to connect with other registered and/or identified user(s) of network(s); determining connection(s) based on request(s); and connecting determined user(s) with requestor(s).

In one embodiment types of connections required may comprises user want to connect with one or more user(s) of network(s) for one or more types of activities, user(s) actions, interactions, transactions, events, workflows, tasks, searching, sharing, participating, collaboration, communication, establishing communication sessions, conduct transactions and messaging.

In another important embodiment dynamically enable digital object(s) or digital point(s) to connect with other digital object(s) or digital point(s).

In another important embodiment dynamically enable digital object(s) or digital point(s) to connect with other digital object(s) or digital point(s) based on sent request(s) data for connecting with other digital object(s) or digital point(s).

In another important embodiment dynamically enabling digital object(s) or digital point(s) to connect with other digital object(s) or digital point(s) based on monitoring, tracking, detecting, identifying, accepting, collecting, organizing, filtering, orchestrating, recognizing, sensing, recording, indexing, processing and formatting digital object'(s) or digital point(s)'s one or more activities, actions, events, transactions, requests, search queries, preferences, privacy settings, match making preferences, interactions, behavior, senses, location, places, current location or place, communication, messaging, viewing, collaboration, access, connections, searching, sharing, processing, selections, inputs, tasks, workflows from/with/via/by/to/in/at/within one or more sources, applications, services, objects, profiles, web sites, web pages, sensors, devices, databases, servers, networks, social networks, peer to peer networks and sending said data for matching other digital object(s) or digital point(s) for dynamically enabling digital object(s) or digital point(s) to connect with other digital object(s) or digital point(s).

In another important embodiment dynamically enable digital object(s) or digital point(s) to connect with other digital object(s) or digital point(s) based on privacy settings, preferences, rights & privileges, invitation(s), requesting, payments, partnerships, negotiations.

In another important embodiment dynamically enable digital object(s) or digital point(s) to connect with other digital object(s) or digital point(s) based on or via application programming interface(s) (APIs), web services, plug-ins, and one or more types of communication interfaces, channels, modules, applications, services, networks, & devices.

In another important embodiment digital object(s) or digital point(s) may compresses pixel, web site, web page, object, module, function, routines, computer programming, application, service, web service, device, database, server, controls including textbox, button, check box, radio button, list box, combo box, edit box & one or more types of controls and one or more type of multimedia content including video, image, photo, text, document, voice, audio, binary instruction, uniform resource location (URL) or link.

In another important embodiment enabling connected digital object(s) or digital point(s) to conduct one or more types of activities, actions, interactions, transactions, events, workflows, tasks, searching, sharing, participating, collaboration, communication, messaging, synchronizing of data, presenting contents, sending requests including request for registering digital object(s) or digital point(s) and/or users of digital object(s) or digital point(s), request for search result based on search query, request for selective user data & payment information, receiving responses, sending and/or receiving search results, comments, reviews, user data, user profile, user connections, user activities related data, payment information of user(s), accessing data, uploading and/or downloading applications, contents, providing and/or consuming services, subscribing connected one or more digital object(s) or digital point(s), executing and/or processing commands, binary instructions, parameters.

In another important embodiment enable connected digital object(s) or digital point(s) to connect with other connected digital object(s) or digital point(s) up-to particular number of degrees or depths.

In another important embodiment enable user(s) to dynamically connect with other users of network(s) based on dynamic request(s); dynamically receiving request(s); dynamically determine connection(s) or user(s); dynamically present request(s) specific connection(s) or user(s) and/or enable requestor user(s) to dynamically connect with determined connections or user(s) and/or dynamically connect requestor user(s) with determined connections or user(s) and/or connect requestor user(s) with determined connections or user(s); dynamically present requestor user(s) and/or connected user(s) specific resource(s); and enable user(s) to dynamically communicate, request, collaborate, participate with connected users and/or resources associate with connected user(s) of user(s) via accessed, installed, subscribed, invoked, selected, connected, executed & used resource(s).

In another embodiment dynamic request can create by user.

In another embodiment dynamic request(s) comprising automatically generated request(s).

In another embodiment dynamically receive request(s) comprises receiving request(s) via one or more sources.

In another embodiment dynamically receiving request(s) comprising receiving request based on user senses, user life stream, user activities, user actions, user transactions, user behavior, user associate triggered events, current location of user, detecting user in video, user generated or provided or shared or received data, user profile, user voice, user image or photo, user video, user initiate command(s), date & time, user associate physical or logical environment data including temperature, climate, wind, rain, eye view(s) including movement of birds viewing by user, expressions, user status and like, user request(s) and/or auto generated request(s) and/or request(s) provided 3^{rd} parties on behalf of user(s), user connections, data of connected users, user's social graph and user associate data inputted, viewed, selected, updated, connected, detected, sensed, processed, mined, analyzed, aggregated, imported, synchronized, shared, collected, formatted, generated, provided, presented by/via/from one or more sources.

In another embodiment source(s) including one or more web sites, web pages, applications, services, objects, networks, servers, devices, databases, user, user profile, users of network(s), connected users of user, pixel of screen of digital device and one or more types of digital sources.

In another embodiment dynamically determine connection(s) or user(s) comprising connecting requestor user(s) with other user(s) based on availability, points earned by user(s) or group(s) of user(s), match making of requestor(s) user's data and/or other users of network(s), preferences, ranks of user(s), location(s) of user, current location of user, current place of user, current activity of user, current sense(s) of user including at present user are viewing, eating, touching, movement of user, other types of sense(s), current user contacts with other things including users, current user connections, current action of user, current transaction of user, pending transaction of user, current status of user, current event attended by user, use associate triggering of events, date & time, schedule(s), privacy settings, preferences, rights & privileges, security policies, events, user profile, user data, user connections, user social graph.

In another embodiment dynamically present request(s) specific connection(s) or user(s) comprising presenting as per updated user preferences, user initiated re-ordering of list of connections, connections added, attached, detached, removed & updated by user, changes or updating of user's activities, actions, transactions, status, senses, events, behavior, locations, places, date & time, environment or surrounding associate with user including entities or things or items or people surrounding of user, views of user, selected or updated presentation settings & preferences including selection of type or presentation interface, filtering or sorting by user, selection of view(s) from list or types of views.

In another embodiment enable requestor user(s) to dynamically connect with determined connections or user(s) from presented or provided or received list of determined connections or user(s) and/or dynamically & automatically connect requestor user(s) with determined connections or user(s) comprising connect user with determined users based on invitation, request for perpetual or permanent or persistent or long term connections like connections with friends, family, relatives, colleagues, associates, classmates, neighbors and like, ranks, points, orders, orchestrated process, rules, privacy settings, preferences, user selections, user search, user match making, filter, order, conditions, selections by 3^{rd} parties including connected users of user, expert mediated selections, workflow, workspace, tasks, procedures, programming, collaboration, communication, other connections, social network, groups, applications installed by user, user associate items, things, process, works, tasks, activities, actions, events, senses, status, environment, transactions, locations, current or updated or contextual location(s), checked-in locations or places.

In another embodiment dynamically present requestor user(s) and/or connected user(s) specific resource(s) comprising

In another embodiment enable user to dynamically communicate with connected users comprising

In another embodiment enable user(s) to dynamically communicate, collaborate, participate with connected users comprising enable user(s) to conduct one or more activities, transactions, workflow, search, match making, take actions, events, use applications, services, web sites, web pages, databases, devices, networks, social networks, objects, functions, share contents.

In another embodiment determining potential or prospective or candidate connections for user;

generating a list of potential or prospective or candidate connections not connected to the user;

presenting a list of potential or prospective or candidate connections not connected to the user;

enable user to make new connections and/or connect from a list of potential or prospective or candidate connections not connected to the user; enable user and/or potential or prospective or candidate connections to select, attach, set, apply, associate, share, send, present potential or prospective or candidate actions with one or more candidate connections not connected to the user; present list of actions associated with each potential or prospective or candidate connections not connected to the user; enabling user to access one or more user actions associate with each potential or prospective or candidate connections not connected to the user.

In another embodiment candidate connection include objects, entities, concepts & other users not connected with the user.

In another embodiment the one or more suggestions are provided to the user, without the user requesting the suggestions.

In another embodiment the one or more suggestions are provided to the user responsive to a query from the user for suggestions.

In another embodiment the candidate action comprises send instant messages, buy products, make bid, make phone call, send invitation to make new connections, participate with activities of user and/or connected users, ask question.

In another embodiment new connections are temporary or long lasting.

In another embodiment enable user to register, create, define, generate, update, customize, store one or more accessible user(s) object(s) link(s) or user(s) link(s) or link(s) including search, match, select, purchase, download, customize, install, subscribe, update, attach, associate, integrate, upload one or more applications, services, objects, user actions, functions, controls, forms, interfaces, one or more types of multimedia contents including text, video, voice, images, photos, uniform resource locator (URLs) or links & documents, all or selective user data including user generated data, shared data, received data, activities stream, user profile, user connections and one or more types of resources and apply access privacy settings & preferences; enable user to send, post, publish, advertise, broadcast, synchronize, present, provide, share accessible user(s) object(s) link(s) or user(s) link(s) or link(s); enable other users to access said user(s) object(s) link(s) or user(s) link(s) or link(s) to take one or more actions including view, access, share user contents including provided user data, comments, reviews, blogs, shard data, applications, services, objects, participate with activities, conduct e-commerce transactions, connect, communicate, collaborate with user, share with user, add to contacts or connections, like or dislike user(s).

In another embodiment enable user to send, post, publish, advertise, broadcast, synchronize, present, provide, share accessible user(s) object(s) link(s) or user(s) link(s) or link(s) from one or more web sites, web pages, networks, applications, services, objects, sources, destinations, devices, databases, servers.

In another embodiment enabling user(s) to configure, selects, input, set or update privacy settings & preferences for enabling other users to connecting with user(s) and/or accessing user's user object(s) by connected or related users including who can, for what, based on what, when, where, with or via or by whom, who are eligible, why and how to connect, participate with & access user or user object(s) for/based on one or more types of activities, actions, events, transactions, senses, behavior, locations, purpose, follow-ups, jobs, tasks, workflows, communications, collaborations, sharing & participations and based on preferences, status, presence information, privacy settings, rules, keywords, categories

In another embodiment user(s) is/are enable to 1152 select, 1101 customize, make sharable, edit, update, 1102 filter, sort, & categories, 1105 apply, set, select, input, update privacy settings, roles, rights, privileges, security policies & preferences and 1104 attach, detach, block, un-register, package, integrate, add, remove one or more uniform resource locator (URLs) or links of applications, services, objects, contents and selective user data and can attach or detach with/in/to/at dynamic, portable, customizable, presentable & accessible 1150, 1120 & 1135 user object(s) or user profile object(s) or user object link(s) or user specific dynamic, portable, customizable & accessible interface(s).

In another embodiment dynamic, portable, customizable, presentable & accessible 1150, 1120 & 1135 user object(s) or user profile object(s) or user object link(s) or user specific dynamic, portable, customizable & accessible interface(s) enables connected users with user to use, access, re-share, refer, order, sort, attach, detach, customize user specific interface, invoke link associated one or more applications, services, objects, contents for sharing & accessing contents and for conducting or participating with one or more activities, actions, events, transactions, communications & collaborations.

In another embodiment enabling user(s) to connect user with other users and/or allow to presenting of User Object Links of other users to user for/based on one or more purpose, posted request(s), activities, actions, events, transactions, locations & user data including select, define or add new & update 1292 definition(s) for allowing other users to presenting 1215, 1220 & 1235 links of other users to user and/or connect user with other users, wherein 1292 definition(s) includes input, select, set or apply, post, update one or more purpose, rules, conditions, keywords, settings, connection types, connection names, availability & presence info., schedules, duration, activities, actions, events, transactions, locations, tasks, workflows, communications, collaborations, sharing & participations and any combination thereof for defining when, who, why, how, where, for whom & for what other users can connect with user and/or allowing to presenting of one or more User Object Links of other users to user.

In another embodiment dynamic, portable, customizable, presentable & accessible 1215, 1220 & 1235 user object(s) or user profile object(s) or user object link(s) or user specific dynamic, portable, customizable & accessible interface(s) enables user to use, access, re-share, refer, order, sort, attach, detach, customize interface, invoke connected user's user object specific link(s) associated or referred one or more applications, services, objects, contents for sharing & accessing contents and for conducting or participating with one or more activities, actions, events, transactions, communications & collaborations.

In another embodiment enable user to define how to connect user by other users; enable other users to connect users based on definition; and enable connected users to communicate, collaborate, share, send and/or receive messages or contents, make new connections, conduct one or more types of activities, actions, events, transactions, tasks, workflow & participate with each other.

In another embodiment define how to connect user by other users comprises who can, for what, based on what, when, where, with or via or by whom, who are eligible, why and how to connect, participate with & access user.

In another embodiment connect user with other user based on definition comprises connect for one or more types of activities, actions, events, transactions, senses, behavior, locations, purpose, follow-ups, jobs, tasks, workflows, communications, collaborations, sharing & participations.

In another embodiment connect user with other user based on definition may base on one or more types of activities, actions, events, transactions, senses, behavior, locations, purpose, follow-ups, jobs, tasks, workflows, communications, collaborations, sharing & participations and preferences, privacy settings, rules, keywords, categories.

In another embodiment definition comprises user defined, inputted, searched, matched, filtered, selected, attached, associated one or more keywords, categories, rules, one or more type of activities, actions, transactions, events, purpose, task, workflow, locations, places, current location and/or place, checked in locations and/or places, profile data including fields and associate or corresponding values or ranges or selections or inputs, criteria, privacy settings, preferences, rights & privileges, security policies, schedules, date & time ranges, presence information, user data, user social graph & user connections and any combination thereof.

In another embodiment enable user to search, match, select, register, purchase, install, subscribe, upload, download, updates, customize, share, input, edit, update, filter, sort & categories, apply or set privacy settings & preferences, attach, detach, associate, integrate, remove, un-install, un-register one or more accessible uniform resource locator (URLs) or links of one or more applications, services, objects, connections, multimedia types of contents including text, video, audio, voice, image, photo, uniform resource locator (URLs) or links, documents and one or more types of contents with/to/in/for definition(s) or named link(s) of user(s).

In another embodiment enable user to define for presenting links of other users or enable user to define for enabling other users to connect with user; enable user to connect with other users based on definition; and enable connected users to communicate, collaborate, share, send and/or receive messages or contents, make new connections, conduct one or more types of activities, actions, events, transactions, tasks, workflow & participate with each other.

In another embodiment enable to select, define or add new & update definition(s) for presenting links.

In another embodiment definition of presenting links to user includes input, select, set or apply, post, update one or more purpose, rules, conditions, keywords, settings, connection types, connection names, availability & presence information, schedules, duration, activities, actions, events, transactions, locations, tasks, workflows, communications, collaborations, sharing & participations and any combination thereof for defining when, who, why, how, where, for whom & for what other users can connect with user and/or presenting of one or more links to user.

In another embodiment definition of presenting links to user includes input, select, set or apply, post, update one or more purpose, rules, conditions, keywords, settings, connection types, availability & presence information, schedules, duration, activities, actions, events, transactions, locations, checked-in places, tasks, workflow for when, who, why, how, where, for what, for whom presenting one or more links to user.

In another embodiment enabling user(s) to connect with other users or group(s) of users for one or more type(s) of purpose(s); connecting user(s) to other user(s) based on type(s) of purpose(s);

presenting, associating or attaching purpose(s) specific link(s); enabling user(s) to use or access purpose(s) specific said link(s); and enable user(s) to purpose(s) specific participation with connected users.

In another embodiment link(s) comprising link(s) of accessible or invoke-able apps, services, web sites, feature of web sites, web pages, objects, multimedia types of contents including text, video, audio, images, photos, uniform resource locator (URLs) or links & documents, profile object, social networks, devices, servers, user actions, controls, databases, interfaces.

In another embodiment enable user(s) and/or connected users of user(s) to search, match, select, purchase, download, customize, install, subscribe, update, attach, associate, integrate, upload link(s) associated one or more applications, services, objects, user actions, functions, controls, forms, interfaces, one or more types of multimedia contents including text, video, voice, images, photos, uniform resource locator (URLs) or links & documents, all or selective user data including user generated data, shared data, received data, activities stream, user profile, user connections one or more types of resources from one or more sources including 3^{rd} parties developers, service providers, web sites, web pages, applications, services, devices, networks, databases and apply access privacy settings & preferences.

In another embodiment types of purpose(s) may comprises wan to view or search or match particular products or hotel menu, negotiate or buy particular products and/or services, sell particular products, connect with particular types of users, want to share comments or messages for particular types of user at particular locations, participate with particular deals, solve particular tasks, connect for particular type of workflow including view hotel menu, order selected food items from menu, view bill & make payment for presented bill by hotel administrator.

In another embodiment participation may comprises conduct one or more types of communications, collaborations, sharing, searching, workflows, tasks, user actions including like products or users, write or update comments & provide ranks, view selective profile or user data including messages, shared contents, activity stream, comments & reviews, add connected user(s) to contacts, share contents, send instant message(s), send e-mail(s), create group(s), and participation with one or more types of activities, actions, transactions, locations, events with connected user(s).

In another embodiment monitor, track, detect, sense, input, access, search, match, filter, select, update, infer, identify entities who interact with user and entities to whom user interact with them or user interacted entities; identifying, searching, matching, receiving, importing, detecting or recognizing or sensing, inputting, selecting and/or storing and/or updating and/or processing information about user interactions with other entities; search, match, select, add, update, invite, import, process, remove, attach, detach, sort, rank, determine, identify one or more or one or more set(s) or group(s) of connections based on updated user interaction(s) data and/or user data;

present, provide, update, add, remove, attach, detach, send, publish, share, synchronize, store, process, format, bookmark, allow to access said one or more or one or more set(s) or group(s) of connections and/or information about said one or more or one or more set(s) or group(s) of connections; enable user to search, match, filter, sort, rank, bookmark, share, select & connect with other user(s) and/or connect user(s) with other user(s) and/or automatically connect user(s) with other user(s); and enable user(s) to conduct plurality types of activities, actions, events, transactions, workflows, tasks, participations, presentation of information, communications, collaborations, providing & receiving of services, taking one or more user actions and sharing with each other.

In another embodiment identify user interacted entities may base on updated status of user and/or monitoring, tracking & storing one or more user's activities, actions, events, transactions, current or checked-in locations & places, requests, plurality types of data including user data, identification of entities sensed, identified, detected via video and/or sensors, user inputs, recording of user(s) voices and extracting, processing, formatting, converting & storing user's or group(s) of users' conversations, identify via 3^{rd} parties' applications, services, devices, sensors, inputs, sharing, databases, servers, networks, identify entities associate with one or more types of activities, actions, transactions, events, checked-in or past or identified or related or current locations or places.

In another embodiment identify user interacted entities comprises identify in near or real time or continuously or when activated by user or update.

In another embodiment entity or user comprising one or more persons, group(s) of person(s) including friends, family, colleagues, classmates, professionals, experts, salesman and like, company, infrastructure including road, building, shop, school, collage, tourist place, hotel, restaurant & mall, location, place, items, products, vehicle, web site, applications, service, device, foods, furniture & fixtures, movie theater, movie user is watching, viewers watching movie, users surround user, users around moving user, user surround environment including trees, birds, mountains, river and like.

In another embodiment information about user interactions with other entities comprises information about activity, actions, event, transaction, current location or place & purpose of user's and or interacted entities interaction with other users, information about where, when, how, why, with whom, who is involves, for what interaction take place, full or partial or selective data, profile, shared data, past or historical related data & one or more types of data of user and/or one or more identified and/or connected entities,

In another embodiment enable user(s) to conduct plurality types of activities, actions, events, transactions, workflows, tasks, participations, presentation of information, communications, collaborations, providing & receiving of services, taking one or more user actions and sharing with each other are based on provided, searched, matched, presented, selected, installed, downloaded, uploaded, subscribed, purchased one or more applications, services, objects, interfaces, web sites, web pages, features, functions, multimedia types of data including text, video, voice, audio, image, photo, object, document, file, URL or link and like, databases, controls, forms and one or more types of digital objects.

In another embodiment storing & updating prospective or candidate parts of structured updated status/request(s) and enabling user(s) to provide updated status/request(s) based on selecting and/or inputting from parts of structured updated status/request(s) comprising: storing & updating prospective part of updated status/request(s) including keywords, categories, nodes, items, objects, commands, date & time ranges, named entities including brand names & contacts, types of activities, actors, actions, purposes, contents, interest, events, status & transactions, grammar, parts, profile fields, values, properties & metadata, location names, rules, values, numbers, fields & associate values or ranges and syntax language; enabling user to input, select, draft, edit, update & provide updated status/request(s) based on searching, matching, filtering, selecting from parts of structured updated status/request(s) or suggested parts of structured updated status/request(s) and/or automatically identifying, updating & preparing updated status/request(s) based on monitored, tracked, detected, sensed, recognized, identified & stored user's activities, actions, events, interactions, locations, places & transactions via automatically searching, matching, filtering, selecting, sequencing or ordering from parts of structured updated status/request(s); verifying and/or validating syntax of updated status/request(s) including matching keywords with parts of structured updated status/request(s), sequences or order of keywords, existing of master keywords of structured updated status/request(s) in/at global database(s), syntax, grammar & spellings of updated status/request(s), minimum and/or maximum ranges or values, associate rules and auto correcting errors & providing errors, solutions & suggestions; and enabling user to post, auto post, suggest, share, publish, broadcast, advertise, send to selected, synchronize, update, provide, save, discard updated status/request(s).

In another embodiment automatically identifying, selecting and associating or attaching data about who is posting or who post updated status/request(s) including identification data, user profile & user data, past or historical updated status/requests, user connections, contacts & social graphs, data about when updated status/request(s) posted or post including date & time and/or date & time ranges of posting of updated status, data about from where updated status/request(s) was/were/is/are posted or post including locations of posting of updated status/request(s) or current locations or places or checked-in or user selected or inputted or provided locations or places and data about availability and/or presence information about user who posting updated status/request(s).

In another embodiment identify keywords not present in parts of structured updated status/request(s) and enabling to save or update keywords to global database(s) of parts of structured updated status/request(s).

In another embodiment real time identifying, searching, matching, filtering, processing, inferring, determining, suggesting, presenting, sending, sharing & providing prospective or candidate connections including one or more types of contextual connectable users & entities based on one or more or combination and/or permutations of keywords or parts of structured updated status/request(s) provided by user(s).

In another embodiment identifying doers, associates, attendees, actors and/or locations and/or date & time of particular activities, actions, events, transactions and/or identifying contextual facilitators including contextual sellers, nearest shops, related experts or activity associate job specific responsible persons or staffs, nearest or related people or group(s) of persons including viewers, guests, members, related assistants & consultant, contextual advertisers, & of particular or similar types of activities, actions, events, transactions and/or identifying prospective or candidate associate or related users with particular type(s) of activities, actions, events, transactions.

In another embodiment enabling user to provide detail updated status based on presented, suggested, provided, shared, determined, auto matched, filtered, customized, searched, matched & selected full or partial domain, subject, field, job, task, activity, action, transaction, interaction, location, language, workflow, event specific forma and/or dynamically generated and/or dynamically customized forms and/or one or more types of controls and interfaces.

In another embodiment determining connections for each user for each structured updated status or request(s) is/are based on matching of structured updated status and/or request(s) and/or user data of user with structured updated status and/or request(s) of other users of network(s) and/or user data.

In another embodiment presenting real-time interface for viewing, accessing, sharing, synchronizing, identifying, selecting, send invitation for adding to contacts & connecting, creating and/or inviting and/or adding to groups or social networks arranging, sorting, ordering, ranking, connecting, conducting one or more activities, actions, events, transactions, communications, collaborations, searching, sharing, participations, workflow & tasks with/from/to/in/at/on/by/via presented connectable users and prospective connections among them and/or connected users and associate selective or permitted data related to communications, participations, sharing, collaborations, activities, actions, events, transactions, workflow & tasks based on one or more criteria, rules, filters, search & matchmaking queries comprising: enabling user(s) to input, select, update one or more search criteria, match making preferences, filters, categories, keywords, lists, fields & associate value(s) or rang(s) of value(s), location(s), date(s) & time(s) or date & time range(s), select past, present or current or line & prospective or future type, type of users or connectable users or entities, user contacts or connections, named entities, nodes, activities, actions, events, transactions, communications, collaborations, participations, sharing, workflow & tasks; present set(s) or group(s) of identified, portable, accessible link(s) or object(s) or interface(s) of connectable & connected users or entities and indication of connections and/or prospective connections among them and associate indications of conductions of and/or enablement via associate or provided or presented links for conducting of one or more types of activities, actions, events, transactions, communications, collaborations, participations, sharing, workflow & tasks among them; and enabling user to navigate, browse, explore, search, match, filter, attach, detach, monitor, track, subscribe, link, map, store, share, synchronize, advertise, publish, post, send, send to, refer, suggest, tag, sort, rank, creating group(s) or social network(s), mining or analyzing data, present based on selected view type(s), save or update selective, bookmark, rearrange, order, orchestrate, choreograph, sequence, make one or more types of formation, add or update or provide comments, reviews, ranks, notes, one or more types of multimedia content(s), accessible links of applications, services, objects, interfaces & multimedia types of content(s), real-time update, visually view or make connections or suggested connections or mapping or linking, connect, disconnect, invite to add them to contacts, auto and/or manually select for presenting of advertisement(s) in real-time, view & access associate data & links of applications, services, objects, interfaces & multimedia type(s) of content(s) related to or conduct one or more types of activities, actions, events, transactions, communications, collaborations, participations, sharing, workflow & tasks, providing support, identifying prospective customers, make offers or deals or participate in offers or deals, assign, monitor, track, manage, plan, schedule workflow, tasks & jobs, view updated status & activities, actions, events, transactions, communications, collaborations & workflow, present or update or push information or data, present and/or receive structured forms including survey forms, create, add member(s) and/or link(s), invite for & access workspace(s), purchase, bid & order & access from/to/via/in/on/at/within/by said presented or selected one or more or set(s) or group(s) of identified, portable, accessible link(s) or object(s) or interface(s) of connectable, prospective connections & connected users or entities and associate data related to one or more types of activities, actions, events, transactions, communications, collaborations, participations, sharing, workflow & tasks and/or associate or presented or attached or updated or suggested links.

In another embodiment enabling user(s) to input, select, update one or more search criteria, match making preferences, filters, categories, keywords, lists, fields & associate value(s) or rang(s) of value(s), location(s), date(s) & time(s) or date & time range(s), select past, present or current or line & prospective or future type, type of users or connectable users or entities, user contacts or connections, named entities, nodes, activities, actions, events, transactions, communications, collaborations, participations, sharing, workflow & tasks; enabling user to provide, select, update & input name of button and attach or associate or integrate or package with button selected or updated connectable users from said searched, matched, presented, identified, suggested, selected & matched list or set of connectable users; enabling user to configure, customize, add or update metadata, apply privacy settings & preferences of access, update & generate button(s); presenting accessible button(s); enabling user to search, match, select, sort, group(s), categories, filter accessible button(s) and post, share, synchronize, publish, broadcast, advertise, making them searchable, enable for subscription based on one or more types of payment models, send, send to one or more selected and/or group(s) of connected or related users; and enabling viewing or receiving or subscriber users to search, match, sort, filter, select, purchase, subscribe, customize, use, stores, host, re-share, distribute, access, attach & integrate button(s) with one or more web sites, web pages, applications, services, servers, devices, databases & networks.

In another embodiment enabling user to connecting with button associate connectable users or entities or connections via clicking on or accessing or tapping or selecting button(s).

In another embodiment enabling user to conducting one or more types of purposes, deals, tasks, workflow, activities, actions, events, transactions via accessing prospective connections or connectable or connected users associate links of applications, services, objects, multimedia contents, databases, user actions or controls and interfaces.

In another embodiment enabling user(s) and/or group(s) of user(s) and/or server(s) and/or system(s) to manually and/or automatically adding, drafting, inputting, selecting, editing, updating, ordering, sequencing, orchestrating, choreographing, real-time modifying programming instructions based on standardized syntax for programming of user's plurality types of connections needs; storing, updating, saving, processing, formatting standardized syntax based programming instructions; verifying, validating, compiling, detecting & present or correcting errors or suggesting for errors for standardized syntax based programming instructions; executing, running, implementing standardized syntax based programming instructions; determining, searching, matching, identifying, selecting, purchasing, ranking, ordering, sorting, presenting programmed instruction(s) specific connections or connectable users & connected users; enabling user(s) to connect with presented connectable users or connections including prospective connections; and enabling user(s) to access one or more links associate with one or more connectable users or connections including prospective connections and/or one or more type(s) of purposes, updated status, requests, activities, actions, events, transactions, communications, collaborations, participations, sharing, workflows & tasks.

In another embodiment programming of user's plurality types of connections needs including programming for one or more types of purposes, requirements, activities, actions, events, transactions, behavior, interactions, tasks, workflows, jobs, updated status, requests, queries, senses, past, present or current or checked-in location(s) or place(s).

In another embodiment determining, searching, matching, identifying, selecting, purchasing, ranking, ordering, sorting, presenting programmed instruction(s) specific connections or connectable users & connected users including prospective, suggested, candidates, matched, inferred connections or connectable users & connected users and associate links of applications, services, objects, interfaces, contents, databases, profile objects, multimedia data.

In another embodiment programmed instruction(s) executed or implemented based on associate order(s) and/or group(s) and/or date and/or time and/or ranges of date and/or time and/or schedule(s) and/or calendar entries and/or customized or defined triggers or triggering of events and/or user meditated actions including user clicks, user(s) or admin(s) or group(s) of user(s) permission(s), authentications, authorization, identifying privacy settings, preferences, roles, rights & privileges, security policies and/or identification, detection, recognition of particular type of senses or sensors or devices and/or detection, recognition & identification of user's image in video or photo or sequence of image(s) or user's voice or user's and/or user associate or related or connected or contextual or nearness user(s)' or entities' location(s) and/or determined or selected or auto identified one or more type(s) or keyword(s) of user interaction(s), activity or activities, actions, events, purposes, requirements, transactions, behavior, shared contents, sharing, communications, collaborations, participations, nearness, connections, connected users, presented links of applications, services, objects, interfaces, databases & multimedia types of contents, interactions, tasks, workflows, jobs, updated status, requests, queries, senses, past, present or current or checked-in location(s) or place(s).

In another embodiment enabling user to set, apply, select, input & update one or more script as/in running mode or run or execute or implement one or more or selected parts of one or more script(s).

In another embodiment interpreted & execute instruction or line(s) or group(s) of lines of standardized syntax or text codes of one or more scripts in sequences or any other defined manner and based on interpretation of instruction or line(s) or group(s) of lines of standardized syntax or text codes and defined sequences of commands, rules and associate named entities, user actions, links & nodes presents to user(s) defined needs specific plurality types of connections for one or more types of purposes, requirements, activities, actions, events, transactions, behavior, interactions, tasks, workflows, jobs, updated status, requests, queries, senses, past, present or current or checked-in location(s) or place(s) including determining, searching, matching, identifying, selecting, purchasing, ranking, ordering, sorting, presenting programmed instruction(s) specific connections or connectable users & connected users including prospective, suggested, candidates, matched, inferred connections or connectable users & connected users and associate or instructed or programmed or suggested or defined links of applications, services, objects, interfaces, contents, databases, profile objects, multimedia data.

In another embodiment user(s) is/are enabling to preview or visualize scripts in graphical mode, for enabling user to easily view instructions or codes of script(s), relationship among them, take one or more associated user actions, update the code, calculate date & time, orchestrate & choreograph process & order, calculate, determine date & time, including present images, links, videos, voice, audio, icons, photos, objects, identity of parts of instructions including named entities, groups, date & time, location, people, applications, service, object, functions, items and linking line which highlights relationship, order, sequence between them and associate dynamically presented & contextual user actions menu including select from list, invite within visual editor, ask for appointment date & time, attach contents, add comments, reviews, ranks and like.

In another embodiment enabling user(s) to view, access & use visual editor for writing, drafting, editing, updating instructions or standardized code syntaxes or text code in graphical or visual mode(s) including enabling to search, match, sort, filter, brose, navigate, explore, select, visually relate, map, link, connect, interact, associate, attach or detach links, define, sequence, order, compare, rank, merge, split, assign, formation, orchestrate including sequence based on rules & business process, choreograph, drag and drop, take one or more associate actions & select images, icons, photos, videos of one or more programming syntax part(s) or elements including named entities, nodes, users, calendar, applications, services, objects, links, locations, places, functions, actions, activities, events, transactions, groups, contacts, connectable users, connections, updated status.

In another embodiment user(s) is/are enabling to share, collaboratively share, suggest, real-time suggest, collaboratively suggest & refer one or more scripts and/or parts of scripts to one or more users.

In another embodiment user(s) is/are enabling to view & access one or more executed or implemented instructions or part of script(s) or script(s) associated or selected activity stream including monitored, tracked, stored, processed activity, action, transaction, event, location, place specific activity stream and associate data including communications, messaging, conversations, application data, comments, reviews, ranks, notes, shared data, details of transactions, workflow & tasks & logs.

In another embodiment user(s) is/are enabling to view automatically and/or manually assigned, selected & updated status and can set, input, apply, configure, customize, define, select & update status for one or more or set or group(s) of instructions or standardized code or text code.

In another embodiment user(s) is/are enabling to assign multi users and/or collaboration and/or workspace and/or workflow specific roles, rights & privileges, security policies, associate privacy settings & preferences for enabling each member for adding, editing, updating, compiling, verifying, validating, testing, sharing, suggesting, collaborating, providing comments & ranks, accessing editor options, create or remove members, applying privacy settings, setting status, searching, matching, executing, running or implementing scripts, accessing one or more features of editor(s), updating of part(s) of programming syntax including named entities, nodes, items, keywords, categories and viewing, using & accessing one or more applications, services, features, functions, objects, profiles, user data, updated status, requests, connections, contacts, links, communications data, activities streams & resources.

In another embodiment user(s) is/are enabling to set, apply, input, select & update one or more privacy settings, access roles, rights & privileges, security policies & preferences to/with/in one or more script(s) for authenticating and/or authorization other users for accessing & managing script(s).

In another embodiment user(s) is/are enabling to apply settings for automatically, dynamically and/or manually adding & updating of instructions at selected or in auto generated script(s) based on past presented connections, connectable users, connected users and associate activities, actions, events, transactions based on posted and/or generated updated status.

In another embodiment user(s) is/are enabling to apply settings for automatically, dynamically and/or wizard based dynamically generating and/or presenting of dynamic templates.

In another embodiment user(s) is/are enabling to dynamically generate report(s) including location and/or date & time and/or user(s) and/or associate named entity or entities or user(s) wise logs, activities stream, communications, shared data, comments, reviews, ranks, various types of statistics, transaction details, workflow details, status of workflow & tasks, information or structured data about marketing, e-commerce, selling, purchasing, booking, ordering, request for quotes, bidding, deals, auctions, sales leads based selection of one or more part(s) of scripts, scripts, dates & times, date & time ranges, locations, places, connectable, contacted, connected, suggested, associated or related user(s) or group(s) of users one or more types of activities, actions, events, status, communications, collaborations, searching, matching, sharing, participations, workflows, workspaces, tasks, jobs, procedures, processes, transactions and any combination of thereof.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a client device that may be employed in a system implementing the invention;

FIG. 3 shows one embodiment of a network device that may be employed in a system implementing the invention;

FIGS. 4(A) and 4(B) illustrates exemplary graphical user interface (GUI) for enabling users to dynamically establish contextual connections with other users of network and enabling to communicate, collaborate, participate with activities of/with dynamically connected users;

FIG. 5 illustrates flowchart of one embodiment of the present invention;

FIGS. 6(A), 6(B), 6(C) and 6(D) illustrates exemplary user interface for sending or posting structured updated status, updated status, requests, accessing presented connections and information about connections, and/or communicating, collaborating, participating with all or selected connected users of user(s);

FIGS. 7(A) and 7(B) illustrates user interface for enabling user to connect or link user or present to user accessible link(s) of prospective connections or user(s) for enabling user to connecting with candidate or prospective or matched connections or user(s) based on one or more posted structures request(s) and/or request(s) and/or monitored, tracked, stored and extracted activities stream for conducting one or more types of activities, actions, events, transactions, communications, collaborations & participations with prospective or connectable or presented or connected users;

FIGS. 8(A) and 8(B) illustrates user interface for enabling user to one or more time set, input, search, match, select, update, edit, share, send, post, synchronize & provide information about one or more types of user's status or updated status or structured updated status regarding user's one or more types of activities, actions, transactions, senses, behavior, environment, events, current location & place with date & time, metadata, data and like;

FIG. 9 illustrates user interface for providing & updating user status. 910 when user clicks on “Update My Status” button, user is presented with interface for providing details of updated status including what, when, how, why, who, where & when aspects related to/of updated status. Update Status of User may related to user's one or more activities, actions, transactions, events, locations, plan, availability, services, presence Information;

In various embodiments FIG. 10 illustrates some examples;

FIG. 11 illustrates interface for enabling user(s) to configure, set or update privacy settings & preferences for enabling other users to connecting with user(s) including who can, for what, based on what, when, where, with or via or by whom, who are eligible, why and how to connect, participate with & access user or user object(s) for/based on one or more types of activities, actions, events, transactions, senses, behavior, locations, purpose, follow-ups, jobs, tasks, workflows, communications, collaborations, sharing & participations and based on preferences, status, presence information, privacy settings, rules, keywords, categories;

FIG. 12 illustrates interface for enabling user(s) to connect user with other users and/or allow to presenting of User Object Links of other users to user for/based on one or more purpose, posted request(s), activities, actions, events, transactions, locations & user data including select, define or add new & update definition(s) for allowing other users to presenting links of other users to user and/or connect user with other users;

FIG. 13 illustrates flowchart of the one embodiment of the present invention;

FIGS. 14(A) and 14(B) illustrates various examples of the present invention;

FIGS. 15(A) and 15(B) illustrates one or more types of representation or presentation of physical and/or logical word, including visual, text, video, audio, graphic, image, objects, links, map, tree, multimedia and any combination thereof, based on user navigation, browsing, exploring, mining, mouse movements in various directions, selections, commands, requests, preferences, rules, criteria, queries, locations, date & time ranges, types of activities and/or types of connected and/or prospective or candidate or suggested connections and/or connectable users, subscriptions, permission & privacy settings;

FIGS. 16(A) and 16(B) illustrates user interface enabling user(s) to add new, update or save & remove one or more structured or relational entries or records of updated status or details of particular activity, actions, event, transaction, status, note, user generated or shared content;

FIG. 17 illustrates searching interface which enabled searching user or requestor(s) to search connections, updated status & requests of users based on one or more search queries, auto matchmaking preferences, advance search criteria, ranges, values, selections from pre-created lists or templates or past search queries, rules, select status type(s), Boolean operators, keywords, categories and/or one or more structured search queries selected via Select Search query/updated user status Part(s) Menu and enabling searching user or viewing user to connect said users, view availability status and/or presence information, view ranks & comments provided by other users of network(s), view shared contents including reviews of user, view statistics, levels & points associate with user;

FIGS. 18(A) and 18(B) illustrates user interface for searching, matching, navigating, browsing, selecting, sorting, accessing, connecting, purchasing, generating button or link(s) of set of, filtering, sharing, referring categories, domain(s), keyword(s), subject(s), one or more type(s) of activity or activities, action(s), event(s), transaction(s), location(s), workflow(s), business(s), job(s), work(s), education(s) or qualification(s), task(s) specific or one or more query or logical formation specific real time updated & pre-created connections & connectable users or entities from categories or taxonomy wise directories;

FIGS. 19(A) and 19(B) illustrates user interface for enabling user(s) and/or group(s) of user(s) and/or server(s) and/or system(s) to manually and/or automatically adding, drafting, editing, updating, storing, saving, processing, formatting, ordering, sequencing, orchestrating, choreographing, real-time modifying, sharing, searching, matching, selecting, verifying, validating, compiling, detecting & present or correcting errors or suggesting for errors, executing, running, implementing programming instructions based on standardized syntax for programming of user's plurality types of connections needs;

### DETAILED DESCRIPTION OF THE DRAWINGS

Illustrative Operating Environment

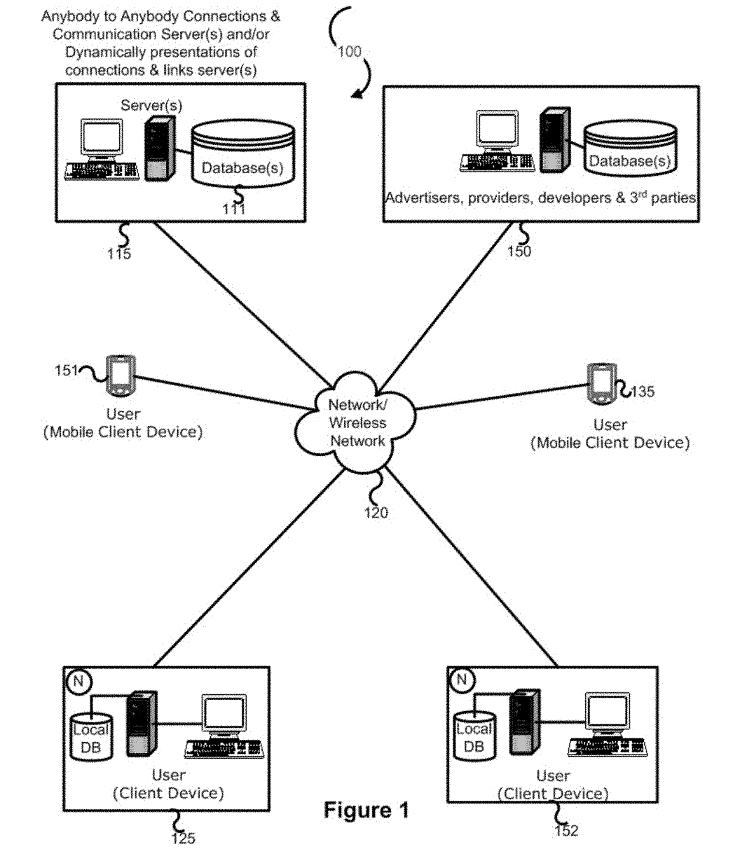

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes a client device, in particular mobile device 151 & 135 and personal computer 125 & 152. The system also includes network or wireless network 120, central server 115, Advertisers, providers, developers & 3rd parties' Server(s) 150, and client devices 151 & 152 and 125 & 135.

A variety of client devices may be employed in accordance with the invention. The client devices may include mobile devices, smart phones, smart devices, tablets, PCs, digital home clients such as personal computers and media centers, and other client devices. Generally, mobile device 135 may include virtually any portable computing device capable of receiving and sending a message over a network, such as network 120, or the like. Mobile device 135 may also be described generally as a client device that is configured to be portable. Mobile device 135 may have the capability of connecting to a network using wireless technology, wired technology, or a combination of both wired and wireless technologies. Thus, mobile device 135 may include virtually any portable computing device capable of connecting to another computing device and receiving information. Such devices include portable devices such as cellular telephones, smart phones, display pagers, radio frequency (RF) devices, infrared (IR) devices, Personal Digital Assistants (PDAs), handheld computers, sensors, laptop computers, wearable computers, tablet computers, integrated devices combining one or more of the preceding devices, and the like. As such, mobile device 135 typically ranges widely in terms of capabilities and features. For example, a cell phone may have a numeric keypad and a few lines of monochrome LCD display on which only text may be displayed. In another example, another cell phone or web-enabled mobile device may have a touch sensitive screen, a stylus, and several lines of color LCD display in which both text and graphics may be displayed.

A web-enabled mobile device may include a browser application that is configured to receive and to send web pages, web-based messages, and the like. The browser application may be configured to receive and display graphics, text, video, multimedia, and the like, employing virtually any web based language or protocol, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile device 135 may include one or more other client applications that are configured to receive content from another computing device. The client application may include a capability to provide and receive textual content, graphical content, audio content, video content, and the like. The client application may further provide information that identifies itself, including a type, capability, name, and the like. In one embodiment, mobile device 135 may uniquely identify itself through any of a variety of mechanisms, including a phone number, Mobile Identification Number (MIN), an electronic serial number (ESN), or other mobile device identifier. The information may also indicate a content format that the mobile device is enabled to employ. Such information may be provided in a message, or the like, send to central server 115 or other computing devices.

Mobile device 135 may also be configured to communicate a message, such as through Short Message Service (SMS), Multimedia Message Service (MMS), instant messaging (IM), internet relay chat (IRC), Mardam-Bey's IRC (mIRC), Jabber, and the like, between another computing device, such as central server 115, another web server, or the like. However, the present invention is not limited to these message protocols, and virtually any other message protocol may be employed.

Mobile device 135 may be further configured to enable a user to participate in communications sessions, such as IM sessions. As such, mobile device 135 may include a client application that is configured to manage various actions on behalf of the client device. For example, the client application may enable a user to interact with the browser application, email application, IM applications, SMS application, and the like. Generally, instant messaging provides ability for at least two computing devices to exchange messages in real time.

Mobile device 135 may further be configured to include a client application that enables the end-user to log into an end-user account that may be managed by a network application. Such an end-user account, for example, may be configured to enable the end-user to receive emails, send/receive IM messages, SMS messages, and access selected web pages, maintain a digital wallet, or the like.

Network 120 is configured to couple mobile device 135, 151 & Personal Computer 125 & 152, as well as other client devices not illustrated, and their components, with other network devices, such as central server 115, and the like. Network 120 is configured to couple responder client devices including mobile phone 135, 151 & Personal Computer 125 & 152 with central server 115.

Though for illustrative purposes network and wireless network are shown combined, in various environments employing the present invention, network and wireless network 120 may be the separate or same network, different networks, or different networks including a combination of overlapping components and distinct components. The discussion herein that describes network 130 may therefore be applicable to describe network 120.

Network 120 may include any of a variety of wired or wireless sub-networks that may further overlay stand-alone ad-hoc networks, and the like, to provide an infrastructure-oriented connection for mobile device 135. Such sub-networks may include mesh networks, Wireless LAN (WLAN) networks, cellular networks, and the like. Additionally, network 120 may connect to mobile devices with a wired connection, such as cable, phone lines, Ethernet wires, and the like. Network 120 may include wide area networks, such as the Internet. The invention may be used either generally with networks, specifically with wireless networks, or with various combinations of wireless and wired networks.

Network 120 may further include an autonomous system of terminals, gateways, routers, and the like connected by wireless radio links, and the like. These connectors may be configured to move freely and randomly and organize themselves arbitrarily, such that the topology of network 120 may change rapidly.

Network 120 may further employ a plurality of access technologies including 2nd (2G), 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as mobile device 135 with various degrees of mobility. For example, network 120 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, network 120 may include virtually any communication mechanism by which information may travel between mobile device 135 and another computing device, network, and the like.

Network 120 may further include or employ one or more network gateways (not shown) that serve as intermediaries between mobile device 135 and other network devices, such as central server 115. A network gateway may receive data from a device or network, transform the data, and forward the data to another device or network. A network gateway may perform a transformation in more than one direction. Transformation may, for example, include modifying protocols or communications mechanisms in order to facilitate communication between two devices or two networks, each of which may employ differing protocols. A WAP gateway is one type of network gateway. A WAP gateway may facilitate communication between a first device that uses the Wireless Application Protocol (WAP), and a second device. The second device may, for example, communicate using the HyperText Transfer Protocol (HTTP). An SMS gateway is a network gateway that facilitates communication between a device using the Short Message Service (SMS) protocol and another device, such as one using HTTP. A WAP and SMS gateway combines the features of a WAP gateway and an SMS gateway.

In one embodiment, network 120 may include one or more components of a Anybody to Anybody Connections, Messaging & Communication Platform or Dynamically presentation of connections & links server(s), Server, Application, Client, Service & Management Interface and service that operates to facilitate or enable to dynamically and/or automatically and/or structured updated status and/or request(s) data specific connecting with one or more users of one or more networks, web sites, applications, services, devices, databases for sending and/or receiving, routing, processing, formatting, indexing messages & contents, communications, shared contents, participate with one or more activities, actions, transactions, & events, search, match, select, register, upload, host, store, process, download, install, subscribe, attach, update, upgrade, share, present and access one or more applications, services, contents and/or link(s) of one or more applications, services, contents from plurality of sources, servers including Anybody to Anybody Connections, Messaging & Communication or Dynamically presentations of connections & links server(s) Server(s) 115, devices, databases including database(s) 111 connected to server(s) 115 and providers 150 to client devices including mobile devices 135, 151 and smart device 125 & 152 and central server 115.

FIG. 1 shows mobile device 135 communicating with central server 115, and central server 115 communicating with Applications, Services, Contents and 3^{rd} parties & Providers Server(s) 150. FIG. 1 also shows central server 115 communicating with client devices 135, 151, 125 & 152. Each of these communications may employ a direct connection, or one or more networks, or a combination thereof. For illustrative purposes, FIG. 1 show communication between central server 115 and Applications, Services, Contents and 3^{rd} parties & Providers Server(s) 150 employing network 120, however environments that include this communication may be employed with the present invention. In particular, central server 115 and Applications, Services, Contents and 3^{rd} parties & Providers Server(s) 150 may employ any one or more of direct communication, a local area network, or a wide area network, such as network 120.

A network enabling any one or more of the above communications may employ any form of computer readable media for communicating information from one electronic device to another. Also, the network may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, the network includes any communication method by which information may travel between central server 115, Interfaces and Functions Providers Server(s), and Developers, Sponsors, Advertisers and Providers 150, client devices 151,152, 125 & 135, and other computing devices (not shown).

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” include a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Client devices 151, 135, 125 & 152 are computing devices that may be employed by a user, referred to as a receiver and sender, for receiving and sending or sharing structured updated status and/or request(s) data, connections, contents and associate data and user instructions. A variety of sender and/or receiver client devices may be employed in accordance with the invention. Client devices may include mobile devices, digital home clients such as personal computers and media centers, and other client devices. Generally, clients may include virtually any computing device, portable or non-portable, capable of receiving and sending a message over a network, such as network 120, or the like. Clients may include devices such as mobile device 151 (135) described herein. Though FIG. 1 illustrates only four Clients 151, 135, 125 & 152, it is envisioned that the invention may be practiced in an environment that include a large community of sender and receiver clients. Thus, sender and receiver clients or members of network(s), application(s), service(s), web site(s), device(s), database(s) or provider or user or receiver may number in the hundreds, thousands, hundreds of thousands, millions, or virtually any number.

Though FIG. 1 illustrates an embodiment of a system having each of network 115 central server(s) and Anybody to Anybody Connections, Messaging & Communication Server(s) or Dynamically presentations of connections & links server(s) and 150 3^{rd} parties' server(s) as separate computing devices, the invention is not so limited. Software, hardware, or hardware-software combinations implementing any portion of these components may be combined with any other component on a single computing device, or arranged in a different manner among multiple computing devices. Some portion or all of the functionality of any component may be distributed or duplicated among multiple computing devices.

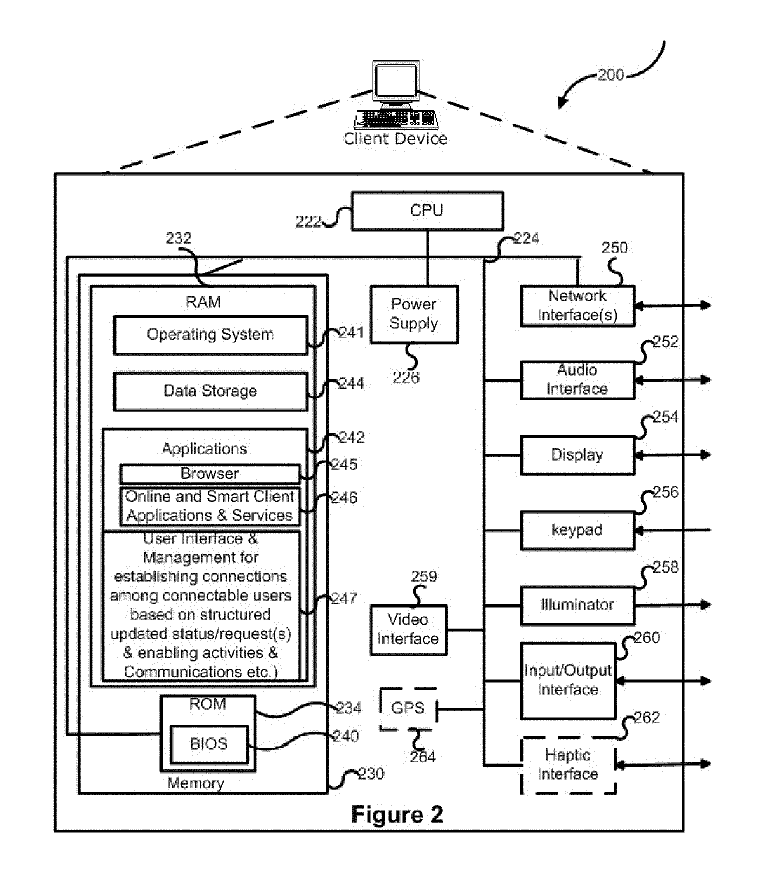

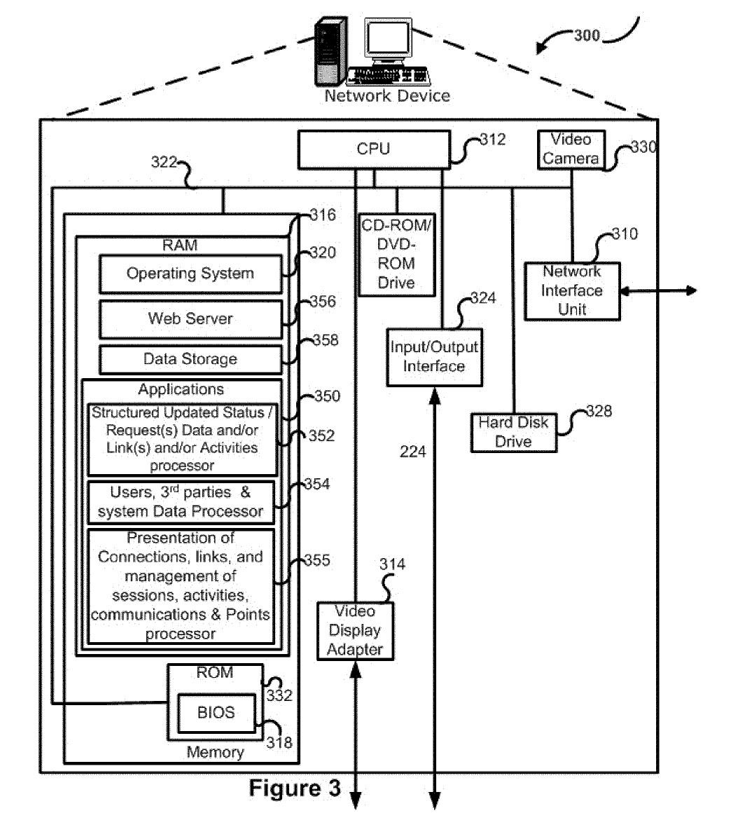

One embodiment of a network device that may be used to implement any one or more of central server(s) 115 or Anybody to Anybody Connections, Messaging & Communication Server(s) or Dynamically presentations of connections & links server(s) is described in more detail below in conjunction with FIG. 3. Briefly, however, such network devices may include any computing device capable of communicating with other network devices to enable network applications or web sites to process, send and respond to structured updated status and/or requests from client devices, such as mobile device 135 is described in more detail below in conjunction with FIG. 2. Devices that may operate as these network devices include personal computers desktop computers, multiprocessor systems, microprocessor-based or programmable consumer electronics, network PCs, servers, and the like, or any combination thereof.

FIG. 1 illustrates an embodiment of a system having an ads server (not shown). Briefly, an advertisings server provides advertisements, such as banner advertisings, application advertisings or other types of advertisements. An application advertisement is an advertisement that is associated with an interaction with an application. It is typically integrated with the application presentation in some way. A search advertising is an example of application advertisings. When a search is performed, a search application may select one or more ads based on the keywords of the search. The search application may combine search ads with the search results, and present them in an integrated manner. In some embodiments, the integration may be so complete that there is not a clear distinction between the search ads and the search results. In some embodiments, one or more ways of indicating the search ads may be included, such as text, color, line separators, and the like. Similarly, other applications may generate application ads. A mapping application, for example, may use the location specification in a request to generate advertisements based on the location, such as those of businesses in the area, and may display an advertisement on the map.

A banner advertisement typically is placed in a location that is separate from, or more distinguishable from, an application's results. For example, it may be at the top or bottom of a page, or along the margin. A banner advertisement may be selected based on criteria similar to those for an application ad, based on different criteria, or randomly selected

Ads server (not shown) may have an associated ads database, which may be integrated or in communication with central server 150. An ads database may store data pertaining to advertisement contents, constraints, and rules pertaining to the use of each advertisement. At least a portion of the data stored in ads server may be specified by an advertiser. An advertiser may specify data describing the advertisement contents, constraints, and rules pertaining to the use of each advertisement.

Ads server may receive data or a set of parameters to use for determining whether to provide an advertisement, selecting and generating an advertisement, including data upon which various determinations are made. Selecting and generating an advertisement may include selecting an advertiser, selecting an advertisement associated with the advertiser, or selecting content to include in an advertisement. The data upon which these and other determinations may be based may include information derived from user data, user profile, information related to interactions among users and interfaces and function links and associate references nodes or objects received by the central server, and the like. The data upon which these and other determinations may be based may also include information about the user or mobile device, actions that the user or mobile device have taken, data pertaining to one or more advertisers, relevant events, and a variety of other types of information.

FIG. 1 illustrates an embodiment in which mobile device 135 communicates with central server 115. A user of mobile device 135, referred to as a provider and/or receiver of structured updated status and/or request data, prospective connections or connectable users, links, messages, shared contents, applications, services & objects may employ mobile device 135 to send and/or receive request data, prospective connections or connectable users, links, messages, shared contents, applications, services & objects to central server 115. Central server 115 may receive and process the request data, prospective connections or connectable users, links, messages, shared contents, applications, services, and objects from mobile device 135. Central server 115 may select a set of connected or related users of user devices 151 and 152. Central server 115 may employ identifiers or addresses of senders and receivers devices, or both. It may, for example, employ a login name or email address of a sender and/or receiver. It may employ an IP address, MIN, or other identifier of a device. Central server 115 may employ any one or more of these identifiers or addressing mechanisms when communicating with a sender and/or receiver device. As used herein, unless the context clearly indicates otherwise, the term “sender” and “receiver” may be used to refer to a person, a device, or a combination of a person and a device.

115 Central server enabling 151, 152, 125 & 135 user(s) to post structured updated status and/or requests based on inputting & selecting pre-created or updated or collaboratively updated generalized or standardized parts of structured updated status and/or requests including types of activities, actions, events, transactions, purposes, user actions, named entities, nodes, items, objects, fields, rules, syntax, locations, keywords, categories, date(s) & time(s) and enabling 115 sever(s) to receive, store, process structured updated status and/or requests and/or user data and/or automatically monitor track, record, store & process user's activities, actions, events, transactions, interactions, senses, behavior, communications, collaborations, sharing, participations, workflows, tasks & requirements and/or enabling to search, match, determine, select & present prospective, suggested, candidate, matched, relevant & contextual connections or connectable 151, 152, 125 & 135 user(s) and dynamically presented or suggested or associated or attached links including link(s) of application(s), service(s), object(s), interface(s) & multimedia type(s) of content(s) to 151, 152, 125 & 135 user(s) or entity/entities of network(s) and enable 151, 152, 125 & 135 user(s) or entity/entities of network(s) to dynamically establishing connections and/or dynamically conducting one or more activities, actions, events, transactions including e-commerce transactions & deals, interactions, communications, collaborations, sharing, searching, presentations, participations, workflows & tasks with one or more selected 151, 152, 125 & 135 user(s) or entity/entities of network(s) from presented prospective, suggested, candidate, matched, relevant & contextual connections or connectable user(s) based on provided or associated or presented or suggested one or more or group(s) of links of application(s), service(s), object(s), interface(s) & multimedia type(s) of content(s).

Illustrative Client Device

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, user client devices 151, 152, 125 and 135 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, video interface 259, a display 254, a keypad 256, an illuminator 258, an input/output interface 260, an optional haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user.

For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Optional haptic interface 262 is arranged to provide tactile feedback to a user of the client device. For example, the optional haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, mobile device may, through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® Operating system. The operating system may include, or interface with a Java virtual machine module that enables control of hardware components and/or operating system operations via Java application programs.

Memory 230 further includes one or more data storage 244, which can be utilized by client device 200 to store, among other things, applications 242 including browser 245, online and smart client applications & services 246 and Anybody to Anybody Connections, Messaging & Communication Management User Interface or User Interface & Management for establishing connections among connectable users based on structured updated status/request(s) & enabling activities & Communications etc.) 247 and/or other data. For example, data storage 244 may also be employed to store information that describes various capabilities of client device 200. The information may then be provided to another device based on any of a variety of events, including being sent as part of a header during a communication, sent upon request, or the like. Moreover, data storage 244 may also be employed to store multimedia information and/or content for later publication, editing, or the like, as well as other information including address lists, contact lists, personal preferences, or the like. At least a portion of the content may also be stored on a disk drive or other storage medium (not shown) within client device 200.

Applications 242 may include computer executable instructions which, when executed by client device 200, transmit, receive, and/or otherwise process messages (e.g., SMS, MMS, IM, email, and/or other messages), content, and enable telecommunication with another user of another client device. Other examples of application programs include calendars, editors, email clients, IM applications, SMS applications, VOIP applications, contact managers, task managers, transcoders, database programs, word processing programs, security applications, spreadsheet programs, games, search programs, Anybody to Anybody Connections, Messaging & Communication Management application, service or interface and so forth. Applications 242 may further include browser 245. Browser 245 may include virtually any of a variety of client applications configured to receive and/or provide communications of web pages, and other content over a network. Browser 245 typically provides for a graphical display of various web pages, including user interfaces provided, in part, by another computing device over the network. Browser 245 may include a variety of security features, and/or other plug-in applications, modules, applets, scripts, or the like, to enable display of animation, videos, playing of audio files, or the like. Browser 245 and applications 242 are configured to enable a user or sender and/or receiver to send and/or connection receive request data for connecting users with requestor, share contents, send & receive messages, communicating with or register, search, match, select, install, subscribe, upload, download, update, upgrade, test, attach, associate and access one or more applications, services, contents from/to/on/by/with one or more sources, destinations, web sites, web pages, applications, services, objects, networks, databases, social networking, and devices based on privacy settings and preferences, match making preferences via sending/receiving to/from central server 115 of FIG. 1. Moreover, through one or more of applications 242 or Anybody to Anybody Connections, Messaging & Communication Management Application or Service or Interface or User Interface & Management for establishing connections among connectable users based on structured updated status/request(s) & enabling activities & Communications etc.) 247, the requestor can input, select, search, match and send request data for connecting with other users of networks for communication, messaging, collaboration, sharing, searching, publishing, participating with activities of connected users, conducting one or more transactions, tasks, workflow and like.

Illustrative Network Device Environment

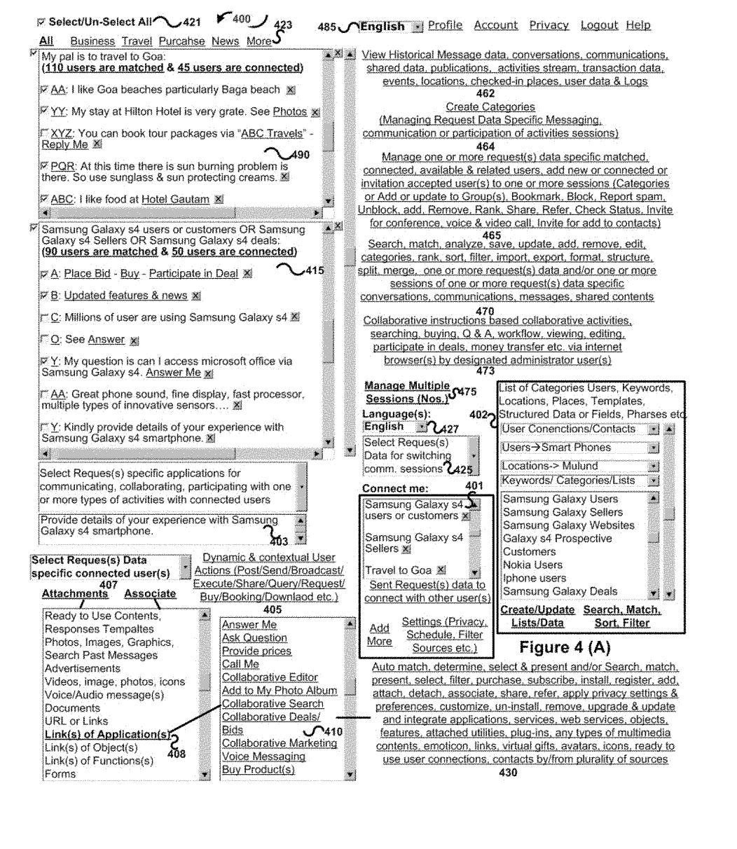

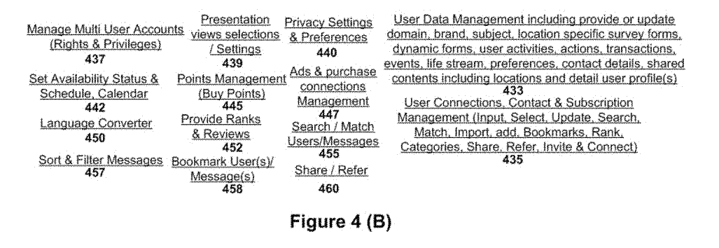

FIG. 3 shows one embodiment of a network device 300, according to one embodiment of the invention. The embodiment of network device 300 illustrated in FIG. 3 may be used to implement the Anybody to Anybody Connections, Messaging & Communication Server(s) 115 of FIG. 1. Network device 300 may include many more components than those shown. It may also have less than all of those shown. The components shown, however, are sufficient to disclose an illustrative embodiment for practicing the invention. One or more network devices, and the application programs integrated with the devices, may be used to implement the processes of the present invention, as illustrated in FIGS. 4-6 and discussed herein.

In any event, network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account managers, and so forth. More detailed discussions of some application programs are included herein.

Mass memory further includes web server 356, data stores 358, and applications 350. Applications 350 are shown to include structured updated status/request(s) data and/or links and/or response(s) and/or activities processor 352, Users, 3rd parties & system Data Processor 354 and Presentation of Connections, links, and management of sessions, activities, communications & Points processor 355. Web server 356 includes virtually any application configured to delivers Web pages and other content to browsers and other client applications via at least the HTTP protocol. However, web server 356 may also be configured to provide scripts, user interfaces, accounting interfaces, editors, security, or the like, to the client application. Moreover, web server 356 may employ a variety of other communication protocols, beyond HTTP. For example, web server 356 may be configured to manage email communication protocols, SMS protocols, IM protocols, or the like. Moreover web server 356 may employ a variety of scripts, applets, programs, or the like, to enable communications of content with a client application.

Data stores 358 may include any of a variety of storage mechanisms, configured to store, and otherwise managed content, applications, scripts, applets, or the like. As such, data stores 358 may be a database, a file structure, or the like. Data stores 358 may store the content into a category structure, such as folders, albums, graphs, trees, or the like, based on a user account, a web service, or the like. In one embodiment, data stores 358 may represent the Data Management services illustrated in FIG. 1, and described in more detail below in conjunction with FIG. 4.

Anybody to Anybody Connections, Messaging & Communication Platform 350 is described in more detail below in conjunction with FIG. 4. Briefly, however, Anybody to Anybody Connections, Messaging & Communication 350 includes a variety of components to provide web services to a user, including structured updated status/Request(s) data and/or link(s) and/or activities and/or response(s) processor 352, Users, 3rd parties & system Data Processor 354 and Presentation of Connections, links, and management of sessions, activities, communications & Points processor 355, Management Interface, search tools, user interfaces, services plug-and-play modules, or the like. Various embodiments of example user interface screens are described in more detail below.

In one embodiment, applications 352 may include structured updated status/Request(s) data and/or link(s) and/or activities and/or response(s) processor 352. An structured updated status/request(s) data and/or link(s) and/or activities and/or response(s) processor 352 may include program logic that performs actions in response to receiving request for matching users for presenting, filtering, identifying, determining, selecting & establishing connections with requestor(s) for conducting communications, messaging, sharing, participate with activities and collaboration among connected users and/or requestor(s) and connected users of network(s) from user(s) or sender(s) client device. These actions may include determining a request data specific connections and connecting matched users with requestor(s) for enabling requestor(s) to select, filter, communicate, receive & send messages, responses, replies, collaborate, share contents, use or access shared applications, services, user profile data.

In one embodiment, applications 350 may include Users, 3rd parties & system Data Processor 354. A Users, 3rd parties & system Data Processor 354 may include program logic that performs actions relating to receiving and processing communications or data related to interactions of user or connected users of users. These actions may include receiving and collecting responses, user interaction data, associating advertising, applying validation, spam control, limits & presentation & privacy settings, preparing response to be sent to the receivers and/or provider(s), or other actions relating to processing communication and responses. These actions are discussed in further detail herein. Though FIG. 4 illustrates structured updated status/Request(s) data and/or link(s) and/or activities and/or response(s) processor 352, Users, 3rd parties & system Data Processor 354 and Presentation of Connections, links, and management of sessions, activities, communications & Points processor 355, the actions and logic of each component may be combined into a single component, divided into multiple components in a different manner, or distributed in a variety of ways across multiple network devices.

Illustrative Operating Environment

Rich (smart) client, a Web client, or a rich Internet application (RIA), Website, Web Page and smart client Architecture

FIG. 4 illustrates Anybody to Anybody Connections, Messaging & Communication management Interfaces or web site(s) or web page(s) or application(s) or service(s) which enables user(s) to register with Anybody to Anybody Connections, Messaging & Communication Server(s) or Dynamically presentations of connections & links server(s) 115 of Anybody to Anybody Connections, Messaging & Communication or Dynamically presentations of connections & links website(s), application(s), service(s), device(s), database(s), web service(s), application programming interface(s), network(s) & platform(s). In another embodiment non-member or visitor or guest or user(s) of 3^{rd} parties' web sites, applications, services, devices, networks, servers & databases can also use Anybody to Anybody Connections, Messaging & Communication management or Dynamically presentations of connections & links Interfaces or web site(s) or web page(s) or application(s) or service(s) 400. Registered users can logged-in 485 with the Anybody to Anybody Connections, Messaging & Communication Server(s) or Dynamically presentations of connections & links server(s) 115 from/via one or more clients, applications, interfaces, web sites, sources, web services, networks & devices. In another embodiment non registered user(s) can access & use Anybody to Anybody Connections, Messaging & Communication management or Dynamically presentations of connections & links Interfaces 400.

User can enter, input, edit, update, search, match, filter, attach and select from one or more types of lists 402 including connections or contacts list, locations list, categories or keywords or phrases or domain or subject specific pre-created request(s) data or taxonomy or ontology or semantic syntax list & user or system created various types of lists, select keyword(s) via auto-fill list(s), select from historical request data, select from structured data of database(s), prepare, import, select, use & attach one or more types of multimedia data including one or more videos, images, voice, sounds, photos, uniform resource locator (URLs), links, files, documents, objects and like, select from suggested request data & templates and send one or more request(s) and/or request(s) data 401 to Anybody to Anybody Connections, Messaging & Communication Server(s) or Dynamically presentations of connections & links server(s) 115 for determining request data 401 specific matched users from pool of users of Anybody to Anybody Connections, Messaging & Communication network(s) or Dynamically presentations of connections & links network(s) 115 and establishing connections among/between requestor(s) and matched or determined users of network(s) and enabling requestor(s) and connected users to send messages, communicate with each other, participate activities of each other, share contents with each other, conduct collaborative activities, actions, events, interactions, transactions, searching, viewing, workflow, tasks and like.

In another embodiment Anybody to Anybody Connections, Messaging & Communication Server(s) or Dynamically presentations of connections & links server(s) 115 and/or connected networks, web sites, users, partners, experts, devices, sensors, modules, databases, applications, web services 115 can monitoring, tracking, detecting, identifying, accepting, collecting, organizing, filtering, orchestrating, recognizing, sensing, recording, indexing, processing and formatting user's one or more activities, actions, events, transactions, requests, search queries, preferences, privacy settings, match making preferences, interactions, behavior, senses, location, places, current location or place, communication, messaging, viewing, collaboration, access, connections, searching, sharing, processing, selections, inputs, tasks, workflows from/with/via/by/to/in/at/within one or more sources, applications, services, objects, profiles, web sites, web pages, sensors, devices, databases, servers, networks, social networks, peer to peer networks and enabling user(s) to send or update request for connecting requestor user(s) with other registered and/or identified user(s) of network(s) and/or automatically send or update request(s) to enabling user(s) to connect with other registered and/or identified user(s) of network(s). Anybody to Anybody Connections, Messaging & Communication Server(s) or Dynamically presentations of connections & links server(s) 115 determines, identifies, searches, matches, selects users of networks for establishing connection(s) among request(s) and determined, identified and matched users of network(s) and Anybody to Anybody Connections, Messaging & Communication Server(s) or Dynamically presentations of connections & links server(s) 115 can connects determined user(s) with requestor(s) for conducting plurality types of activities, actions, transactions, events, interactions, registering, accessing, messaging, communication, sharing, searching, collaboration and participating activities of each other.

In another embodiment client side logic can verify & validate text of request data, process, format, check spellings, grammar & language of user's structured and/or un-structured request(s) data and associate system data including identify data of user for accessing user's all types of data, information & profile, date & time, language, location of user or requestor(s) and location of request(s) data.

In another embodiment Anybody to Anybody Connections, Messaging & Communication Server(s) or Dynamically presentations of connections & links server(s) 115 can processes request(s) data of user(s) of network(s), wherein processing request data comprising formatting, indexing text data mining including text categorization, text clustering, concept/entity extraction, production of granular taxonomies, sentiment analysis, document summarization, and entity relation modeling (i.e., learning relations between named entities), text analytics including information retrieval, lexical analysis to study word frequency distributions, pattern recognition, tagging/annotation, information extraction, data mining techniques including link and association analysis, visualization, and predictive analytics to turn text into data for analysis via application of natural language processing (NLP) and analytical methods, analysis of data including process of inspecting, cleaning, transforming, and modeling data with the goal of discovering useful information, suggesting conclusions, and supporting decision making, converting to appropriate format including language, voice to text, text to voice, structured data, identify text data in image or video, validating & verifying text language and syntax of text, spell or grammar checking, determining, matching, identifying users or receivers for connecting requester(s) with matched user(s) of network(s) based on plurality types of factors including matching sender user's profile, user data, activities, actions, interactions, behavior, purpose, locations, events & transactions data, location, message(s) contents with prospective receiving users or users of network(s)' data, preferences, privacy settings, profile, location, activities, actions, interactions, behavior, purpose, locations, events & transactions data, calculating points & ranks earned by sender(s) and/or prospective receivers or users of network(s) for identifying & determining targeted receiving users or users of network(s) for connecting requestor with matched or determined users of network(s), identifying availability and presence information of prospective receivers or determined users of network(s), dynamically identifying current or updated priorities and limits of receiving messages of prospective receivers or determined users of network(s), applying privacy settings and preferences, associating metadata including keywords, categories, semantic syntax, ontologies, context data and system data including date & time.

In another embodiment after connecting with request(s) data specific user(s) of network(s), user can send and/or receives messages, shared contents questions, answers, communicating with each other including sending and/or receiving instant messages, chats, SMS, MMS, video or voice messages, e-mails, streaming videos or IPTVs, selective video life stream of user(s) and/or connected or related users of user, multimedia presentations, customizable automatic replies, call each other, video or voice call each other, conduct meeting or group conference, collaborate with each other for searching, viewing, deciding, negotiating, transacting, buying products & services, participate with deals, participate with each other's activities and search, match, filter, sort, purchase, store, select, attach, detach, associate, apply privacy settings, capture, import, format, edit, update & send and/or receive, store, edit, update, index, process, use, access, format, share, refer, categories, group(s), sort & filter plurality types of multimedia types of contents including videos, images, graphics, photos, text, rich texts, voice, audio, link, URLs, files, documents, objects, applications, links of applications, services, objects, modules, functions and structured and/or un-structured data including past or historical user data & responses, templates, advertisements, pre-created or dynamically created forms, Products Requirement Specification, Present list of product via web pages or multimedia, Share contents from web, Yellow pages, Dictionaries, News, Microblogging, Comments, Reviews, Status Updates, Publications, Search Results, FAQs, Features, Contacts, Maps & Directions, Blogs, Ready Questions, Ready Answers, Database(s), Search, match & select data records, Ready to use messages, Job Posting, User's Selective Profile, User's Selective Data, Structured Data (XML), Business Card and like 408 & 410.

In another embodiment user can search, match, sort, filter, remove, hide, open, close, minimize, maximize, restore, select various types of views, switch 425 and view each request data specific communication session(s) interface(s) 415 or 490 for communicating, messaging, collaborating, discussing, participate with activities of each other, accessing message associate or attached link(s) associates or referred application(s), web service(s), interface(s), object(s), content(s) and sharing with request data specific connected users.

In another embodiment user can search, match, select, sort, filter, open, re-connect & switch 407 one or more requests data specific identified, bookmarked, matched, selected, ranked & connected users for establishing or continuing or participating or conducting communications, messaging, sharing, one or more types of user activities, actions, instructions, transactions, events, tasks & workflows.

In another embodiment user can search 455, match 455, filter & select one or more persistent or temporary or bookmarked or filtered or searched or matched or ranked connected users 407 and/or communication sessions 415 and/or 419 and/or contents of communication sessions 415 and/or 419 and/or selective user data and/or requests data 425 for taking one or more group actions including sort 457, order, organize, view, filter 457, bookmark 458, share 460, refer 460, synchronize, publish, send, broadcast, advertise, access associate links, categories, text analysis, text mining, data analysis, data mining, update, remove, import, export, backups, restore, encrypt, decrypt, format, index, process, apply one or more matchmaking & processing functions, settings, applications, services & modules including use language convertor, compare, and provide ranks & reviews 452 and other dynamically provided, updated, integrated, customized & installed group user actions or features or buttons.

In another embodiment user can switch language(s) 427 for drafting request data(s) in particular selected language(s), connecting request data specific users related to that language(s), receiving and/or sending contents in selected language(s), viewing & managing interface functions, contents & option in said selected language(s) and use entire Anybody to Anybody Connections, Messaging & Communication interface(s) or application(s) or service(s) or web site(s) in said particular selected language(s) and enabling localization and/or globalization features.

In another embodiment user can manage 433 and provide plurality types of user data including fill-ups or updates domain, brand, subject, location specific survey forms, dynamic forms, enable to monitor, track, identify, detect, sense, record, process, index, format, save & use or access user activities, actions, transactions, events, life stream, preferences, contact details, any types of user generated contents, user connections, social graphs, shared contents including locations and detail user profile(s) to Anybody to Anybody Connections, Messaging & Communication Server(s) or Dynamically presentations of connections & links server(s) 115 for matching said data said user(s) with request(s) data and/or user data of other users of network(s) for establishing connection with them.

In another embodiment providing user connections, contact & subscription management interface 435 to user for managing, inputting, selecting, updating, searching, matching, filtering, sorting, ranking, importing, adding, bookmarking, ranking, categorizing, sharing, referring, inviting & connecting user's present persistent connections including connections or affiliations or kinships or relationships with friends, family, colleagues, classmates, associates, relatives, neighbors, employers, employees, like minded users of network(s) and like.

In another embodiment enabling user to auto match, determine, present & select from list 410 and/or search, match, present, select, filter, purchase, subscribe, install, register, add, attach, detach, associate, share, refer, apply privacy settings & preferences, customize, un-install, remove, upgrade & update and integrate link(s) of application(s), object(s), function(s), web service(s), interface(s) & one or more types of multimedia content(s) 410 and/or applications, services, web services, objects, features, attached utilities, plug-ins, any types of multimedia contents, emoticon, links, virtual gifts, avatars, icons, ready to use user connections, contacts by/from plurality of sources 430.

In another embodiment enabling user to search, match, select, attach, integrate & associate one or more accessible link(s) of application(s), object(s), function(s), web service(s) & one or more types of multimedia content(s) 408 & 410 with message(s) or shared content(s) for enabling receiving & viewing user to access link(s) associated or referred or invoked application(s), object(s), function(s), web service(s), interface(s) & one or more types of multimedia content(s) for send question, provide answer or response, make payments, purchase product(s) and/or service(s), participate in deals or bids, compare products, refer message or user, share contents, reply or forward message, send virtual gifts or emoticon and participate with one or more types of activities, transactions, communications, collaborations.

In another embodiment enabling user to manage multi user & multi members accounts 437. Multi users management including create, modify & disable users, control which features are available to each user, add specific users to everyone's contact list, set default contacts for new users, provide management of activity log, custom defined management levels, custom default settings and like.

In another embodiment enabling user to set, update, customize, add & apply privacy settings and preferences 440 for allowing persistent or global connected users of user and/or request data specific connected users of user and/or other users of networks and/or users of 3^{rd} parties web sites, web pages, applications, services, web services, devices, databases, networks & servers to access, re-share, re-publish, convert, format, import, export, participate, register, making searchable, use, view one or more types of selective user data, connected users' data & user profile, payment information, user requests associate data, user installed applications, services, user activities data, user connections & social graph, user generated data, setting number of users connected to user for each or particular or particular categories or type(s) of request(s), share particular type(s) of content with user(s).

In another embodiment enabling user to set, update, customize, add & apply presentation settings 439 associate with presented, searched, matched, filtered, sorted & selected contents, messages, conversation sessions, applications, user data, user activities logs or life streams, user profiles, user connections, user social graph(s), request data specific connections and communication sessions 490 and/or 415. User(S) is/are also enable to select one or more types of presentation views 439 including multimedia type of view of presentation interface, graphical, tree, explorer, visual, text, web page, web style and associate settings including select fonts, size, style templates etc.

In another embodiment enabling user to search, match, select, share, set, customize, update, broadcast, send, refer & apply one or more types of presence information or availability status 442 including active, away, busy, at work, at home, available, tired, User is also enable to set availability timings, set date & time of availability, use calendar for set various date & time for various types of availability status.

In another embodiment enabling advertiser user to prepare, draft, update, organize, start, pause, cancel, discard one or more advertisement campaign, advertisement group(s) and advertisements for presenting contextual advertisement(s) 447 to user(s) of Anybody to Anybody Connections, Messaging & Communication network(s), web site(s), web page(s), application(s), interface(s), device(s), database(s), server(s) or Dynamically presentations of connections & links server(s) 115 at one or more advertisement places o spaces or in-line advertisement with messages. Advertisers can provide various advertisement criteria including one or more phrases, keywords, categories, languages & locations of users where advertisers want to display advertisements, set budget & bid of advertisement(s) and like.

In another embodiment enabling user to manage, use, access, share, gift, purchase & view earned points, ranks & weights 445. User can earn points based on user's participation with other users of networks, number of times user spent for communicating, messaging for other users of networks, number of users connected with users, total ranks received by user from other users of networks, number of times other users bookmarked user, number of times other users invite & add user to their contact list, number of comments & reviews provided by other users of network to user, number of times user is referred by other users, number of messages sent by users for other users, total amount of purchase transactions conducted by/via user(s), total number of clicks or impressions on user shared contents received by user, total number or types of actions on shared contents received by user from other users of networks, total number of & duration of communication, connections, messaging & collaborative activity sessions, points purchased or received by user(s) and plurality types of other factors.

In another embodiment enabling user to categories request data and associated or related all communication sessions interface(s), messages, shared contents and conversations of all connected users and enabling to switch categories via tabbed or other type of interface 423.

In another embodiment providing management interface for managing multiple request(s) data associate one or more communication, messaging, activities, collaboration sessions with associated connections including set number of users connected with session, add, update, remove associates connected users and enabling user to manage one or more request(s) data specific matched, connected, available & related users, add new or connected or invitation accepted user(s) to one or more sessions, categories or add or update to group(s), bookmark, block, report as spam, unblock, add, remove, rank, share, refer, check status, invite for conference, voice & video call, invite for add to contacts one or more connections of one or more request data 465.

In another embodiment enabling user to search, match, sort, filter, select & purchase connections 447 of users of networks for sending advertisements, commercial messages, buying request, presenting, marketing, conducting e-commerce transactions & conducting one or more types of activities, events, transactions with connected users including one or more types of or categories of or related to one or more keywords, languages, locations, type(s) of activities, actions, transactions, profile attributes or fields including age range, gender, qualification, income range, purchasing history, range of purchasing amount or total amount of user transactions and one or more other types of customized criteria, rules, conditions, search queries, & preferences including duration of acquiring or using connections, re-sharing or re-sell rights, priority, type of activities and like.

In another embodiment enabling user(s) to search, match, select, categories, access, sort, filter, import, export, format, analyze, data mine, text analysis, process, index, store, share & view historical messages, conversations, communications, shared data, publications, activities stream, transaction data, user locations & checked-in places, user data, user profile, user connections, user social graph & various types of log reports 462.

In another embodiment enabling user(s) to search, match, analyze, save, update, add, remove, edit, categories, rank, sort, filter, import, export, format, structure, split, merge, one or more request(s) data and/or one or more sessions of one or more request(s) data specific conversations, communications, messages, shared contents 470.

In another embodiment enabling user(s) to conduct collaborative instructions based collaborative activities, searching, buying, questioning & answering, workflow, viewing, editing, participate in deals, money transfer etc. via internet browser(s) by one or more users and/or designated administrator user(s) 473.

In another embodiment enabling user(s) to manage & update user profile and user accounts 485.

In implementing various types of embodiment including sending customized and personalized request(s) or request(s) data for connecting users of network(s) with other users of network(s) for establishing connections among them and conducting plurality types of communications, sharing, participations with activities of connected users and messaging, herewith some of the examples illustrates implementing various types of embodiment may comprises, wherein user sends various types of exemplary request(s) to connect with other users of networks including but not limited to are:

Connect requesting user with television or stadium viewers of particular sports of particular date & time e.g. cricket, soccer, football, baseball, Olympics for sharing comments, experience, views and scores,

Connect requesting user with users who entered in to R-mall for determining prospective customers and make offers,

Connect requesting user with users of particular collages and/or school who are at Goa for inviting them for coffee or lunch or dinner or collaborative shopping,

Connect requesting user with society members or guest of particular hotels, events etc. for providing feedbacks, suggestions or make complaints,

Connect requesting users based on structured language query/queries e.g. user can enter or select SQL Query: Select users from CurrentLocation=“Goa” and StayAt=“Hotel Rama” or StayAt=“Hotel Gautam” for consulting with them regarding hotel, price range and foods,

Connect requesting user with users who are using Colgate as toothpaste for sharing reviews and suggesting alternatives, sharing health effect,

Connect requesting user with users who are customer or member of particular named shop(s), brand(s), product(s), service(s), companies, web sites, devices, networks, applications for providing customer supports, surveying prospective customers, marketing & selling or e-commerce of products and services,

Connect requesting user with users who are currently eating or eat at “Sukh Sagar” for entertainment, comparison and sharing reviews & comments,

Connect requesting user with users who are presently stand at iPhone store for purchasing iPhone for sharing thoughts, comparison analysis, viewpoints, usage study, information about new features, available new applications and like,

Connect requesting user with provider of particular product(s) and/or service(s) who offers lowest price

Connect requesting user with users who are moving via particular type of vehicle at particular road for communication,

Connect requesting user with users who are surround user for enabling to share information about tourist places, shops, hotel menu, particular event and like,

Connect requesting user with users who are connected with user for creating social networks, sharing photos, call or video call with connected users,

Connect requesting user with family for updating user status,

Connect requesting user with user's professional e.g. lawyer, chartered accountants etc. for consulting with them,

Connect requesting user with colleagues or classmates or all or selected friends for inviting them for movie,

Connect requesting user with particular names <at particular time>

Connect requesting group(s) of user(s) with prospective buyer(s) who are looking for particular smart phone or mobile or device for providing competitive price and negotiate with them,

Connect requesting user with users who are looking for patent attorney for making them client,

Connect requesting user with users who are looking for <particular type(s)> of job for interviewing them, request to send profile, finalizing job, negotiate with them for salary and like,

Connect requesting user with assistants for booking hotel rooms at “Four Seasons”, Hongkong

Connect requesting user with users who are interested in cricket for providing commentary,

Connect requesting user with users who are in Goa for acquiring various types of knowledge and information from them via questions,

Connect requesting user with users who are at particular number of bus at particular time

Connect requesting user with users who are also looking for “Samsung Galaxy Smart phones”

Connect requesting user with particular <named entities> including user(s) associate with particular company, brand, professional, shop, mall, office, service provider, trust, government office or department, apartment, room number or contact address or physical address of user or entity, school, college, class of particular school, college or class, hotels, restaurants, roads, travel place, airport for conducting various types of activities, events, transactions, organizing & participating with events, communication, collaboration, sharing and like,

Connect requesting user with users who are currently purchasing particular product(s) and/or service(s) for providing competitive prices, presenting features, request them to participate with deals wherein deals closes when number of users ordered particular product(s) and/or service(s) included with deal(s) and negotiate with them

Automatic connect requesting user with available other users of network(s) who are purchasing or want to purchase or want details for particular product(s) and/or service(s),

Connect requesting user with users for booking flight for particular destination for particular date & time

Connect requesting user with users who provide me answers for particular question(s) or queries

Connect requesting user with 3 users who are speaking Guajarati as well as English languages.

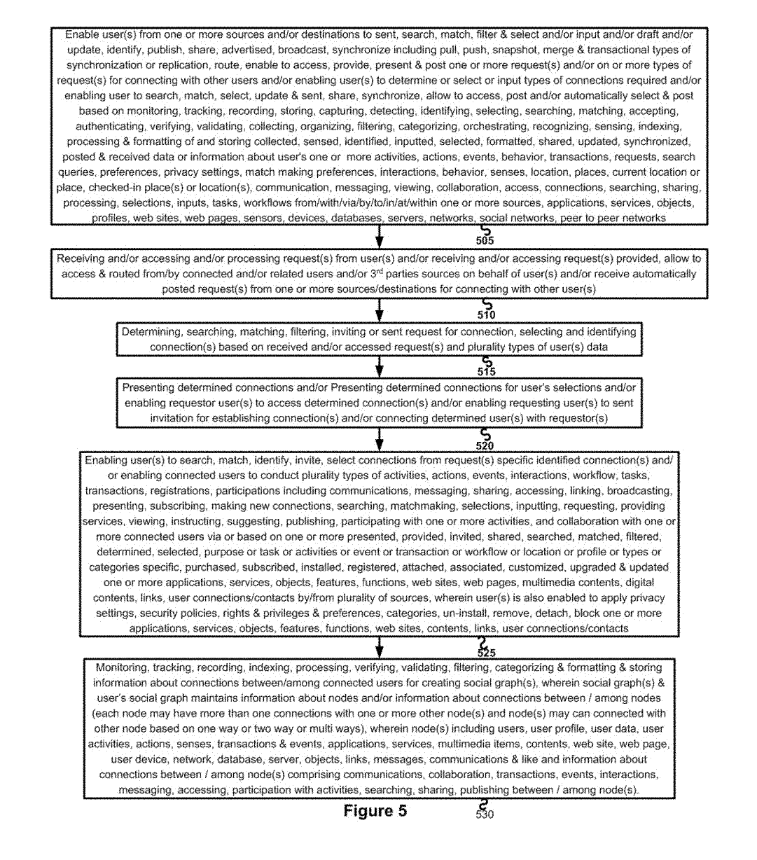

FIG. 5 illustrates in one embodiment flowchart of present invention. 505 shows enabling of user(s) from one or more sources and/or destinations to send, search, match, filter & select and/or input and/or draft and/or update, identify, publish, share, advertised, broadcast, synchronize including pull, push, snapshot, merge & transactional types of synchronization or replication, route, enable to access, provide, present & post one or more request(s) and/or on or more types of request(s) for connecting with other users and/or enabling user(s) to determine or select or input types of connections required and/or enabling user to search, match, select, update & send, share, synchronize, allow to access, post and/or automatically select & post based on monitoring, tracking, recording, storing, capturing, detecting, identifying, selecting, searching, matching, accepting, authenticating, verifying, validating, collecting, organizing, filtering, categorizing, orchestrating, recognizing, sensing, indexing, processing & formatting of and storing collected, sensed, identified, inputted, selected, formatted, shared, updated, synchronized, posted & received data or information about user's one or more activities, actions, events, behavior, transactions, requests, search queries, preferences, privacy settings, match making preferences, interactions, behavior, senses, location, places, current location or place, checked-in place(s) or location(s), communication, messaging, viewing, collaboration, access, connections, searching, sharing, processing, selections, inputs, tasks, workflows from/with/via/by/to/in/at/within one or more sources, applications, services, objects, profiles, web sites, web pages, sensors, devices, databases, servers, networks, social networks, peer to peer networks.

510 shows receiving and/or accessing and/or processing request(s) from user(s) and/or receiving and/or accessing request(s) provided, allow to access & routed from/by connected and/or related users and/or 3rd parties sources on behalf of user(s) and/or receive automatically posted request(s) from one or more sources/destinations for connecting with other user(s).

515 shows determining, searching, matching, filtering, inviting or send request for connection, selecting and identifying connection(s) based on received and/or accessed request(s) and plurality types of user(s) data.

520 shows presenting determined connections and/or Presenting determined connections for user's selections and/or enabling requestor user(s) to access determined connection(s) and/or enabling requesting user(s) to send invitation for establishing connection(s) and/or connecting determined user(s) with requestor(s).

525 shows enabling of user(s) to search, match, identify, invite, select connections from request(s) specific identified connection(s) and/or enabling connected users to conduct plurality types of activities, actions, events, interactions, workflow, tasks, transactions, registrations, participations including communications, messaging, sharing, accessing, linking, broadcasting, presenting, subscribing, making new connections, searching, matchmaking, selections, inputting, requesting, providing services, viewing, instructing, suggesting, publishing, participating with one or more activities, and collaboration with one or more connected users via or based on one or more presented, provided, invited, shared, searched, matched, filtered, determined, selected, purpose or task or activities or event or transaction or workflow or location or profile or types or categories specific, purchased, subscribed, installed, registered, attached, associated, customized, upgraded & updated one or more applications, services, objects, features, functions, web sites, web pages, multimedia contents, digital contents, links, user connections/contacts by/from plurality of sources, wherein user(s) is also enabled to apply privacy settings, security policies, rights & privileges & preferences, categories, uninstall, remove, detach, block one or more applications, services, objects, features, functions, web sites, contents, links, user connections/contacts.

530 shows monitoring, tracking, recording, indexing, processing, verifying, validating, filtering, categorizing & formatting & storing information about connections between/among connected users for creating social graph(s), wherein social graph(s) & user's social graph maintains information about nodes and/or information about connections between/among nodes (each node may have more than one connections with one or more other node(s) and node(s) may can connected with other node based on one way or two way or multi ways), wherein node(s) including users, user profile, user data, user activities, actions, senses, transactions & events, applications, services, multimedia items, contents, web site, web page, user device, network, database, server, objects, links, messages, communications & like and information about connections between/among node(s) comprising communications, collaboration, transactions, events, interactions, messaging, accessing, participation with activities, searching, sharing, publishing between/among node(s).

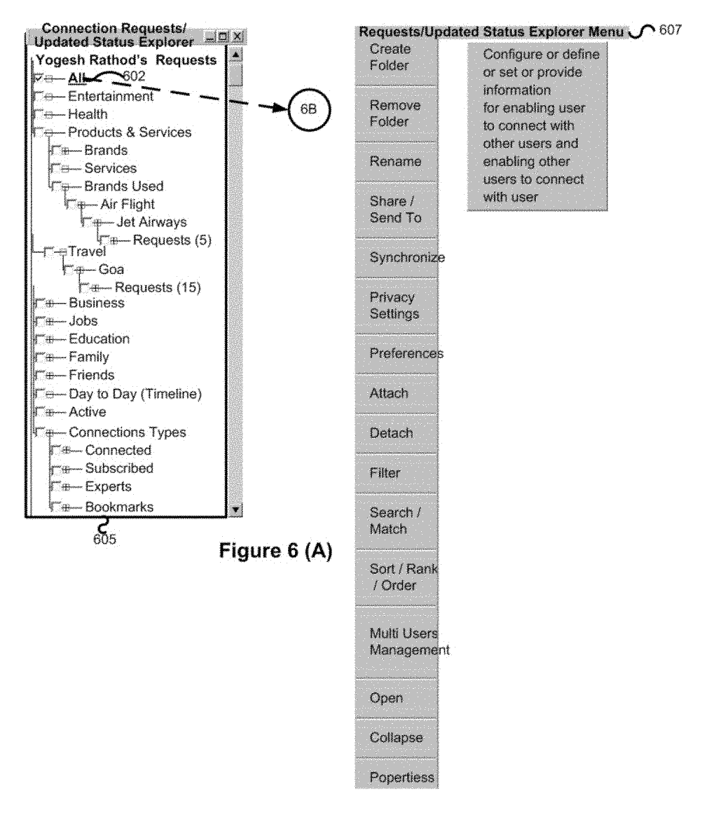

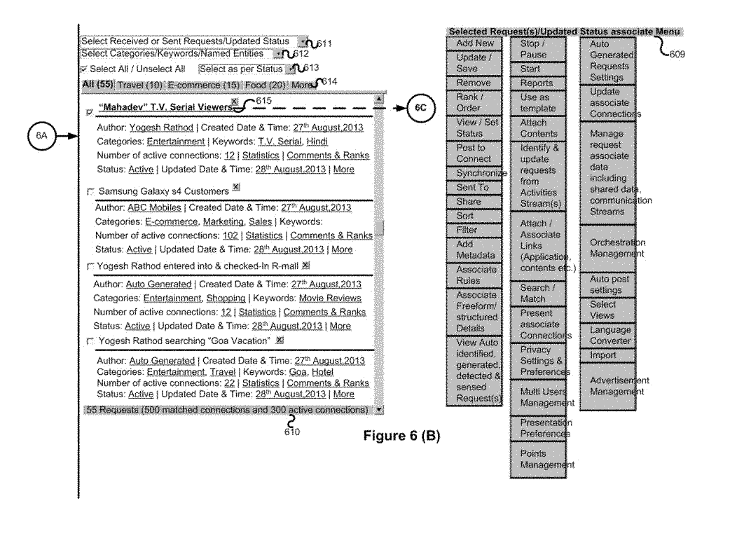

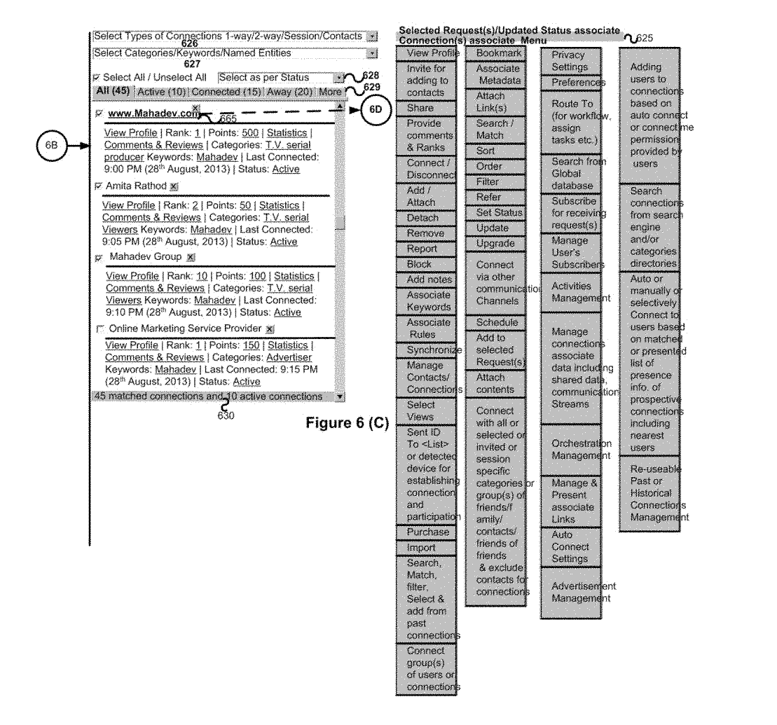

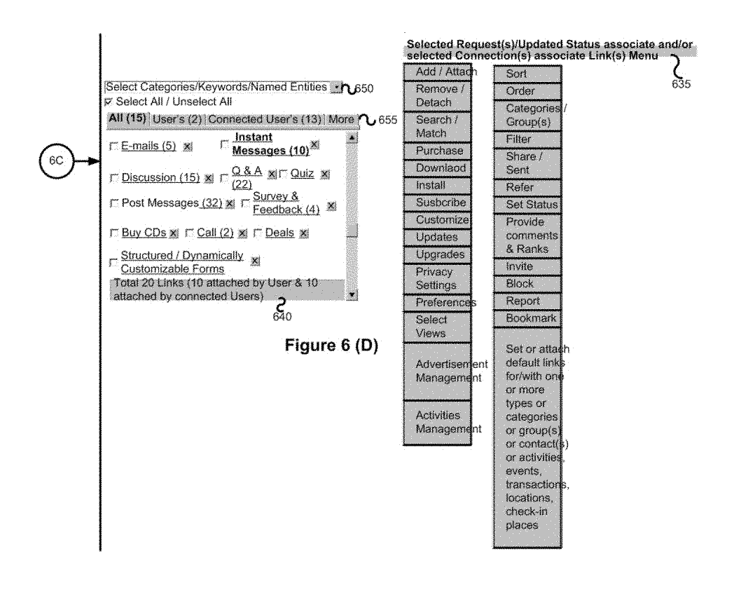

FIG. 6 illustrates in one embodiment user interface for sending or posting requests, accessing presented connections and information about connections, and/or communicating, collaborating, participating with all or selected connected users of user. 605 present plurality types of or categorized user generated or user prepared & posted or auto generated requests. 607 User can access one or more menu items or function(s) associate with menu(s) for one or more selected folders and/or items of explorer including user can create folder(s) for categorizing requests, user can remove folder, rename items, share and/or send and synchronize all or selected explorer folder(s) and/or item(s), associate requests, associate connections and/or resources including links, messages, communications, shared contents, activities stream & like, user can apply privacy settings for accessing full or part or selective items of explorer(s) for one or more users or administrators, user can apply preferences for presentation of explorer items, receiving or subscribing of other user's full or selective part of explorer(s), user can attach or detach one or more items and/or folders of explorer, user can search, match, sort, filter, open & collapse one or more explorer(s) and/or folders and/or associated items and/or associated resources, user can view properties of one or more folders and/or associated items and/or associated resources including author, author profile, metadata, keywords, categories, date & time of creating or modification of folders, items of folders, requests and associate resources, user can also configure or define or set or provide information for enabling other users to connect with user and enable user to connect with other users including connecting users for particular requests, types of purpose & activity, location, place, task, event, transaction, action, workflow at particular date, time, for number of times, for particular locations, places, keywords & categories.

User can clicks on 602 particular item or folder of explorer 605 for accessing 610 associate requests. User can use 614 tabs for accessing categories requests. User can also access requests based on status of requests including sent, received, pending, active, de-active, blocked, and current. User can also access requests based on one or more categories, keywords, named entities. User can view & access request associate 615 metadata including author name, request sent, received, view, update, created & modified date & time, categories, keywords, request associate presented or added or updated connections including number of matched, presented, added, active, de-active, pending, away, busy, removed, blocked & other types of connections, request associate statistics, comments & ranks, current status of request.

User can search, match, filter, sort and select one or more request(s) and can take one or more 609 actions on one or more requests including add new, draft, edit, remove, rank, order, sort, filter, categories, add associate metadata, rules, structured or unstructured details, synchronize and/or send and/or share to one or more users, view, set status update existing or save one or more request(s) and post one or more request(s) for receiving one or more prospective or matched or determined connections for enabling user to connect with other users. User can also view auto generated, identified, detected, sensed, extracted from user's data and/or life stream including activities stream, user actions, transactions, events, history, behavior, locations, places, checked-in places, message stream and information about user's interaction with one or more entities. User can also stop or pause posted request(s) for determining, receiving, presenting & updating of request specific connections. User can also start again stopped or paused & already posted request(s) for determining, receiving, presenting & updating of request specific connections. User can view statistics related to one or more or group(s) of requests. User can also search, match, filter, select, use one or more request as template or tag for newly drafted request(s). User can attach or associate or integrate or package one or more types of contents or multimedia contents including text, video, audio, voice, image, photo, URL or link, object, data record, database, user profile, document, file and one or more types of digital resources with one or more request(s). System can monitors, tracks, detects, senses, identifies, updates, stores & processes user's activities, actions, interactions, transactions, events, behavior, communications, sharing, collaborations, checked-in & current locations & places and enabling user to search, match, select, edit, update selective activities items or activities stream and select, identify, attach, extract, cut, copy, past, edit, derive, update request from activities stream. User can manually and/or automatically or dynamically can also search, match, sort, filter, categories, group, order, rank, select, register, host, store, purchase, download, customize, install, subscribe, update, upgrade, upload one or more links and/or link associate applications, services, objects, user actions, functions, controls, forms, interfaces, one or more types of multimedia contents including text, video, voice, images, photos, URLs or links & documents from one or more sources including one or more networks, web sites, portals, application stores, devices, servers, databases, and 3^{rd} parties developers & service providers and user can also enabled to manually and/or automatically or dynamically search, match, & select one or more links and attach, detach, update, order, group, associate, package & integrate with one or more request(s), wherein automatically or dynamically search, match, determine, select, present, attach, detach, hide, remove, rank, order, sort, share, purchase, download, upload, subscribe, install, update, upgrade, allow to access are based on preferences, privacy settings, needs, updated status, matchmaking of applications, services, object, multimedia content associate profile, privacy settings, rights & privileges, preferences, data & metadata with user's updated activities, actions, events, status, transactions, senses, behavior, inferring or recognizing user's need or requirements, updated status, requests, current or checked-in location(s) and/or place(s) & search query. User can view one or more request(s) associate connections including past, current or present, prospective, ranked, connectable, bookmarked, added to contacts & active connections and are enabled to search, match, filter & select connections and/or invite for adding them to contacts, connect them for communications, collaborations, participating in activities, sharing, conduct one or more workflow, tasks, actions, transactions & events, provide ranks and/or comments, set status, share, assign, transfer & refer connections for enabling other users to connect with them for conducting one or more types of activities, actions, communications, collaborations, sharing, transactions & events, remove or block or report for selected connections, disconnect connected connections, add to group, bookmark connections from selected connections. User can also apply one or more types of privacy settings for sending, posting, synchronizing and/or receiving & presenting associate candidate or prospective or actual connections and/or establishing connections with presented candidate connections. User as an administrator can also manage including apply, associate, provide, input, select, define, set, update, assign multi users roles, rights & privileges, security policies, associate privacy settings & preferences for each member for accessing applications, services, features, data, requests, associate connections, other contacts or connections, associate links, communications data & resources. User can also apply, associate, provide, input, select, define, set, update, assign presentation settings & preferences including default folder, set of requests, set of connections, set of links, view types of presentation including tree, visual, normal or general or default interface, tabular and like, sort order of folders, requests, connections & links and associate data including sort based on date and/or time, categories, keywords, status, types, statistics, locations, languages, current or checked-in location(s) or place(s), fields, values, ranges, ranks, selected, source(s), group(s), types of activities, actions, events, transactions and name. User can manage points including view points earned by users based on various factors, participations, ranks provided by other users & contributions, user can purchase, gift, assign, allocate, categories points for spending for particular category, spent, deposit, debit, credit, view account, transfer, route, provide, send, receive, update, calculate & share point(s) to/from/by/via one or more other users of network(s). User can purchase connections via points or directly purchase selective connections. User can apply, set, update settings & preferences for auto extracting, inputting, notifying before posting for receiving user permission, updating, sending, posting, pausing, starting for receiving or presenting matched contextual connections and/or connecting with other users, identifying, searching, matching, selecting & filtering of one or more auto generated requests. User can also update connections for selective request(s). User can manage including search, match, select, view, edit, update, remove, filter, order, sort, share, synchronize, bookmark, import, export, backup, restore, apply privacy settings, rank, provide ranks & comments, set status for one or more requests associated one or more types associate content(s). User can also orchestrate and/or choreograph requests including order or sequence or schedule or specify rules of posting of requests, receiving of connections, connecting with selected candidate connections, conducting one or more types of activities, actions, tasks, workflows, transactions, events, sharing, communications, and collaborations. User can also apply, select, set, and update settings& preferences for auto posting of requests including schedule posting of request(s) or post particular types of categories of requests. User can also select views for presentation of requests including list, tree & visual views of presentation of requests and associate features. User can also use language converter functionality for converting request and/or associate data from one or more types of languages to one or more selected types of languages. User can also import request or data for preparing or updating request(s). User can use advertisement management for creating or updating one or more advertisement campaigns, prepare, draft, update, post, start, pause one or more group(s) of advertisements and/or associate advertisement(s). Advertiser(s) can bid or make payment based on/for making or connecting with number of connections, duration of engagement with connected users, market, present, negotiate, buy & sell of products & services with connected users, types of participation of connected users with advertisers including fill surveys, install applications, subscribe service, & participate in deals by connected users with advertiser(s) for particular advertisement(s) or group or type or categories of advertisement(s) or request(s) data.

630 shows list(s) of matched, stored, received, presented, bookmarked, added, selected, searched, filtered, updated, active, pending to connect, ordered, sorted, ranked, in-active connections for one or more selected requests. User can 665 view profile(s), rank(s), points, statistics, comments & reviews, categories, keywords, date(s) & time(s) of presented, received, connected & last connected, and status of/associate with connection(s). 626 User can select types of connections including one way connected and/or two way connected connections or connected users, connected users or connections associate or relate with particular session(s) and/or particular type(s) of session(s) and/or 628 type(s) of status and/or 627 keywords and/or categories and/or named entities and any combination thereof. User(s) can also select categories 629 tabs for selecting particular type(s) or group(s) or categories or status specific connections.

625 User can search, match, select presented or provided or received candidate or prospective or temporary or purpose specific connections from one or more request(s) to inviting them for adding them to contacts or new connections. User can share, provide comments & ranks, connect, disconnect, add, update, remove, attach with one or more other requests, block, add notes, associate keywords, rules & categories, synchronize including pull, push, snapshot, merge & transactional replications types, manage existing, select views for, send id or accessible link(s) of connection(s) to one or more selected destinations or sources, purchase, receive as gift, transfer from other users, import, export, search, match, filter, select & add from past connections, bookmark, associate metadata & system data, attach link(s), search, match, sort, filter, order, refer, set status, update, upgrade, connect via/at/from/with/in/on/to other communication channels, web sites, applications, services, networks, devices, & servers, schedule, added to/with one or more selected request(s), apply privacy settings & preferences, route to particular or selected users for particular or selected purpose(s), attach & update contents, search, match, select, filter, subscribe, receive, update, request, purchase from central or global database(s) and/or database(s) of 3^{rd} parties providers of connections, search from directories one or more or group(s) or sequence(s) of connections or selected connections.

625 User can also subscribe for receiving requests of connections in user's set of or selective connections and/or connections based on one or more types of models including free, paid, sponsored, subscriptions, points earned, payment, and gift. User can also allow others to subscribe user's request(s) for connecting user's with their set of or selective connections. User can also manage connections including search, match, filter, sort, rank, order, group(s), and categories, add, remove, update, invite, share, refer, import, export, purchase, assign, transfer, provide, send, receive, post, publish, access, set status, provide privacy settings, synchronize one or more or set of connections.

625 User can also connect group(s) of users or connections. User can connect with all or selected or invited or session specific categories or group(s) of friends/family/contacts/friends of friends & exclude contacts for connections. In another embodiment adding connectable users to list of connections based on auto connect or connect me permission provided by users.

625 User can search, match, sort, filter, categories, group, order, rank, select, register, host, store, purchase, download, customize, install, subscribe, update, upgrade, upload one or more links and/or link associate applications, services, objects, user actions, functions, controls, forms, interfaces, one or more types of multimedia contents including text, video, voice, images, photos, URLs or links & documents from one or more sources including one or more networks, web sites, portals, application stores, devices, servers, databases, and 3^{rd} parties developers & service providers and user can also enabled to search, match, & select one or more links and attach, detach, update, order, group, associate, package & integrate with one or more request(s).

625 System can monitors, tracks, identifies, sense, detects, recognize, records, stores user's activities related to or associate with connections among users or connected users including information about connections between connected nodes including identity, data & time of connections, status, duration or time spent per sessions, number of times connected, exchange or sharing of data, communications, messaging, workflow, collaborations, participation and like.

625 User can manage including search, match, select, view, edit, update, remove, filter, order, sort, share, synchronize, bookmark, import, export, backup, restore, apply privacy settings, rank, provide ranks & comments, set status for one or more connections and/or requests specific connections associated one or more types associate content(s).

625 User can also orchestrate and/or choreograph connections and/or connecting with candidate connections processes and/or request(s) specific or associated or related connections including order or sequence or schedule or specify rules for connecting, disconnecting, accessing, using, plugging, integrating, attaching, associating, assigning, transferring, routing, sharing, referring & receiving of one or more connections, connecting with selected candidate connections, conducting of one or more types of particular activities, actions, tasks, workflows, transactions, events, sharing, communications, and collaborations with connected users.

625 User can also manage connection(s) associate link(s) including search, match, filter, select, attach or associate, access, use, invoke one or more links with one or more connection(s).

625 User can set, apply, select, input & update auto connections or disconnecting settings & preferences including connect or disconnect with one or more candidate connections at particular data & time and/or as per schedule and/or based on triggering of particular user actions, activities, workflow, tasks, communications, sharing, messaging, status, collaborations, events, behavior, interactions, transactions, identifying of location(s) or place(s).

625 Advertiser user(s) can also present advertisement(s) to particular or selected presented or contextual candidate connections based on targeted advertisement criteria including keywords, categories, location, language, user data, and user profile and/or other users' requests. Advertiser(s) can also bid for presenting advertisements to connected users prior to other competitors' advertisements. Advertisement(s)'s targeting criteria is/are matched with request(s) data of users of network(s) and advertisement(s) is/are presented to matched or contextual users and/or advertiser is/are connected with contextual requestor(s), so advertiser(s) can present & sell products and/or services, communicate, collaborate, share & provide answers of prospective customers and connected advertisers and/or requestors or prospective customers can also participate with each other's activities.

625 User can also automatically or manually or selectively connect based on matched or presented list of presence information of prospective connections including nearest users. For example users who are attending meeting are presented with identities of other attendees at user device so each user can connect with each other user and can conduct one or more activities, actions, events, transactions, communications, sharing and collaboration.

625 System can intelligently stores, bookmarks, saves, formats, processes, orders, ranks & presents past or historical connections and enabling user(s) to access, use, manage, search, match, filter, rank, order, view, select and connect to users or candidate or prospective connections from past or historical connections based on request data, search queries, filter criteria. System can also automatically present connections from past or historical connections based on rank provided by user and/or system, bookmarks, past usage history of connections by user, number of times user was connected with said connections, similar type(s) of user's activities, posted requests, actions, events, interactions, behavior, transactions, current locations or places, check-in locations or places.

User can 665 select, access, use & invoke one or more links 640 of one or more connections 630.

User can also 635 add, remove, update, attach or detach one or more 640 links from/with set of 640 links of or associate with 630 or 665 selected connection(s). User can search, match, sort, rank, filter, order, rank, purchase, install, subscribe, download, customize, update, upgrade, share, send to selected, refer, block, report, bookmark, categories link(s) or group(s) of links. User can also apply privacy settings & preferences, provide ranks & comments and set status for/to one or more link(s) associate applications, services, shared contents, objects, user data, user profile, user connections & user social graphs. User can invite other connected users or candidate or prospective connected user(s)'s for collaborating & sharing links and/or via links and/or via referred or associated applications, services, shared contents, objects, user data, user profile, user connections & user social graphs.

User can also set, select, apply, input or attach default links for/with one or more types or categories or group(s) or contact(s) or connections or requests or activities, actions, events, transactions, locations and check-in places.

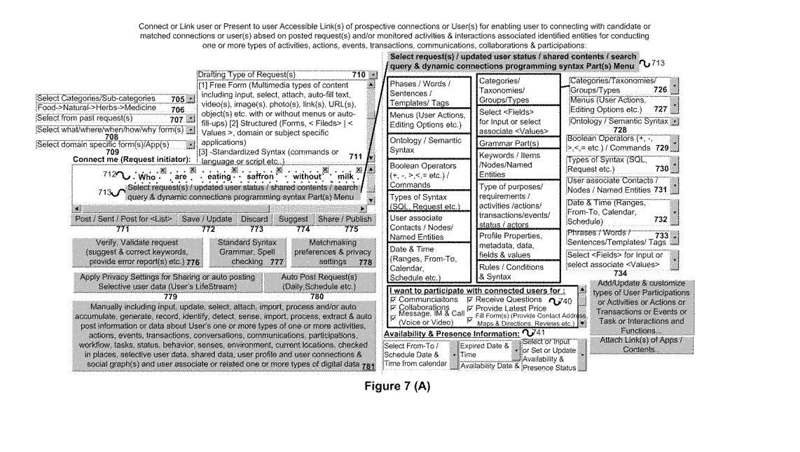

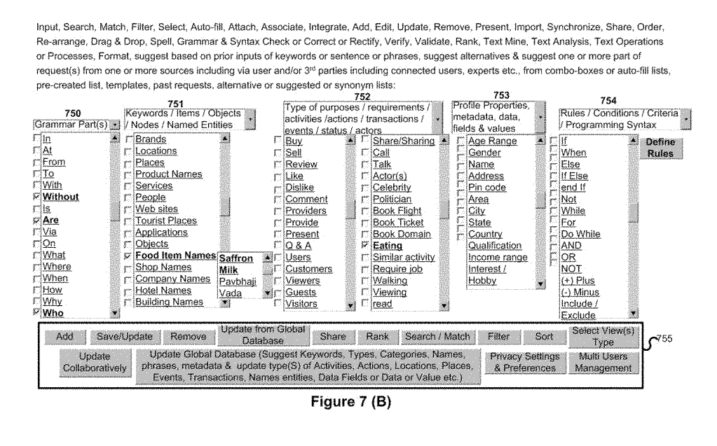

FIG. 7 illustrates user interface for enabling user to connect or link user or present to user accessible link(s) of prospective connections or user(s) for enabling user to connecting with candidate or prospective or matched connections or user(s) based on one or more posted structured request(s) and/or request(s) and/or monitored, tracked, stored and extracted activities stream for conducting one or more types of activities, actions, events, transactions, communications, collaborations & participations with prospective or connectable or presented or connected users.

User or request source or request initiator or request entry point can 712 draft, prepare, edit, update requests including select & update from 706 past request(s) and/or 712 select, select via 713 menu and/or select via intelligent auto fill-ups, input, edit, remove, compose, update and/or order one or more keywords, categories, taxonomies for drafting request(s). User can also select 709 standardized domain or subject specific forms and/or applications for inputting, searching, matching, attaching, associating, selecting details of requests including 708 providing what, when, how, why, where, who aspects of request(s).

User can also use 710 free form including input, select, attach one or more types of multimedia contents including input, select, edit, update, process, format, attach, auto-fill text, video(s), image(s), photo(s), link(s), documents, URL(s) & object(s) via or without menus or auto-fill-ups. User can also prepare, configure, customize, search, match, purchase, and select structured forms, domain or subject specific applications, dynamically generated or customized forms. User can configure, select, update & inputs form associate and associate fields and associate values. User can also select, input, edit standardized syntax of requests including commands or standardized request language(s) or script.

User is also enabled to Input, Search, Match, Filter, Select, Auto-fill, Attach, Associate, Integrate, Add, Edit, Update, Remove, Present, Import, Synchronize, Share, Order, Re-arrange, Drag & Drop, Spell, 777 Grammar & Syntax Check or Correct or Rectify, Verify, Validate, Rank, Text Mine, Text Analysis, Text Operations or Processes, Format, suggest based on prior inputs of keywords or sentence or phrases, suggest alternatives & suggest one or more part of request(s) from one or more sources including via user and/or 3rd parties including connected users, experts etc., from combo-boxes or auto-fill lists, pre-created list, templates, past requests, alternative or suggested or synonym lists.

User can access, invoke & use 713 menu(s)/sub-menu(s) from within editor for selecting or auto filling one or more 726 Categories, Taxonomies, Groups & Types, 727 Menus including User Actions, Editing Options, Spell or grammars checking, 728 Ontology & Semantic Syntax, 729 Boolean Operators including plus, minus, not, include, exclude, greater than, less than, equal to (+, >,<,=) and Commands, 730 Various types of Syntax (Structured queries language (SQL), Standardize Request Language), 731 User associate contacts, nodes & named entities, 732 Date & Time including (Ranges, From-To, Calendar specific multiple entries, Schedule), 733 Phrases, Words, Sentences, Templates & Tags, 734 Select <Fields> for Input or select associate <Values>, 750 Grammar Part(s), 751 Keywords, Items, Nodes & Named Entities, 752 Type of purposes, requirements, activities, actions, transactions, events, status & actors, 753 Profile Properties, metadata, data, fields & values, 754 Rules, Conditions & Syntax.

User can 755 add, save, edit, update, remove, attach, detach, search, match, select, sort, rank, order, update from global database, share, refer, suggest, select view type(s), update collaboratively by one or more connected or related or invited users, apply privacy settings & preferences for one or more items of one or more 713/726-734/750-754 list(s). User can also update Global Database including Suggest Keywords, Types, Categories, Names, phrases, metadata & update Activities, Actions, Locations, Places, Events, Transactions, Names entities, Data Fields or Data or Value.

771 Posting of free form and/or standardized 712 keywords, categories, commands, rules, syntax, items, nodes, named entities via 712 request(s) editor or application or interface enables determining of matched candidate or prospective 630 connections for 712 user request(s) and/or for user's current or particular activities, actions, events, transactions, senses, locations places, interactions associate entities, and/or enables user(s) to search & match candidate or prospective connections for conducting plurality types of communications, collaborations, sharing, accessing of contents, applications & services, tasks, workflows, activities, actions, events, & transactions.

User can also 772 save or update, 723 discard, 775 share or publish or synchronize or send request(s). User can select from 774 suggested list(s) of request(s). User can verify, test & validate standardized syntax, sequence of request(s) and view errors & rectify errors for enabling more contextual determination of prospective or candidate connections for user's request(s).

Optionally user can also 740 add, attach, customize, select, input & update what user want to do for connected users with request(s) including what types of functions, actions, accessible links user want to use for communicating, collaborating, sharing, participating, conducting one or more types of activities, actions, transactions, events with connected users.

Optionally user can also provide 741 availability and/or presence information with request(s) for connecting with presented contextual or matched or related prospective and/or candidate connections including date & time of availability, expiration date & time, date & time ranges, schedules, use calendars for multiple entries for one or more types of connections and user status.

Optionally user can also 778 provide, select, set, apply, update & input matchmaking default and/or customize or request specific preferences & privacy settings for receiving, matching, determining, selecting candidates or prospective connections.

Optionally user can also 779 provide, select, set, apply, update & input settings for sharing of request(s) and/or auto posting of request(s) extracted from user's data including user's activities, actions, events, transactions, current locations or places, checked-in locations or places associate data and user's life stream.

Optionally user can also 780 provide, select, set, apply, update & input settings for auto posting of one or more requests including automatically post drafted or generated requests and schedule of auto posting.

User can 781 manually including input, update, select, attach, import, process and/or auto accumulate, generate, record, identify, detect, sense, import, process, extract & auto post information or data about User's one or more types of one or more activities, actions, events, transactions, conversations, communications, participations, workflow, tasks, status, behavior, senses, environment, current locations, checked in places, selective user data, shared data, user profile and user connections & social graph(s) and user associate or related one or more types of digital data.

User can also stop or pause or start determining and receiving of posted or identified request(s) specific prospective or candidate connections from one or more sources.

In one embodiment based on storing standardized 712 request(s) posted by users of network(s), system can determine, identify, infer, search, match, filter, compare, linking, mapping, monitoring, tracking, orchestrate, order, sequence, choreograph, aggregate, rank, sort & select who was/were did or is/are going to do or is/are doing or want(s) to do what, where, when, how, why and/or facilitate for conducting one or more types of activities, actions, events, transactions and/or similar types of activities, actions, events, transactions and enable users of networks to search & match connections for one or more posted and/or auto generated and/or auto posted request(s) for conducting one or more types of communications, messaging, collaborations, sharing, participate with each other's activities, take one or more actions, and to-do one or more types of transactions, e-commerce, deals. Standardize syntax enables server(s) to search, match, request, invite, identify & infer, update, rank, order, present and determine request(s) specific contextual connections for requestor(s).

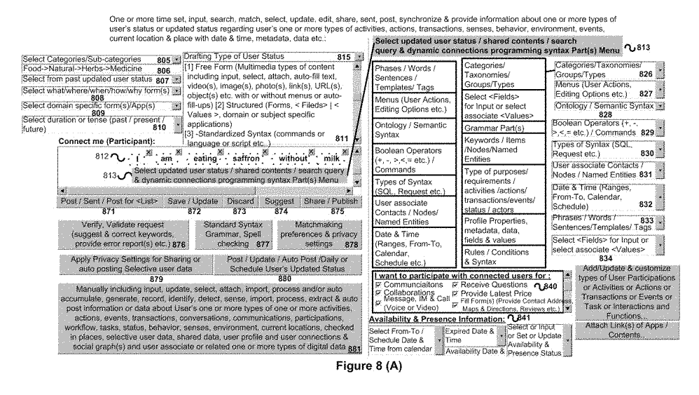

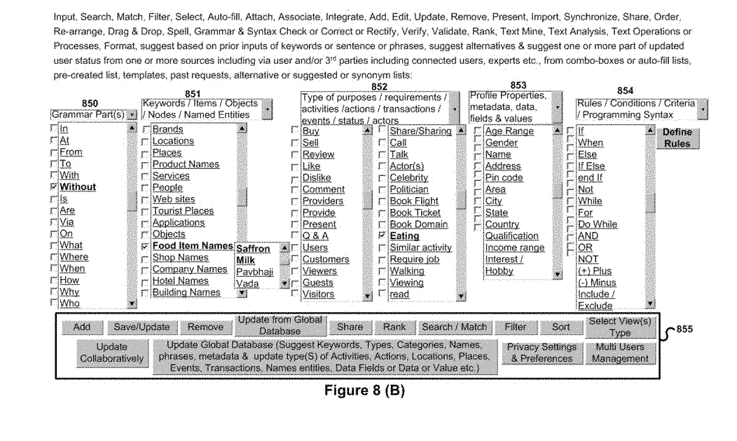

FIG. 8 illustrates user interface for enabling user to one or more time set, input, search, match, select, update, edit, share, send, post, synchronize & provide information about one or more types of user's status or updated status or structured updated status regarding user's one or more types of activities, actions, transactions, senses, behavior, environment, events, current location & place with date & time, metadata, data and like.

User or updated status source or participant with request(s) or updated status initiator or user's updated status entry point can 812 draft, prepare, edit, update updated status including select & update from 807 past updated status and/or 812 select, select via 813 menu and/or select via intelligent 812 auto fill-ups, input, edit, remove, compose, update and/or order one or more keywords, categories, taxonomies for drafting updated status(s). User can also select 809 standardized domain or subject specific forms and/or applications for inputting, searching, matching, attaching, associating, selecting details of updated status including 808 providing what, when, how, why, where, who aspects of updated status.

User can also use 815 free form including input, select, attach one or more types of multimedia contents including input, select, edit, update, process, format, attach, auto-fill text, video(s), image(s), photo(s), link(s), documents, URL(s) & object(s) via or without menus or auto-fill-ups. User can also prepare, configure, customize, search, match, purchase, and select structured forms, domain or subject specific applications, dynamically generated or customized forms. User can configure, select, update & inputs form associate and associate fields and associate values. User can also select, input, edit standardized syntax of updated status including commands or standardized updated status language(s) or script.

User is also enabled to Input, Search, Match, Filter, Select, Auto-fill, Attach, Associate, Integrate, Add, Edit, Update, Remove, Present, Import, Synchronize, Share, Order, Re-arrange, Drag & Drop, Spell, 877 Grammar & Syntax Check or Correct or Rectify, Verify, Validate, Rank, Text Mine, Text Analysis, Text Operations or Processes, Format, suggest based on prior inputs of keywords or sentence or phrases, suggest alternatives & suggest one or more part of updated status from one or more sources including via user and/or 3rd parties including connected users, experts etc., from combo-boxes or auto-fill lists, pre-created list, templates, past updated status, alternative or suggested or synonym lists.

User can access, invoke & use 813 menu(s)/sub-menu(s) from within editor for selecting or auto filling one or more 826 Categories, Taxonomies, Groups & Types, 827 Menus including User Actions, Editing Options, Spell or grammars checking, 828 Ontology & Semantic Syntax, 829 Boolean Operators including plus, minus, not, include, exclude, greater than, less than, equal to (+, >,<,=) and Commands, 830 Various types of Syntax (Structured queries language (SQL), Standardize updated status Language), 831 User associate contacts, nodes & named entities, 832 Date & Time including (Ranges, From-To, Calendar specific multiple entries, Schedule), 833 Phrases, Words, Sentences, Templates & Tags, 834 Select <Fields> for Input or select associate <Values>, 850 Grammar Part(s), 851 Keywords, Items, Nodes & Named Entities, 852 Type of purposes, requirements, activities, actions, transactions, events, status & actors, 853 Profile Properties, metadata, data, fields & values, 854 Rules, Conditions & Syntax.

User can 855 add, save, edit, update, remove, attach, detach, search, match, select, sort, rank, order, update from global database, share, refer, suggest, select view type(s), update collaboratively by one or more connected or related or invited users, apply privacy settings & preferences for one or more items of one or more 813/826-834/850-854 list(s). User can also update Global Database including Suggest Keywords, Types, Categories, Names, phrases, metadata & update Activities, Actions, Locations, Places, Events, Transactions, Names entities, Data Fields or Data or Value.

871 Posting of free form and/or standardized 812 keywords, categories, commands, rules, syntax, items, nodes, named entities via 812 updated status editor or application or interface enables determining of matched candidate or prospective 630 connections for 812 user updated status and/or for user's current or particular activities, actions, events, transactions, senses, locations places, interactions associate entities, and/or enables user(s) to search & match candidate or prospective connections for conducting plurality types of communications, collaborations, sharing, accessing of contents, applications & services, tasks, workflows, activities, actions, events, & transactions.

User can also 872 save or update, 823 discard, 875 share or publish or synchronize or send updated status. User can select from 874 suggested list(s) of updated status. User can verify, test & validate standardized syntax, sequence of updated status and view errors & rectify errors for enabling more contextual determination of prospective or candidate connections for user's updated status.

Optionally user can also 840 add, attach, customize, select, input & update what user want to do for connected users with updated status including what types of functions, actions, accessible links user want to use for communicating, collaborating, sharing, participating, conducting one or more types of activities, actions, transactions, events with connected users.

Optionally user can also provide 841 availability and/or presence information with updated status for connecting with presented contextual or matched or related prospective and/or candidate connections including date & time of availability, expiration date & time, date & time ranges, schedules, use calendars for multiple entries for one or more types of connections and user status.

Optionally user can also 878 provide, select, set, apply, update & input matchmaking default and/or customize or updated status specific preferences & privacy settings for receiving, matching, determining, selecting candidates or prospective connections.

Optionally user can also 879 provide, select, set, apply, update & input settings for sharing of updated status and/or auto posting of updated status extracted from user's data including user's activities, actions, events, transactions, current locations or places, checked-in locations or places associate data and user's life stream.

Optionally user can also 880 provide, select, set, apply, update & input settings for auto posting of one or more updated status including automatically post drafted or generated updated status and schedule of auto posting.

User can 881 manually including input, update, select, attach, import, process and/or auto accumulate, generate, record, identify, detect, sense, import, process, extract & auto post information or data about User's one or more types of one or more activities, actions, events, transactions, conversations, communications, participations, workflow, tasks, status, behavior, senses, environment, current locations, checked in places, selective user data, shared data, user profile and user connections & social graph(s) and user associate or related one or more types of digital data.

User can also stop or pause or start determining and receiving of posted or identified updated status specific prospective or candidate connections from one or more sources.

In one embodiment based on storing standardized 812 updated status posted by users of network(s), system can determine, identify, infer, search, match, filter, compare, linking, mapping, monitoring, tracking, orchestrate, order, sequence, choreograph, aggregate, rank, sort & select who was/were did or is/are going to do or is/are doing or want(s) to do what, where, when, how, why and/or facilitate for conducting one or more types of activities, actions, events, transactions and/or similar types of activities, actions, events, transactions and enable users of networks to search & match connections for one or more posted and/or auto generated and/or auto posted updated status for conducting one or more types of communications, messaging, collaborations, sharing, participate with each other's activities, take one or more actions, and to-do one or more types of transactions, e-commerce, deals. Standardize syntax enables server(s) to search, match, request, invite, identify & infer, update, rank, order, present and determine updated status specific contextual connections for requestor(s).

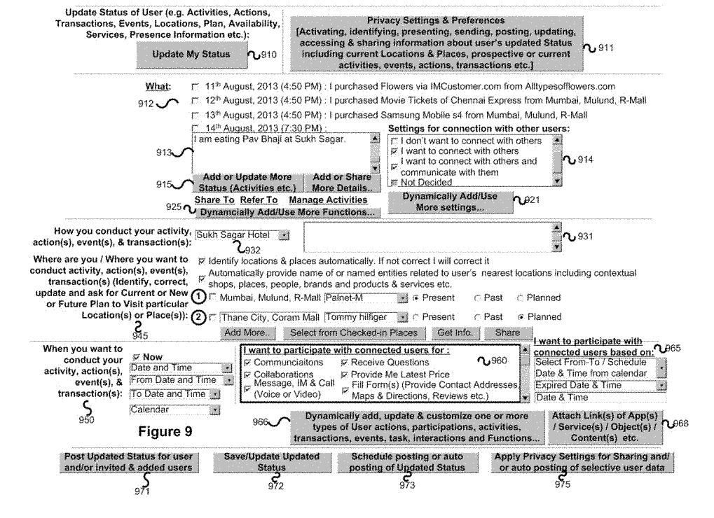

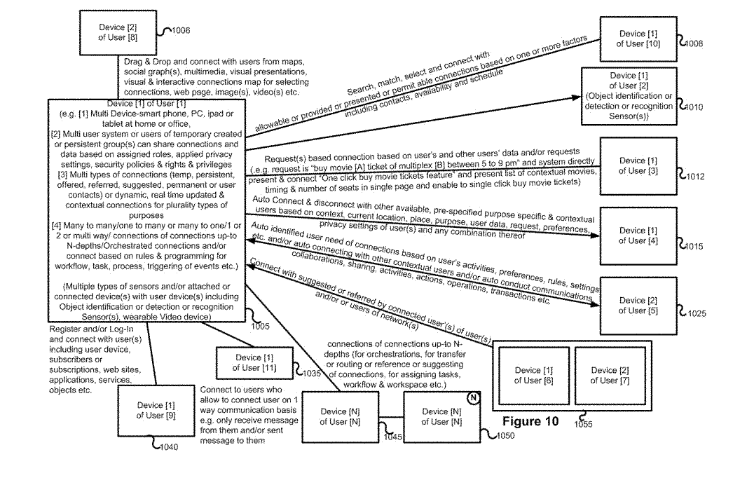

In another embodiment FIG. 9 illustrates user interface for providing & updating user status. 910 when user clicks on “Update My Status” button, user is presented with interface for providing details of updated status including what, when, how, why, who, where & when aspects related to/of updated status. Update Status of User may related to user's one or more activities, actions, transactions, events, locations, plan, availability, services, presence Information.

911 User can apply, set, input, update, configure & select privacy settings & preferences including activating, identifying, presenting, sending, posting, updating, accessing & sharing information about user's updated status including current locations & places, prospective or current activities, events, actions, transactions to/at one or more distinctions & sources.

User can provide, add, and update details of one or more past and/or present and/or pre-planned activities, actions, events, transactions, interactions, tasks, workflow & visiting of locations and/or places, wherein details including 912 what user want to do/did/will do, 931 and/or 932 how user can conduct his/her activity or activities, action(s), event(s), & transaction(s), 945 where user(s) is/are and where user want to conduct activity, action(s), event(s), transaction(s) including identify, correct, update and fill current or new or future plan to visit particular location(s) or place(s), identify locations & places automatically and if location entry is not correct than user will correct it and automatically provide name of or named entities related to user's nearest locations including contextual shops, places, people, brands and products & services, 950 when user want to conduct his/her activity, action(s), event(s), & transaction(s) including now, particular or from-to date & time, calendar based setting of date & time,

915 User can add or update one or more updated status for user and/or one or more other users including all or selected connected users of user. User can provide or update more details for one or more updated status. 914 User can apply settings for connecting with other users of network(s) including user want to connect with other users or not, user wants to connect with others and communicate with them and user not decided to connect or not connect with other users of network(s). User can also dynamically add more default settings for connecting with all or selected or particular type(s) of users for one or more types of activities, actions, events & transactions. 925 User can also share, suggest, post & refer activities to one or more connected or selected users of user. User can also dynamically add one or more functions for take one or more actions on one or more drafted and/or posted and/or updated status including updated status related to one or more activities, actions, events, status, current or checked-in locations or places & transactions.

960 User can also select what user want to do with connected users for particular or particular types of updated status, activities, actions, events & transactions including user want to communicate, collaborate, send and/or receive instant messages and/or assess instant messenger, receive questions, provide me latest price, fill form(s) including user is ready to share user data in structured data form including provide contact addresses, maps & directions, reviews and like.

966 User can also dynamically add, update, & customize one or more types of user participations, activities, actions, transactions, tasks, interactions and functions.

965 User can also set, apply, select, input & update date & time, range of date & time and schedule when user want to connect with other users for one or more updated status and/or one or more types of updated status.

968 User can also attach, detach & associate one or more links with one or more or group(s) of updated status of one or more users, wherein links enable other users to view shared contents, access applications & services, use functions and participating activities of/with connected user(s).

971 User can post updated status on behalf of user and/or all or one or more or group(s) of connected or related or selected users. User can also invite other users for posting updated status for one or more other users who accept invitations and allow user to post updated status on behalf of them. For example user [Y] and his family visit hotel [W] than user [Y] can post updated status i.e. “We are in Hotel [W]” for all members of his family. So single posting of updated status for all or selected or invited users will saves time & repetitive user action.

972 User can also save drafted updated status for posting it later and/or update one or more drafted or already posted updated status. 973 User can schedule posting or auto posting of updated status. 975 User can apply privacy settings for sharing and/or auto posting of selective user data.

In various embodiments FIG. 10 illustrates some examples. 1005 User can access interface from one or more devices including smart phones, PCs, iPad or tablets from/at home or office. Multi user system or users of temporary created or persistent group(s) can share connections and data based on roles assigned rights, applied privacy settings, security policies & rights & privileges. Connections may comprises plurality types of connections including temporary, persistent, offered, referred, suggested, permanent or user contacts, dynamic, real time updated & contextual connections for plurality types of purposes. Connections may also comprises many to many, one to many, many to one and 1 or 2 or multi way connections and connections of connections up-to particular number of depths, orchestrated connections, choreographed connections and/or connect based on rules & programming for workflow, task, process, triggering of events and like. User device can equipped with multiple types of sensors and/or attached or connected device(s) including object identification or detection or recognition sensor(s) & wearable Video device.

For example Device [1] of User [1] can connect with other users or entities based on plurality ways or via plurality types of device, systems, methods for various types of activities, actions, events, transactions, interactions, behavior, current or checked in locations or places, requests, updated status, & user data including for example 1010 User [1] connect with Device [1] of User [2] via object or person recognition device or sensors attached with smart phone. User can take photo of particular user or take finger print or focus laser beam on particular person for selecting them for establishing connections with them and/or invite them for connecting with user.

In another example 1012 Device [1] of User [1] connect with Device [1] of User [3] via matchmaking of request(s) of user with other users' requests and/or user data. For example Device [1] of User [1] posts request “buy movie [A] ticket of multiplex [B] between 5 to 9 pm”, which will connect users to ticket booking service multiplex [B] and directly present & connect “One click buy movie tickets feature” and present list of contextual movies, timing & number of seats in single page and enable to single click buy movie tickets.

In another example 1015 Device [1] of User [1] auto connected with Device [1] of User [4] and other available, pre-specified purpose specific & contextual users based on context, current location, place, purpose, user data, request, preferences, privacy settings of user and any combination thereof.

In another example 1025 Device [1] of User [1] is connected with Device [2] of User [5] based on auto identification of User [1]'s need of connections based on user's activities, preferences, rules, settings and/or auto connecting with other contextual users including Device [2] of User [5] and/or auto conduct communications, collaborations, sharing, activities, actions, operations, transactions with connected users including Device [2] of User [5].

In another example 1055 Device [1] of User [1] is connected with group(s) of connections including Device [1] of User [6] and Device [2] of User [7] based on connectable users suggested or referred by connected user'(s) of user(s) and/or or users of network(s).

In another example 1006 Device [1] of User [1] is connected with Device [2] of User [8]

via using drag & drop option and connect with users including Device [2] of User [8] from particular maps, social graph(s), multimedia, visual presentations, visual & interactive connections map for selecting connections, web page, image(s), video(s) and like.

In another example 1040 Device [1] of User [1] is connected with Device [1] of User [9] based on registering and/or Log-In and connect with user(s) including user device, subscribers or subscriptions, web sites, applications, services, objects.

In another example 1008 Device [1] of User [1] is connected with Device [1] of User [10] based on search, match, select and connect with allowable or provided or presented or permit able connections based on one or more factors including contacts, availability and schedule.

In another example 1035 Device [1] of User [1] is connected with Device [1] of User [11]

Based on connect to users who allow to connect user on 1 way communication basis e.g. only receive message from them and/or send message to them.

1035 Device [1] of User [1] can connect with number of contextual users of network(s) based on plurality of ways, functions, modules, match making algorithms, methods, systems, devices, data, networks, applications, services, web services, objects, user contacts, user activities, actions, events, transactions, events, updated status, requests and can establish connections with connections of connections up-to particular number of depths for conducting or configuring orchestrations of workflows & tasks, assignment of works & tasks and for transfer or routing or reoffering or suggesting of connections.

In another embodiment user may enabled to click on physical body of person(s) or object(s) of connectable user(s) or object(s) via device associate sensors and identify prospective connections based on clicked user's device associate sensors for conducting various types of activities, workflow, communications, collaborations, sharing based on particular or specific purpose

In another embodiment user may enabled to click on image of identified person within photo or video and is enabled to connect with them based on tag associate with photo or video.

In another embodiment user may enabled to click on user profile object or user link and enable to connect with him/them.

In another embodiment user may enabled to auto identified user via mobile device who is watching particular television serial or movie and enabling user to connect with him/her/them.

In another embodiment user may present with list of users in video or movie and enable to selectively connect with them.

In another embodiment user may enabled to connect with other contextual users including connect with connected users of user when user is preparing or eating particular food.

In another embodiment user may enabled to use default applications while establishment of connections.

In another embodiment user may enabled to post voice or video enabled request(s). In another embodiment system can identify or determine connections based on recording of user's voice or user's and/or other users' or objects' video via human wearable video device in black box manner and converting said recorded voice into text and/or video into identified images. After that system can associate data with said generated contents and auto or manually format & process and mining or analyzing text and/or image data for removing unwanted texts data and store said text and/or image data or content as user data and/or based on said stored contents system can identifying prospective or candidate or required request(s) and auto posting one or more extracted, formatted, identified or updated request(s) for matching and presenting contextual connections to user for enabling user to establish 1 or 2 way communications, collaborations and sharing with connected users and enable connected users to participate with various types of activities, actions, events, & transactions.

In another embodiment provide identity (ID) and accessible or link of connectable user object to each user for enabling others to connect user(s) based on one or more purposes or aspects or factors or criteria or contextually and provide visual map or integrate with existing map connectable users or link(s) of connectable user object(s) including one or more types of entities like shop, administrator of company, professional, assistant at airport, seller, company, organization, product, service, brand and like, who define or set types of purpose(s) so that other users can connect them based on types of purpose or task or activity or workflow and present updated connectable users as per real-time updates in user activities, user current location or place, user data, or provided or updated request(s).

In another embodiment user(s) is/are enabled to connect with connected or related or associated or group(s) of users including classmates or all or selective employees of office and user surround or associate environment effected contextual users based on user's request(s) and/or auto posting of request(s) based on user activities and user data.

In another embodiment enabling user to connect with contextual, updated, real time dynamic connections related or contextual to user's updated status for providing or storing including storing at user's local storage medium or device or server) based on snapshot, transactional, merge, pull and/or push synchronizations and/or 1 and/or 2 way information sharing including provide or update complaints, feedbacks, suggestions, likes, dislikes, knowledge, ask queries. For example when User [Y] are walking or seating or standing in mall, user is connected with all shops and user can ask information about product(s) and/or service(s), negotiate or buy product(s) and/or service(s) and connected enable shops and/or corresponding administrator or sales person or staff of shop(s) to present product(s) and/or service(s).

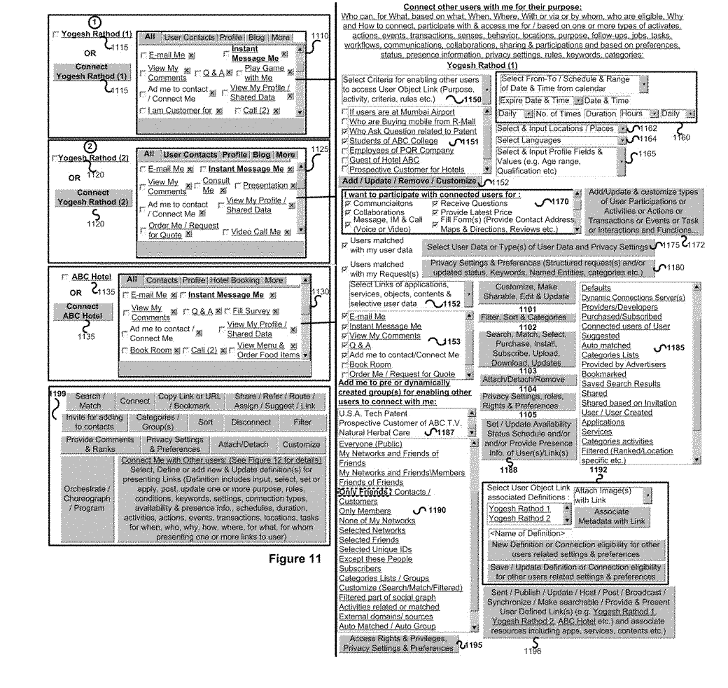

FIG. 11 illustrates interface for enabling user(s) to configure, set or update privacy settings & preferences for enabling other users to connecting with user(s) including who can, for what, based on what, when, where, with or via or by whom, who are eligible, why and how to connect, participate with & access user or user object(s) for/based on one or more types of activities, actions, events, transactions, senses, behavior, locations, purpose, follow-ups, jobs, tasks, workflows, communications, collaborations, sharing & participations and based on preferences, status, presence information, privacy settings, rules, keywords, categories.

User is enable to 1103 search, match, select, register, purchase, install, subscribe, upload, download, share, updates, upgrades, 1102 filter, sort, categories, 1101 customize, make sharable, edit & update, 1105 apply, set, select, input, update privacy settings, roles, rights, privileges, security policies & preferences and 1104 attach, detach, block, uninstall, un-register, remove one or more applications, services, objects, contents from one or more sources including 1185 servers, web sites, platform(s), networks, devices, databases, & 3^{rd} parties providers, list of suggested, categorized, filtered, location specific, shared, ranked & auto matched, provided or share or refer by connected users of user, and present to user 1153 links of said applications, services, objects, contents. User is enable to 1152 select, 1101 customize, make sharable, edit, update, 1102 filter, sort, & categories, 1105 apply, set, select, input, update privacy settings, roles, rights, privileges, security policies & preferences and 1104 attach, detach, block, un-register, package, integrate, add, remove one or more uniform resource locator (URLs) or links of applications, services, objects, contents and selective user data and can attach or detach with/in/to/at dynamic, portable, customizable, presentable & accessible 1150, 1120 & 1135 user object(s) or user profile object(s) or user object link(s) or user specific dynamic, portable, customizable & accessible interface(s).

User can apply one or more types of privacy settings and preferences for who can access and connect with user and/or who can access dynamic, portable, customizable, presentable & accessible 1150, 1120 & 1135 user object(s) or user profile object(s) or user object link(s) or user specific dynamic, portable, customizable & accessible interface(s).

Dynamic, portable, customizable, presentable & accessible 1150, 1120 & 1135 user object(s) or user profile object(s) or user object link(s) or user specific dynamic, portable, customizable & accessible interface(s) enables connected users with user to use, access, re-share, refer, order, sort, attach, detach, customize user specific interface, invoke link associated one or more applications, services, objects, contents for sharing & accessing contents and for conducting or participating with one or more activities, actions, events, transactions, communications & collaborations.

In another embodiment user can 1150 & 1151 select, set, apply, update & input eligibility criteria for enabling other users to connect user and/or access 1115, 1120 & 1135 user object link(s), wherein criteria, rules & conditions may comprises one or more types of purposes, activities, actions, events, transactions, participations, communications, collaborations, sharing, workflow. User can also 1160 set, apply, select, input, & update schedule date & time or range(s) of date & time, expire date and/or time or duration, number of times, number of times within pre-set duration 1160 to allow eligible users to access or view selected or shared user object(s) or user profile object(s) or user object link(s) 1115 or user specific dynamic, portable, customizable & accessible interface(s) and associated presented or updated or shared one or more applications, services, objects and one or more types of content item(s) 1110, when & how many times other users can connect with users including schedule of availability or connection availability, specific or ranges of date & time and particular number of times other users can connect with user within particular duration. User can also set, apply, select, input, & update particular 1162 locations or places, 1164 languages and 1165 profile or customized fields and/or associate values or value ranges including name, identity, age, age range, qualifications, gender & interest types for enabling other users to connect user and/or access 1115, 1120 & 1135 user object link(s). User can also 1170 select what connected user can do with user including communications, collaboration for particular purpose, send messages, receive questions from user, fill one or more types of forms including share of selective user data. User can also 1172 add, update & customize 1170 types of user participations, activities, actions, transactions, events, task, interactions and functions. User can also select, check, uncheck, update & set 1175 privacy settings & preferences for determination of connecting other users with user based on matching user data of other users of network(s) with user data of user or not. User can also select, check, uncheck, update & set 1180 privacy settings & preferences for determination of connecting other users with user based on matching request(s) of other users of network(s) with request(s) of user or not. User can add him/her to 1187 pre or dynamically created group(s) for enabling other users to connecting with users. User can also 1190 select, group(s) selections, apply, set, input & update privacy settings for one or more or group(s) or categories or types of selected users for connecting them with user and/or allow them to access user's user object & associated resources including all users of network(s) or everyone or public, one or more user's networks and friends of friends, user's networks and friends & members, friends of friends, only friends, only contacts, only customers, only members, none of user's network(s), selected networks, selected friends, selected unique IDs, except these people, all or selected subscribers, select from categories lists or groups, select based on customized or particular types of set of users (e.g. select users based on searching, matching & filtering users), filtered part of social graph, select users based on one or more selected types of related or matched activities, select from or input name of external domains or sources and select users based on auto match making preferences, select users from auto or dynamically created group(s) and user can also 1195 set, apply, input, select & update access rights & privileges, privacy settings & preferences for multi users and/or enabling other users to connect with users and/or access user object link(s) and/or selective or all user data and/or user interface(s) and/or one or more features of user interface(s). User and/or system can also 1188 set, auto set or provide, provide, input, apply, select & update availability status schedule and/or presence information of user(s) and/or 1115 and/or 1120 user object link(s) for enabling other users to connect with user. User can 1192 provide name to above discussed new configurations or set of settings & preferences and can search, match, filter, sort & select pre-created or already exists user object link associated definitions for updating set of settings & preferences for enabling other users to connect with user(s) and/or access user's user(s) object(s) link(s). User can also configure user object link including provide, name associate profile link and/or image and metadata. User can 1196 send, publish, update, upgrade, host, post, store, advertise, broadcast, synchronize, make searchable, provide & present user defined link(s) for enabling other eligible or connected and/or authorized user to connect with user(s) or group(s) of user(s) and/or access one or more user object links, for example User Object Link(s) 1115 “Yogesh Rathod 1”, “Yogesh Rathod 2” & “ABC Hotel” may comprises associated link(s) of applications, services, multimedia types of contents, resources and privacy settings, preferences & configuration settings as describe above, wherein said links enable connected or authorized user to access associated links based on associated privacy settings & preferences. Use can apply above discussed privacy settings, preferences & configuration settings at any manner and in any combination thereof.

For example user select or input that 1151 If users are at Mumbai Airport at particular range of date & time then connect user with other contextual, purpose specific users including providing assistant to connected users at airport, book tickets and like. In another example user selects that connect user with users who are buying mobile from R-Mall and/or connect user with users who ask question related to patents and/or connect user with users who are students of ABC College and/or connect user with users who are employees of PQR Company for marketing related only at particular range of duration and/or connect user with users who are guest of Hotel ABC and/or connect user with users who are prospective customer for Hotels at Mumbai.

User can click 1115 Link of User Profile Object or User Object and can 1110 view, access, customize, remove links, drag & drop link(s) from 1153 list and update configured, customizable, purpose specific, portable, packaged & dynamic 1110 User Profile Object Link or User Object Link associated or referred or provided or presented links of applications, services, objects, selective user data, one or more types of multimedia contents, database and resources.

User can click 1135 Link(s) of User Profile Object or User Object of other users who allow user to connect user with them and/or 1199 select, search, match, connect, bookmark, share, refer, route, assign, suggest, link, categories, grouping(s), customize, orchestrate, choreograph, attach or detach links, & access their one or more User Profile Object or User Object and can 1110 and invite them to add them to user's contacts.

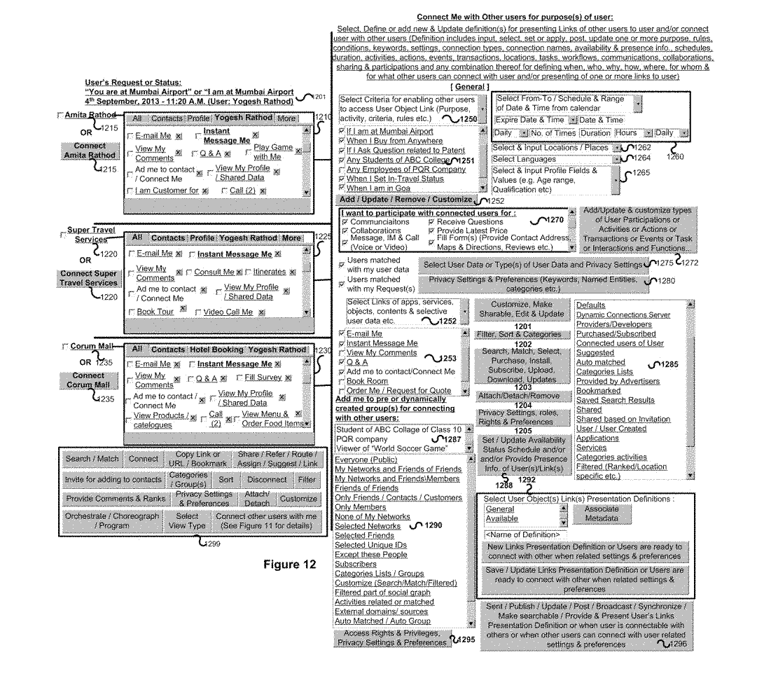

FIG. 12 illustrates interface for enabling user(s) to connect user with other users and/or allow to presenting of User Object Links of other users to user for/based on one or more purpose, posted request(s), activities, actions, events, transactions, locations & user data including select, define or add new & update 1292 definition(s) for allowing other users to presenting 1215, 1220 & 1235 links of other users to user and/or connect user with other users, wherein 1292 definition(s) includes input, select, set or apply, post, update one or more purpose, rules, conditions, keywords, settings, connection types, connection names, availability & presence information, schedules, duration, activities, actions, events, transactions, locations, tasks, workflows, communications, collaborations, sharing & participations and any combination thereof for defining when, who, why, how, where, for whom & for what other users can connect with user and/or allowing to presenting of one or more User Object Links of other users to user.

1201 shows that user is presented with other users' 1215, 1220, 1235 User Object links based on 1201 user's request(s) and/or updated status and/or user's activities, actions, events, transactions, current or checked-in locations or places.

User is also enable to 1203 search, match, select, register, purchase, install, subscribe, upload, download, share, updates, upgrades, 1202 filter, sort, categories, 1201 customize, make sharable, edit & update, 1205 apply, set, select, input, update privacy settings, roles, rights, privileges, security policies & preferences and 1204 attach, detach, block, uninstall, un-register, remove one or more applications, services, objects, contents from one or more sources including 1285 servers, web sites, platform(s), networks, devices, databases, & 3^{rd} parties providers, list of suggested, categorized, filtered, location specific, shared, ranked & auto matched, provided or share or refer by connected users of user, and present to user 1253 links of said applications, services, objects, contents. User is enable to 1252 select, 1201 customize, make sharable, edit, update, 1202 filter, sort, & categories, 1205 apply, set, select, input, update privacy settings, roles, rights, privileges, security policies & preferences and 1204 attach, detach, block, un-register, package, integrate, add, remove one or more uniform resource locator (URLs) or links of applications, services, objects, contents and selective user data and can attach or detach with/in/to/at dynamic, portable, customizable, presentable & accessible 1215, 1220 & 1235 user object(s) or user profile object(s) or user object link(s) or user specific dynamic, portable, customizable & accessible interface(s) of other users.

User can apply one or more types of privacy settings and preferences for who can connect with user and/or who can present dynamic, portable, customizable, presentable & accessible 1215, 1220 & 1235 user object(s) or user profile object(s) or user object link(s) or user specific dynamic, portable, customizable & accessible interface(s) via dynamic connections server(s) and/or one or more sources.

Dynamic, portable, customizable, presentable & accessible 1215, 1220 & 1235 user object(s) or user profile object(s) or user object link(s) or user specific dynamic, portable, customizable & accessible interface(s) enables user to use, access, re-share, refer, order, sort, attach, detach, customize interface, invoke connected user's user object specific link(s) associated or referred one or more applications, services, objects, contents for sharing & accessing contents and for conducting or participating with one or more activities, actions, events, transactions, communications & collaborations.

In another embodiment user can 1250 & 1251 select, set, apply, update & input eligibility criteria for enabling user to connect with other users and/or allow to present 1215, 1220 & 1235 user object link(s) via dynamic connections server(s) and/or any other communication medium or interface or source(s), wherein criteria, rules & conditions may comprises one or more types of purposes, activities, actions, events, transactions, participations, communications, collaborations, sharing, workflow. User can also 1260 set, apply, select, input, & update schedule date & time or range(s) of date & time, expire date and/or time or duration, number of times, number of times within pre-set duration to allow to present user object(s) or user profile object(s) or user object link(s) 1215 or user specific dynamic, portable, customizable & accessible interface(s) and associated one or more applications, services, objects and one or more types of content item(s) 1210 of other users, when & how many times user is connectable with other users including schedule of availability or connection availability, specific or ranges of date & time and particular number of times user want to connect with other users within particular duration. User can also set, apply, select, input, & update particular 1262 locations or places, 1264 languages and 1265 profile or customized fields and/or associate values or value ranges including name, identity, age, age range, qualifications, gender & interest types of other users who can and are enable to connect with user and/or allow to present 1215, 1220 & 1235 user object link(s). User can also 1270 select what functions or activities connected user can do with user including communications, collaboration for particular purpose, send messages, receive questions from user, fill one or more types of forms including share of selective user data. User can also 1272 add, update & customize 1270 types of user participations, activities, actions, transactions, events, task, interactions and functions. User can also select, check, uncheck, update & set 1275 privacy settings & preferences for determination of connecting users with other user based on matching user data of other users of network(s) with user data of user or not. User can also select, check, uncheck, update & set 1280 privacy settings & preferences for determination of connecting users with other user based on matching request(s) of users with request(s) of other users of network(s) or not. User can add him/her to 1287 pre or dynamically created group(s) for enabling users to connecting with other users. User can also 1290 select, group(s) selections, apply, set, input & update privacy settings for one or more or group(s) or categories or types of selected users for connecting user with them and/or allow them to present user object(s) link(s) or user object(s) & associated resources including all users of network(s) or everyone or public, one or more user's networks and friends of friends, user's networks and friends & members, friends of friends, only friends, only contacts, only customers, only members, none of user's network(s), selected networks, selected friends, selected unique IDs, except these people, all or selected subscribers, select from categories lists or groups, select based on customized or particular types of set of users (e.g. select users based on searching, matching & filtering users), filtered part of social graph, select users based on one or more selected types of related or matched activities, select from or input name of external domains or sources and select users based on auto match making preferences, select users from auto or dynamically created group(s) can connect with user and user can also 1295 set, apply, input, select & update access rights & privileges, privacy settings & preferences for multi users and/or enabling users to connect with other users and/or access presented user object link(s) and/or selective or all user data and/or user interface(s) and/or one or more features of user interface(s) of other users. User and/or system can also 1288 set, auto set or provide, provide, input, apply, select & update availability status schedule and/or presence information of user(s) and/or 1215 and/or 1220 user object link(s) for enabling user to connect with other users. User can 1292 provide name to above discussed new configurations or set of settings & preferences i.e. User Object(s) Link(s) Presentation Definitions name(s) and can search, match, filter, sort & select pre-created or already exists User Object Links Presentation Definitions name(s) for updating set of settings & preferences for enabling user to connect with other user(s) and/or present or allow to present other users' user(s) object(s) link(s). User can also configure user object(s) link(s) including provide name and associate metadata. User can 1296 send, publish, update, upgrade, post, store, advertise, broadcast, synchronize, make searchable, provide & present User Object(s) Link(s) Presentation Definitions name(s) for enabling other eligible or connected and/or authorized user to connect with user(s) or group(s) of user(s) and/or present one or more user object links of other users.

For example User Object(s) Link(s) Presentation Definitions name(s) 1215 “General” associate privacy settings and/or preferences enable other users to connect with user. For example when user sets that 1251 “If I am at Mumbai Airport” than allow other users to connect me, then system presents said updated status or request specific connectable or contextual users or User Object(s) Link(s) to user including “Amita Rathod”, “Super Travel Services” & “Comm Mall” User Object Links, wherein User Object Links may comprises associated link(s) of applications, services, multimedia types of contents, resources and privacy settings, preferences & configuration settings of corresponding users, wherein said links enable user to access associated links based on associated privacy settings & preferences. Use can apply above discussed connection for other users related privacy settings, preferences & configuration settings at any manner and in any combination thereof.

For example user select or input that 1251 If I am at Mumbai Airport at particular range of date & time then connect me with other contextual, purpose specific users including receiving assistant from connected users at airport, book tickets and like. In another example user selects that connect me with users when I buy from anywhere and/or connect me with users if I ask question related to patents and/or connect me with users who are students of ABC College and/or connect me with users who are employees of PQR Company for marketing related only at particular range of duration and/or connect me with users when I set “In-Travel” status and/or connect me with users when I am in Goa.

Based on User Object associate privacy settings, rights & privileges & permissions, user can click 1215 Link of User Profile Object or User Object and can 1210 view, access, customize, remove links, drag & drop link(s) from 1253 list and update configured, customizable, purpose specific, portable, packaged & dynamic 1210 User Profile Object Link or User Object Link associated or referred or provided or presented links of applications, services, objects, selective user data, one or more types of multimedia contents, database and resources.

User can click 1215, 1220 & 1235 Link(s) of User Profile Object or User Object of other users who allow user to connect user with them and/or 1299 select, search, match, connect, disconnect, bookmark, share, refer, route, assign, suggest, link, categories, grouping(s), customize, provide comments & ranks, select view type(s), orchestrate, choreograph, attach or detach links, & access their one or more User Profile Object or User Object and can 1210 and invite them to add them to user's contacts,

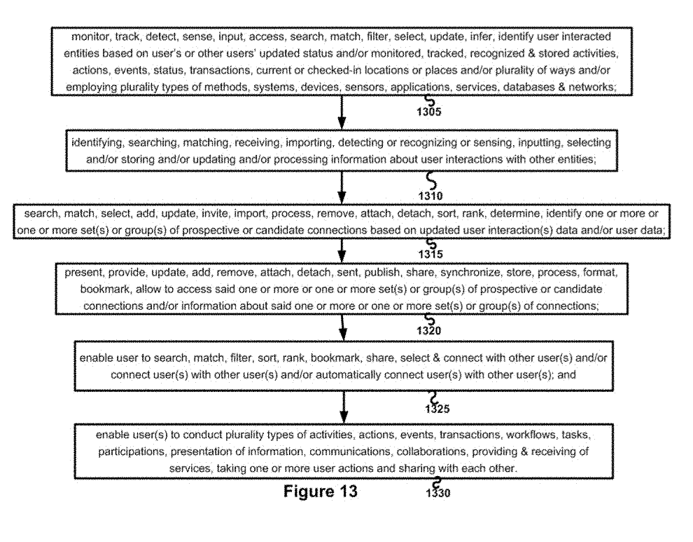

FIG. 13 illustrates flowchart of the one embodiment of the present invention. 1305 shows monitoring, tracking, detecting, sensing, recognizing, inputting, accessing, searching, matching, filtering, selecting, updating, inferring, identifying user interacted entities i.e. users or entities who interact with user and user interact with other users or entities or entities to whom user interact with them or user interacted entities based on updated status of user & other related users and/or monitoring, tracking & storing one or more user's activities, actions, events, transactions, current or checked-in locations & places, requests, plurality types of data including user data; 1310 shows identifying, searching, matching, receiving, importing, detecting or recognizing or sensing, inputting, selecting and/or storing and/or updating and/or processing information about user's interactions with other entities and/or other user's or entities interactions with user; 1315 shows searching, matching, selecting, adding, updating, inviting, importing, processing, removing, attaching, detaching, sorting, ranking, determining, identifying one or more or one or more or set(s) or group(s) of connections based on updated user interaction(s) data and/or user data; 1320 shows presenting, providing, updating, adding, removing, attaching, detaching, sending, publishing, sharing, synchronizing, storing, processing, formatting, bookmarking, allowing to access said one or more or one or more set(s) or group(s) of connections and/or information about said one or more or one or more set(s) or group(s) of connections; 1325 shows enabling user to searching, matching, filtering, sorting, ranking, bookmarking, sharing, selecting & connecting with other user(s) and/or connecting user(s) with other user(s) and/or automatically connecting user(s) with other user(s); and 1330 enabling user(s) to conduct plurality types of activities, actions, events, transactions, workflows, tasks, participations, presentation of information, communications, collaborations, providing & receiving of services, taking one or more user actions and sharing with each other based on one or more applications, services, objects, interfaces, web sites, web pages, databases, lists, user profile objects or user object(s), multimedia types of contents, resources & contents provided, presented, shared, referred, searched, matched, filtered, selected, purchased, subscribed, installed, downloaded, edited, uploaded, updated by user and/or connected users of user or related users of network(s).

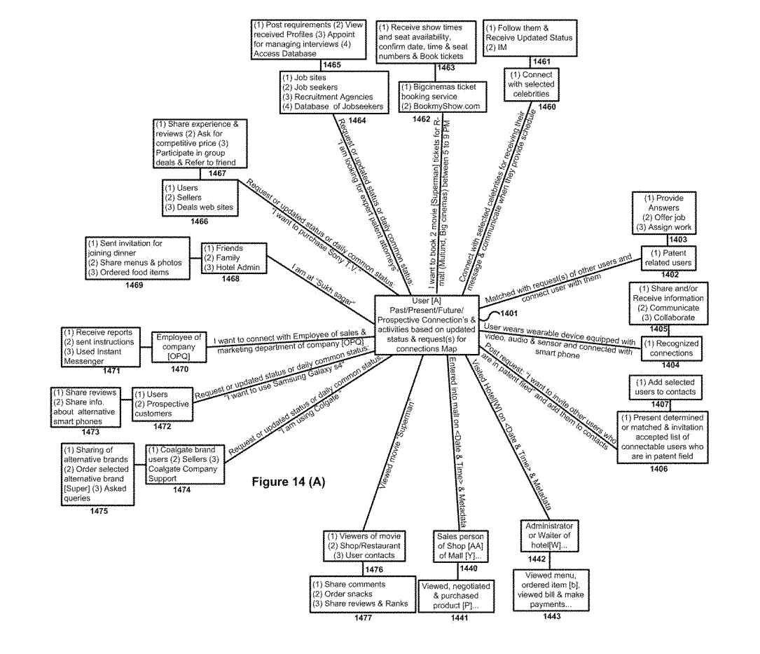

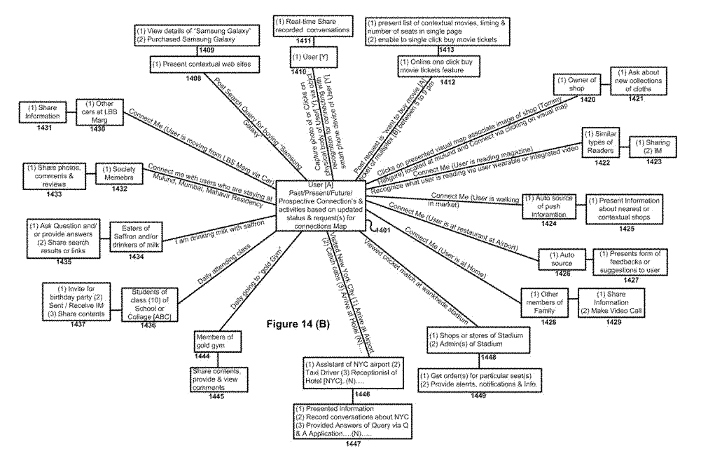

FIG. 14 illustrates various examples of the present invention. User can connect with other users in plurality of ways, applying of methods, systems, devices, sensors, based on structured updated status and/or structured request, from/to/via one or more networks, applications, services, interfaces & web sites or web pages for plurality types of purposes, activities, actions, events & transactions. 151, 152, 125 & 135 User(s) and/or 115 server(s) can provide updated status, requests & user data for physically identify contextual connections and/or logically identify contextual connections and enable user(s) or entity to connect with other users or entities and/or enable other users or entities to connect with user(s) or entity.

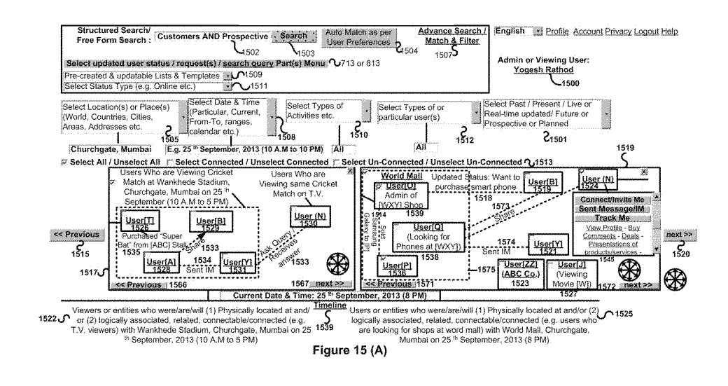

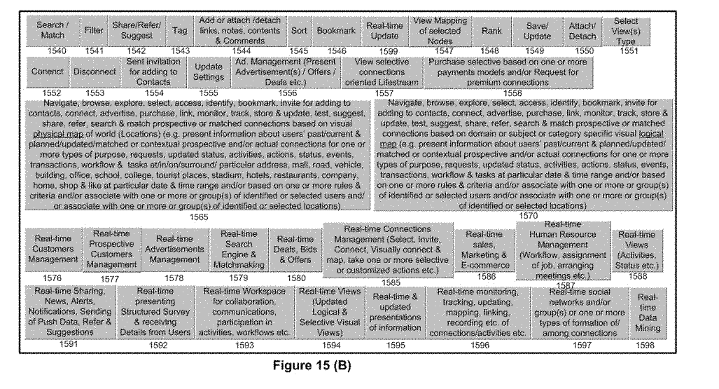

FIG. 15 illustrates one or more types of representation or presentation of physical and/or logical word, including visual, text, video, audio, graphic, image, objects, links, map, tree, multimedia and any combination thereof, based on user navigation, browsing, exploring, mining, mouse movements in various directions, selections, commands, requests, preferences, rules, criteria, queries, locations, date & time ranges, types of activities and/or types of connected and/or prospective or candidate or suggested connections and/or connectable users, subscriptions, permission & privacy settings.

In another embodiment FIG. 15 illustrates presenting of selective or preferred visualize selective maps including location(s) specific and/or date & time range(s) specific and/or particular types of activities, purpose, actions, events, transactions, status specific of past and/or present and/or possibly in future what users are/were/will doing/did/do, who is connected with whom, for what, what interactions, activities, actions, events, transactions take place and like.

In another embodiment FIG. 15 illustrates monitoring, tracking, updating, recording, storing, linking, mapping, visualizing & selectively presenting of information about connections & interactions among/between connected users based on similar location(s) & time line and doing of similar types of activities or related with particular activity of particular user at particular date & time and/or location(s) or place(s)

In another embodiment FIG. 15 illustrates storing & real-time updating of possible or suggested or prospective or candidate or actual or connectable connections and/or information about connections between/among connectable nodes or users entities of network(s) who may connected in network(s) environment including past, current & updated connections, wherein connections determined based on updated status or structured updated status and/or requests posted by users and/or user(s) data and/or user profile & contacts and/or storing & updating information about interactions between/among connected nodes including who connects with who on what basis, for what, where, when and what they share & communicate, how they connect, why they connect, what activities, actions, events, transactions they conduct and like.

User can select various preferences for 1539 (1517 & 1519) presentation of preferences specific users' actual and/or current and/or prospective connections and associate activities, actions, events, transactions, status including sharing of contents, communications, collaborations, buying of products & services, conversations, recorded video and like, wherein various preferences may including 1505 locations or places, 1508 date & time ranges, 1510 types of activities specific and/or 1512 types of users specific, 1509 Pre-created & updatable Lists & Templates, 1511 type of status of users including online available, 1502 structured and/or free form one or more 1503 executed queries, wherein search queries is/are based on 713 & 813 “select updated user status/request(s)/search query part(s) menu” describe in details in FIGS. 7 & 8, inputting, applying, updating, setting & selections of 1504 auto matchmaking preferences & 1507 advance search criteria, rules, ranges & conditions and any combination thereof.

In another embodiment user can move in various directions, navigate including 1515 previous, 1520 next, up, down, move to various angles & directions, explorer from/to one or more locations and/or associate places including road, building, shop, in mall, school, collage, at restaurant and like and/or date & time ranges in/within 1539 (1517 & 1519) presented timeline.

For example user inputs, selects, updates, applies, configured, customized & set preferences including present 1512 all types of connections or entities or users who are 1502 “Customers AND Prospective Customers” and 1501 were/are/will associated/associate, related/relate and interacted/interact with/in/on/via/from/to/over/within/at 1505 Churchgate, Mumbai between 1508 25 Sep. 2013 10:00 A.M. to 10:00 P.M. and also present associate all types of activities, events, transactions, e-commerce, deals, negotiations, communications, collaborations, sharing & participation conducted between connected users. Based on said preferences system presents matched connections and/or interacted or connected users or entities with their various transactions, communications, sharing & activities. For example based on said preferences system presents users who are viewing cricket match at 1522 Wankhede Stadium, Churchgate, Mumbai on 25^{th} September (10 A.M to 5 PM) including 1526 User [T], 1529 User [B], 1530 User [N], 1531 User [Y] & 1528 User [A] and depicts their connections including for example 1528 Users [A] is connected with 1529 Users [B] & 1531 Users [Y], 1531 Users [Y] is connected with 1530 Users [N] and associated activities, actions, events, transactions, communications, messaging, collaborations & sharing including 1528 Users [A] shares contents with 1529 Users [B], 1531 Users [Y] 1528 and Users [A] send/receive instant messages and 1531 Users [Y] asks query and received answers from 1530 Users [N] and For example based on said preferences system also presents connectable users or entities, connected users or entities and/or connections took place or take place in 1525 World Mall, Churchgate, Mumbai on 25 Sep. 2013 (8 PM) including 1536 User [P], 1519 User [B], 1539 User [0], 1524 User [N], 1521 User [Y], 1523 User(s) or group(s) of user(s) [ZZ], 1527 User [J] & 1538 User [Q] and depicts their one or more types of connections or list(s) or categories or group(s) of connections including matched, related, push, pull, forced, updated, real time updated, connectable, dis-connectable, connected, one or two or multi way connectable, sharable, dynamically connectable, accessible, re-connectable, connectable based on privacy settings, preferences, security policies, roles, rights & privileges, connectable based on subscriptions and/or one or more types payment models, schemes & types including free, paid, sponsored, prepaid, postpaid or billed, bids based on numbers of, priorities of, duration of access of, selected one or more type(s) of actions, activities, events, transactions, communications, collaborations, participations & sharing required with, customize need of, inputting, selecting, targeting & updating criteria, keywords, categories, rules & preferences of selections of & rank(s) or quality of connections and/or connectable and/or connected users or entities, invitational able for adding them to contacts, attachable, detachable, ranked, past or historical, advertised or sponsored or offered (e.g. advertisers, marketing agent or company or brand who want to sell products and/or services, airport staff who want to assist travelers or commuters at airport, self-volunteers or experts who want to provide answers for particular field specific queries), compulsory or legal or forced or pushable (e.g. government department, agencies for sending notifications, receiving complaints & feedbacks), indirect, routed, assigned, invocable, blockable, physically connectable and/or connected, logically connectable and/or connected, portable, dynamically presentable, bookmarkable, orchestratable, choreographable, communicateable, user selected or preferred, automatic, suggested, prospective, candidate set of, categories, lists of, human & expert mediated, determined based on various factors, rules & criteria specific, temporary, need specific, updated status specific, structured updated status specific, request specific, user data including user profile associate one or more fields & associate value(s) specific, current location or place specific, date & time specific or date & time range(s) specific, already connected users of user or people in user's contacts list(s) or permanent or durable connections like friends, family, relatives & like or connected users of connected users of user(s) and any combination thereof. For example 1536 User [P] is connected with 1539 User [0] of [WXY shop] via structured updated status provided by 1539 User [0] of [WXY shop] indicating or describing of 1514 “selling of Samsung Galaxy s4” by 1539 User [0] of [WXY shop] to 1536 User [P] and/or structured updated status provided by 1536 User [P] indicating or describing of “purchasing of Samsung Galaxy s4” from 1539 User [0] of [WXY shop], another 1538 User [Q] set status that “Looking for Phones at [WXY]” is also connectable with 1539 User [0] of [WXY shop] but yet not connected with 1539 User [0] of [WXY shop] also presented in 1519 interface. 1519 interface also presents logically connected or connectable or related or associated or linked with World Mall, Churchgate, Mumbai on 25 Sep., 2013 (8 PM). For example 1519 User [B] is physically available in Churchgate, Mumbai on 25 Sep. 2013 (8 PM) and also set updated status that 1518 “Want to purchase Smartphone”, so system logically presenting connection between connectable 1519 User [B] and connectable 1539 User [0] of [WXY shop] so they can establish connection(s) and take or participate with one or more actions, activities, events & transactions including present updated status, send/receive messages, communicate, collaborate, participate in group deals, invite for adding them to user's contacts or permanent or durable connection list(s). System also intelligently present logical connections between 1538 User [Q] who are looking for Smartphone at 1539 [WXY] and 1519 User [B] who are not present in world mall but want to purchase smart phone and are near in world mall. For example system presents 1519 User [B] to 1538 User [Q] at 1538 User [Q]'s interface and/or presents 1538 User [Q] to 1519 User [B] at 1519 User [B]'s interface and logically present or establish prospective or suggested or candidate connections between connectable 1519 User [B] and connectable 1538 User [Q] for enabling them to establish connections with each other and communicate & collaborate with each other. For example 1519 User [B] shares contents with 1538 User [Q]. System also presents connected users of user who are connected with user at the date & time when user are engaged in particular activity at particular location or place. For example when 1538 User [Q] are looking for phones at 1539 [WXY] and asking 1521 User [Y] that whether 1538 User [Q] buy particular phone from 1539 [WXY] or not, system depict 1574 connections between 1521 User [Y] and 1538 User [Q]. System also presents and depicts users or entities who are physically located in (e.g. 1523 User [ZZ] of [ABC co.] and 1527 User [J] who are watching movie [W] at world mall) world mall and/or logically connected with or thinking about, logically related with world mall including indirectly connectable 1524 User [N] who are viewing world mall related video. System infers logical connections between connectable 1524 User [N] and connectable 1575 world mall and enables them to invite each other to adding them to contacts, bookmark connections and establish connections or connect with each other for one or more types of purposes, requirements, updated status, requests, criteria, current or checked-in location and/or place, activities, actions, events & transactions.

There are numerous possibilities, methods, systems, devices, databases, servers, networks, permutations & combinations of detecting user needs or requirements of connections with connectable contextual users, determining, updating, presenting, dynamically presenting, making or establishing of connections and enablement of conduction of plurality types of activities, actions, events, communications, collaborations, sharing & transactions among connected users or entities based on structured or defined or domain, subject, a activity, action, purpose, requirement, event, transaction, location, selective profile data or user data (e.g. age range or gender etc.) or field specific pre-created or customizable or customized or dynamically customizable form(s) or ontology or semantic syntax or taxonomy or relational data structure(s) and/or unstructured or free form updated status, user data & requests and managing of lifecycle of connections including connectable, registered, connected, connected & communicated via particular applications, services, objects, interfaces like instant messenger, video call, disconnected, connected & online or offline or away or busy and like, presented, updated, added to contacts bookmarked, historical, tested, blocked, removed or terminated, unregistered, attached, detached, logical representation or presentation or linking between contextual or matched connectable nodes or users or entities of network(s) who are connected or not-connected with network environment.

In another embodiment said 1539 (1517 & 1519) presentation is/are based on privacy settings, payments, availability, status, subscriptions, authentications, authorizations, roles, rights & privileges, security policies and permissions of presented users or entities or connections and/or associate user data.

In another embodiment user(s) or viewer can visualize world or part of world including view related part(s) of world specific connected, connectable & prospective to connect users or entities who did/doing/will do one or more activities, actions, events, transactions, collaborations, communications & sharing with each other at particular date & time and/or location(s) or place(s) based on posted or automatically generated structured updated status and/or unstructured updated status and/or user data and/or user request(s) for dynamically establishing connections with contextual and/or connectable users or entities and enable connected users to search, match, select, subscribe, purchase, attach, detach, present, share, post & access accessible link(s) of applications, services, objects, multimedia types of contents presented or suggested by one or more connected users and/or dynamic connection server(s) based on purpose, requirement, request, privacy settings, mutual wish of connected users, invitations, suggestions, matchmaking of user's data & preferences, type(s) of activities, actions, events, transactions, status, current or checked-in location or place(s). For example viewer of selective visualize 1539 timeline including 1517 & 1519 can select one or more 1524 user(s) and/or directly access 1524 user object or 1524 link of user object or user provided accessible 1545 buttons (e.g. “Connect Me” button for connecting with 1524 User [N] by viewer & “Send Messages/IM” button for sending/receiving messages or instant messages and “View Profile” link for viewing selective or provide details of user profile) or links of applications, services, objects, profile object, multimedia data including text, video, audio, image, photo, URLs or links, files & documents, controls including buttons, links, check boxes, selections, combo box, radio buttons & forms, functions, user actions including Like Me, Rate or Rank Me & Comment on Me. In another embodiment viewing user can also select one or more 1517 and/or 1519 parts and/or associate one or more users or entities or nodes or connectable nodes of networks connected in network environment or connected users or prospective users and/or connections and/or connections associate accessible link(s) from presented or filtered or updated or real time refreshed or updated 1539 (1517 & 1519) timeline and can take one or more or group(s) of action(s) including user can 1540 search & match, 1541 filter, 1542 share, refer & suggest, 1543 select, input, set or apply or update tag(s), 1544 add notes & comments, 1545 sort, 1546 bookmark, 1599 real-time update, 1547 view mapping, 1548 Rank, 1549 Save & Update, 1550 attach/detach, 1551 select view type(s) including visual, multi-dimensional, multimedia type, tree, text and/or graphics & any combination thereof, 1552 connect, 1553 disconnect, 1554 send invitations for adding to contacts, 1555 apply update settings including refresh within particular times or durations, 1556 present advertisements or offers or deals, 1557 view selective connections oriented Lifestream including all or selective types of selective user data, user profile, user social graph, user connections & user activities stream, 1558 purchase selective based on one or more payment models and/or request for premium connections with selected/ranked or filtered or required set of users, 1559 within/in/at/to/with/on/of presented views of 1539 (1517 & 1519) timeline based on one or more search queries, rules, criteria, conditions, keywords, categories, selections, ranges, advance search queries, search wizards.

In another embodiment viewing user in plurality of ways can 1565 view, navigate, browse, explore, select, access, identify, bookmark, invite for adding to contacts, connect, advertise, purchase, link, monitor, track, store & update, test, suggest, share, refer, search & match prospective or matched connections based on visual physical map of world (selective or preferred locations, countries, cities, areas, addresses) including present information about users' past/current & planned/updated/matched or contextual prospective and/or actual connections took place and/or established and/or able to establish for one or more types of purpose, requests, updated status, activities, actions, status, events, transactions, workflow & tasks at/in/on/surround/particular address, mall, road, vehicle, building, office, school, college, tourist places, stadium, hotels, restaurants, company, home, shop & like at particular date & time range and/or based on one or more rules & criteria and/or associate with one or more or group(s) of identified or selected users and/or associate with one or more or group(s) of identified or selected location.

In another embodiment viewing user in plurality of ways can 1570 view, navigate, browse, explore, select, access, identify, bookmark, invite for adding to contacts, connect, advertise, purchase, link, monitor, track, store & update, test, suggest, share, refer, search & match prospective or matched connections based on domain or subject or category specific visual logical map (e.g. present information about users' past/current & planned/updated/matched or contextual prospective and/or actual connections for one or more types of purpose, requests, updated status, activities, actions, status, events, transactions, workflow & tasks at particular date & time range and/or based on one or more rules & criteria and/or associate with one or more or group(s) of identified or selected users and/or associate with one or more or group(s) of identified or selected locations)

In another embodiment viewing user in plurality of ways can view, navigate, browse, explore, select, access, identify, bookmark, invite for adding to contacts, connect, advertise, purchase, link, monitor, track, store & update, test, suggest, share, refer, search & match prospective or matched connections from/of/to/at/on/in/within one or more selective or preferred parts of physical world and/or logical world or particular scenario of physical world combined with logical world related connections including presented, dynamically presented, matched, contextual, updated connections, related or matched or actual connectable and/or connected users or entities, associate or related links of applications, services, objects, contents, interfaces, for conducting one or more activities, actions, events, transactions, communications, collaborations, participations & sharing, provided by users and/or connected users and/or suggested by 115 dynamic connection server(s), associate or related activities, actions, events, transactions, locations, places, entities, communications, collaborations, participations & sharing and associate or related user data.

In another embodiment present invention enables 1576 real time customer management and customer relationship management.

Viewing user(s) or administrator(s) of visual or presented customer management and customer relationship management of 1539 timeline is/are enabled to view past, present & prospective future customers and/or dynamically attach or update connections at interface 1517 or 1519 and can monitor, track, manage loyal customers or current customers and/or prospective customers and can connect with customers physically present at their premises or building or restaurant or hotel or office based on posted structured updated status of customers and/or user data and/or current location or checked-in location or place of customers or users or entities and/or logically connect with them based on posted structured updated status of customers and/or user data. Viewing user(s) or administrator(s) of visual or presented customer management and customer relationship management of 1539 timeline is/are enabled to search, match, select, attach, detach, register, subscribe, purchase, install, download, upload, edit, update, upgrade, post, send, synchronize to connected users of user or entity and suggest, provide & visually present accessible links of applications, services, interfaces, multimedia data & contents, objects, shared contents to one or more selected or connected users, presented connections, prospective connections or connectable users or entities presented at 1539 timeline. For example restaurant owner can view all past/current & prospective customers in near future or future and their connections with restaurant and associate activities, events, actions, transactions including presented/presenting/will present menu to connected and/or connectable users who came/come/coming/will come at restaurant, order gave/given/advance order by visitor of restaurant, suggestions/feedbacks/complaints/specific requirement provided/providing by visitor of restaurant and bill paid/paying/advance payment by visitor of restaurant based on structured updated status of visitors of restaurant and/or profile data of restaurant including named entities, identity, details of restaurant, associate links of applications, services, objects, multimedia data & contents provided by restaurant to their customers or visitors of restaurant. Owner or administrator or authorized staff of restaurant can visually view, monitored, track, manage, communicate, collaborate, participate or conduct or takes one or more actions, events, activities & transactions including present menu or link of menu to connected customers or users at interface(s) of user(s)' device(s), so user can click on provided or presented menu interface or application & view menu, select items from menu and make order to connected or administrator or authorized staff of restaurant based on structured updated status associate named entities including restaurant name, location and/or current date & time, connected administrator or authorized staff of restaurant can accept order(s) and/or feedbacks, suggestions, comments, reviews, ranks, details of specific changes in ordered item(s) from interface(s) of connected current customer(s) of restaurant.

Viewing user(s) or administrator(s) of visual or presented 1517 and/or 1519 real-time or near real time customer management and customer relationship management is/are enabled to real time connect with and/or identify or receive needs, requirements, contextual or matched or related updated status, request(s), queries of past or loyal or regular customers, provide various types of supports to various types of customers via providing, sending, synchronizing and presenting dynamic, customized, portable & accessible interface to user, wherein interface comprises contextual, domain, field, subject, type of business & provider or entity specific links of applications, services, communication utilities, contents like instant message, video call, e-mail, chat, survey forms, presentations, buying or deal objects provided by administrator or staff of business which enables customers or viewing or receiving users to send/receive messages, make video or phone call, share contents, ask queries/receive answers, fill survey or requirement forms, view presentations of products and/or services and buy selected products and/or services. So dynamic interface of connectable or connected or connectable users are updates as per/based on real or near real-time updates in user's updated status or structured updated status, activities, actions, senses, events, transactions, behavior, status, current locations or places, date & time, wherein updates in dynamic interface of connectable user comprises updates in presentation of structured updated status specific connections, each or one or more or group(s) of prospective or candidate or suggested connection(s) specific links provided by said prospective or candidate or suggested connection(s) and/or attach by user. User can access, try to connect, connect & view current updated status, activity, action, requirement, purpose, event, transaction, location, place, entity specific prospective or candidate or suggested connections and associate dynamically presented or contextual or related or attached links for communicating, collaborating, sharing, conducting one or more actions, events, activities & transactions with one or more connected users.

In another embodiment visually presented or presented 1539 timeline including selectively or contextually generated or presented 1517 and/or 1519 interface(s) associate 1577 Real-time Prospective Customers Management enables viewing user(s) or administrator(s) to find prospective customers based on structured updated status provided or posted or auto generated and/or auto posted by or on behalf of users of network(s). For example based on “looking for/want to purchase” keywords and “Smartphone” keyword associate with filtered structured updated status, enables viewing user(s) or administrator(s) to real-time find prospective customers and are enabled to real-time view presented or updated prospective customers or accessible object or link of e.g. 1524 users or entities or prospective customers and are enabled to connect them and can communicate, collaborate, share contents, make offers, ask to participate in group(s) deal(s), negotiate with them, provide answers & conduct or finalize e-commerce transactions via 1545 associated or attached or provided or presented dynamic, portable & accessible links of applications, services, objects, contents.

In another embodiment visually presented or presented 1539 timeline including selectively or contextually generated or presented 1517 and/or 1519 interface(s) associate 1578 Real-time Advertisements Management enables viewing user(s) or administrator(s) or advertiser(s) to view, data mine, analyze, track, monitor selective or preferred or subscribed or updated or allowed or permitted physical and/or logical timeline including associate or generated or plotted or presented contextual or Ad. targeted connections, connectable or connected users and associate updated status, accessible links, information or data related to activities, actions, events, transactions, communications, collaborations & sharing based on structured updated status and/or request(s) and/or user data and enabling advertisers to select matched or contextual or targeted users or prospective customers and dynamically present to them customized advertisements and accessible links for enabling receiving users to view advertisement(s) and access associated links for communicating, collaborating, sharing, transacting with advertiser(s).

In another embodiment visually presented or presented 1539 selective or searched timeline including selectively or contextually generated or presented 1517 and/or 1519 interface(s) associate 1579 Real-time Search Engine & Matchmaking enables user(s) or administrator(s) or searching user(s) to real-time search information, data, people, entities, customers, prospective customers, trends, stocks related information, user comments, structured updated status or updated status generate in real-time from plurality of connected users, connections, activities, actions, events, status, transactions, communications, collaborations, sharing of/among connected users or entities or sources or nodes of network(s). For example searching user can search and real-time view updated matched or contextual users and selectively connect with them including for example “who is wondering in juhu beach”, “who are looking for particular types of jobs”, “who are looking for Jinaam dresses”, “who are using colgate at present or between particular data and/or time”, “who not like XYZY movie” and establish connections with them and/or communicating, collaborating, sharing, present surveys forms, multimedia presentations, present controls comprising buttons including like or not like or dislike buttons, present workspace and conducting one or more activities, workflow, task, actions, events & transactions with them including for example ask for, receive, view & analyze structured profile, ask queries or more details, fix appointments and call for interview.

In another embodiment visually presented or presented 1539 selective or searched timeline including selectively or contextually generated or presented 1517 and/or 1519 interface(s) associate 1580 Real-time Deals, Bids & Offers enables user(s) or administrator(s) to real-time present deals via detail structured updated status or posting of deals or inviting for group(s) deal(s) to searched & matched or contextual prospective connectable customers based on matching information of deals with structured updated status provided or posted by users of network(s) and/or user data and enabling them to participate in group(s) deals, make payment via user profile or user account associated centralize payment information and/or share or refer group(s) deal(s) to connected or related users of user for fulfilling or closing deals as early as possible.

In another embodiment visually presented or presented 1539 selective or searched timeline including selectively or contextually generated or presented 1517 and/or 1519 interface(s) associate 1585 Real-time Connections Management enables 1501 user(s) to select from visually presented or updated contextual or selective or preferred connections or connectable users or entities and invite them for adding them to contacts for connect them any time, visually connect & map them and take one or more selective or customized actions base on presented links.

In another embodiment visually presented or presented 1539 selective or searched timeline based on structured and/or unstructured search including selectively or contextually generated or presented 1517 and/or 1519 interface(s) associate 1586 Real-time sales, Marketing & E-commerce enables 1501 user(s) to real-time search, match, identify, analyze, select, connect, provide presentations & answers, ask for more details, share contents, communicate, present e-commerce shopping cart, negotiate with prospective customers who are looking for online purchasing of particular products and/or services.

In another embodiment visually presented or presented 1539 selective or searched timeline based on structured and/or unstructured search query (e.g. post structured search query including present selective or request specific set or group(s) of users or employees connected with particular company or entity or entities) including selectively or contextually generated or presented 1517 and/or 1519 interface(s) associate 1586 Real-time Human Resource Management enables 1501 user(s) or employer(s) or administrator(s) or manager(s) to real-time monitor, track, identify & know availability and/or presence information of employees, connect with selected employees, assign task(s) or jobs to one or more selected and/or connected employees, monitor, track & manage workflow, arranging meetings of clients with them, share information, communicate & collaborate with all or selected or filtered clients and/or employees, monitor, track & manage sales and expenses of marketing departments associate employees, set, apply, input, select, update, configure & assign roles, rights & privileges, security polices, privacy settings & preferences for accessing data, connect with one or more or all other employees and/or presented accessible links to all or one or more employees.

In another embodiment 1500 user(s) can real-time 1588 views logical and/or physical activities, actions, status, events & transactions and associate data & links conducted by users of networks based on one or more 1502 structured or free form search queries, 1504 auto matchmaking preferences, drafting structured query via 713 & 813 menu(s), 1509 selection from templates or past search queries, 1505 selection from list of locations, 1508 date & time ranges, 1510 type(s) of activities and like. For example user can view logical and/or physical activities, actions, status, events & transactions and associate data & links of all or selected visitor users of particular mall.

In another embodiment 1591 user(s) can real-time share information, data, multimedia contents, news, blogs, videos, photos, images, songs or music or audio files, URLs, updated status, refer or suggest connectable users or entities or connections, send alerts or notifications and push data with/to selected one or more users plotted or presented or generated or updated in/within/at visually or graphically or textually presented 1517 and/or 1519 views.

In another embodiment 1500 user(s) can real-time presenting domain or subject specific survey forms to selected one or more users plotted or presented or generated or updated in/within/at visually or graphically or textually presented 1517 and/or 1519 views and receive more structured details from them and knowing more to users for establishing contextual & targeted connections for targeted purpose or activities.

In another embodiment 1500 user(s) can real-time 1593 creating, generating, defining, customizing, configuring, attaching or adding users to workspace from presented 1517 and/or 1519 views, attaching links of applications, services, objects & contents and inviting for and/or presenting workspace to one or more selected users from presented 1517 and/or 1519 views for conducting collaboration, communications, sharing, participations in activities, workflows among set of users including administrator, employees, clients, 3^{rd} parties professionals or service providers & entities.

1594 Real-time Views (Updated Logical & Selective Visual Views)

In another embodiment 1500 user(s) can real-time view 1595 updated information based on user interactions with other connectable users or entities from various sources or connections or connectable users or entities including unstructured and/or unstructured updated status, requests, user data, shared data, user activities, actions, events, transactions related data based on source or connectable user(s)' preferences & privacy settings. For example when user visits particular hotel user can connect with appropriate types of hotel staff and also connect with past and present or prospective guests of hotel who experienced with hotel and can view their comments, ratings, reviews, feedbacks, suggestions, complaints and can ask them specific queries.

In another embodiment 1500 user(s) can 1596 real-time monitor, track, update, map, link, record one or more selected connections or users or entities and associate activities, actions, events, transactions, locations or places.

In another embodiment 1500 user(s) can 1597 real-time create, join, and invite selected users for joining to one or more user created and/or dynamically created social networks and/or group(s) based on one or more structured purposes including create social network based on structured updated status related to attending of particular event at particular date & time and location by set of users and add attendees to dynamically created social networks and enables members of said social network to connect, communicate, collaborate & share with each other. In another embodiment system and/or users can dynamically create, generate one or more types of formation of/among connections based on structured updated status and/or requests and/or user data.

In another embodiment 1500 user(s) can 1598 real-time mine or analyze data generated between/among connected user. User can view and/or connect one or more types of trend(s) specific connectable or connected or prospective for connections, user can view and/or connect similar types of activities and/or actions and/or events and/or transactions doers, User can real time view and/or connect comments posted by viewer of particular running movie from all theatres, User can view who likes, purchase which brand of which categories and how many, from where, when purchased and associate data, user can view relational or connecting data of various types of users. 1500 User can in plurality of ways can view, navigate, browse, explore, select, access, identify, bookmark, invite for adding to contacts, connect, advertise, purchase, link, monitor, track, store & update, test, suggest, share, refer, search & match prospective or matched connections from/of/to/at/on/in/within one or more selective or preferred parts of physical world and/or logical world or particular scenario of physical world combined with logical world related connections.

In another embodiment user can view particular or selected one or more user(s) and/or entities specific selective scenario i.e. series or sequence of actions and events or timeline including associate or related past, present, prospective or future prospective or suggested or candidate connections presented to user(s) and/or connection established between/among them based on structured updated status and/or user data including connections determined based logical association between connectable users or entities and/or based on physical location(s) or place(s) association between connectable users or entities and data about associate activities, actions, events & transactions.

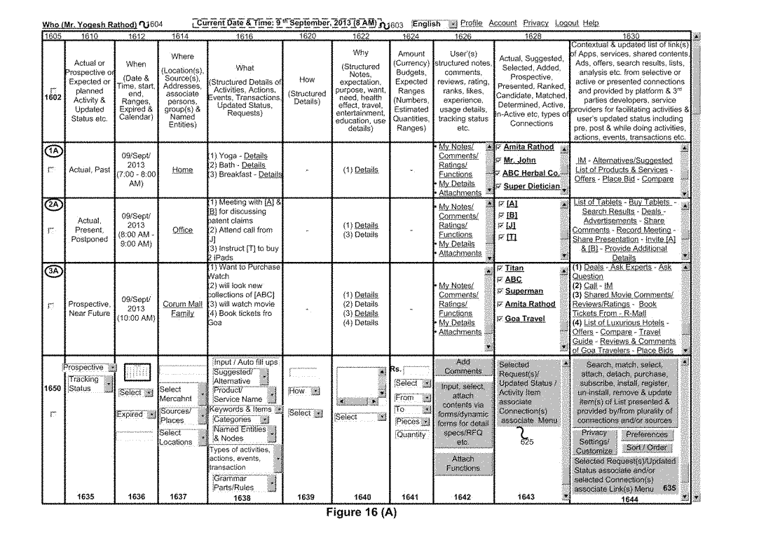

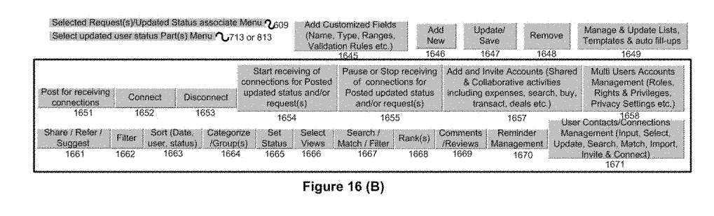

FIG. 16 illustrates user interface enabling 1604 user(s) to 1646 add new, 1647 update or save & 1448 remove one or more structured or relational entries or records of updated status or details of particular activity, actions, event, transaction, status, note, user generated or shared content. User can 1645 add, update & remove fields including data fields and/or interface fields (1605-1630). User can also customize fields including name of field, type & size of field, default data or values of fields, associate one or more rules, validations and like. When user click on 1646 add new entries or record or row of list then system creates, add & presents 1650 empty record or entry or row with various (1635-1644) selection controls including combo boxes or lists or 609 menus for users selections and enables users to input, add, (1635-1644) select item(s) from pre-created or user created & updated lists or combo boxes, apply, set & update one or more types of contents for one or more (1605-1630) fields related to one or more types of activities, actions, events, transactions, events, communications, collaborations, workflow, tasks, sharing & participations including 1612 when including date & time, start, end, ranges, expire & calendar, 1614 where including location(s), source(s), addresses, associate persons, group(s) & named entities, 1616 what including structured details of activities, actions, events, transactions, updated status, requests may selected via 713 & 813 select updated user status part(s) menu, 1620 how including structured or free form details, 1622 why including structured or free form notes, details about expectation, purpose, want, need, health effect, travel, entertainment, education & use details, 1624 associated amount, budgets, volumes, quantities & ranges, 1626 user'(s) structured notes, comments, reviews, rating, ranks, likes, experience, usage details, & tracking status, 1628 actual, suggested, selected, added, prospective, presented, ranked, candidate, matched, determined, active, in-active & other types of connections, 1610 type of record(s) including actual or prospective or expected or planned types of activity & updated status and 1630 contextual & updated list of link(s) of applications, services, shared contents, advertisements, offers, search results, lists, analysis etc. from selective or active or presented connections and provided by platform & 3rd parties developers, service providers for facilitating activities & user's updated status including pre, post & while doing activities, actions, events, transactions. User can view, edit, 1647 update past, present & planned or future or prospective entries or records or rows (1A, 2A & 3A) & associate fields (1605-1630) of activities, actions, events, transactions, communications, participations, collaborations, sharing, notes, comments, user generated data & attached or associated data. User can also 1649 manage including add, update, attach, detach, remove, update to global database, collaboratively update one or more items of one or more lists or combo boxes, templates & auto fill-ups list(s) or keywords or categories or nodes or items. User can use & access 625 selected request(s)/updated status/activity item associate connection(s) associate menu(s) and options for managing one or more selected entries or records or rows (1A, 2A & 3A) associated, presented, attached, related, searched, matched, purchased, ranked & updated connections. User can use & access 635 selected request(s)/updated status associate and/or selected connection(s) associate link(s) menu for managing one or more selected entries or records or rows (1A, 2A & 3A) associated, refereed, presented, attached, related, searched, matched, selected, registered, suggested, subscribed, downloaded, uploaded, upgraded, purchased, ranked & updated links of one or more applications, services, objects, multimedia types of contents or data, databases, forms, controls for user actions and/or user selections of various types of contents and/or items or lists, interfaces, user profile object(s), connection object(s).

In another embodiment user(s) is/are enable to dynamically create, generate, draft, edit, order, arrange, configure, customize, update, and define domain(s), subject(s), field(s), activity or activities, action(s), event(s), workflow(s), task(s), transaction(s) specific forms or interfaces and/or dynamically add, update, select, input, set, apply details associate with forms or interfaces or fields of forms and/or dynamically attach or associate or add with one or more fields (1610-1630) of one or more selected entries or records or rows (1A, 2A & 3A).

In another embodiment user(s) is/are enable to select one or more entries or records or rows (1A, 2A & 3A) and can take one or more or group(s) actions on selected all or one or more entries or records or rows (1A, 2A & 3A) including enabling 1604 user(s) to 1651 post one or more selected entries or records or rows (1A, 2A & 3A) for receiving 1628 connection including prospective, candidate, suggested, searched, matched, determined, ranked, purchased, updated, suggested by connected users of user, available, actual and one or more other types of connections, 1652 enabling 1604 user(s) to 1651 connect or 1653 disconnect with one or more selected 1628 connections of one or more entries or records or rows (1A, 2A & 3A) for enabling connected users to 1644 access, search, match, select, purchase, subscribe, install, register, un-install, remove, update, share, refer, sort, order, attach, detach, apply privacy settings & preferences & use one or more 1630 links or item(s) of contextual list presented & provided by/from plurality of connections and/or sources for conducting one or more types of activities, actions, events, transactions, communications, participations, collaborations, sharing, workflow & tasks.

In another embodiment 1604 user(s) can 1655 pause or stop receiving of prospective, suggested, candidate, searched, matched, determined, auto contextual, past, ranked, available, connected lasts, from contacts, purchased, provided by connected or related users & updated connections for posted and/or stopped or paused one or more entries or records or rows (1A, 2A & 3A) including updated status and/or request(s).

In another embodiment 1604 user(s) can 1654 start receiving of prospective, suggested, candidate, searched, matched, determined, auto contextual, past, ranked, available, connected lasts, from contacts, purchased, provided by connected or related users & updated connections for posted and/or stopped or paused one or more entries or records or rows (1A, 2A & 3A) including updated status and/or request(s)

In another embodiment 1604 user(s) is/are enable to 1658 manage multi users accounts including add, invite, update & remove users & user details and define, customize, update, configure, add, input, set, apply, attach & associate one or more roles, rights & privileges, privacy settings, security policies for one or more users or members or accounts.

In another embodiment 1604 user(s) is/are enable to select one or more entries or records or rows (1A, 2A & 3A) and/or fields (1610-1630) including 1661 share, refer & suggest, 1662 filter, 1663 sort as per date & time wise, location wise, activity wise, user wise, status wise & like, 1664 categorize or group(s), 1665 set or update status, 1666 select views, 1667 search, match & filter, 1668 rank(s) and provide 1669 comments & reviews.

In another embodiment 1604 user(s) is/are presented with received and/or shared entries or records or rows from one or reo sources including connected or related users of user(s).

In another embodiment 1604 user(s) can use, access and set, apply, customize, select, input, update & configure 1670 Reminder Management for reminding user(s) in posting of updated status, viewing, managing, following-ups & conducting of one or more types of activities, actions, events, transactions, communications, participations, collaborations, sharing, workflow & tasks.

In another embodiment 1604 user(s) 1671 can manage user contacts & connections including input, select, update, search, match, import, invite, adding to contacts & connect one or more users.

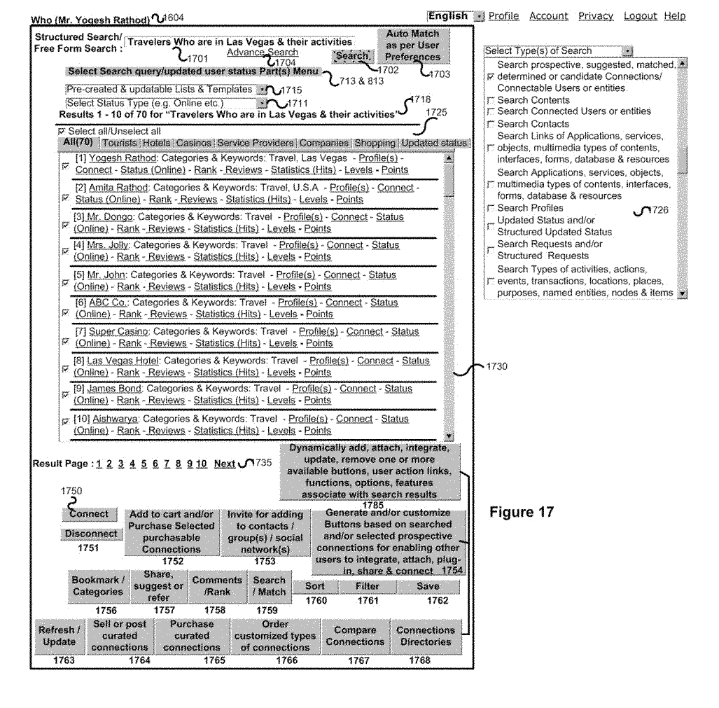

FIG. 17 illustrates searching interface which enabled searching user or requestor(s) to search connections, updated status & requests of users based on one or more 1701 search queries, 1703 auto matchmaking preferences, 1704 advance search criteria, ranges, values, selections from 1715 pre-created lists or templates or past search queries, rules, 1711 select status type(s), Boolean operators, keywords, categories and/or one or more structured search queries selected via 713 & 813 Select Search query/updated user status Part(s) Menu. For example 1604 user(s) input or select & draft structured search query 1701 “Travelers Who are in Las Vegas & their activities” via 713 & 714 auto-fill ups list(s) and/or menus or lists of parts of structured search query and post or submit or send to 115 server for receiving search results. Based on search query 115 server returns 1725 categories (accessible via tabs) 1730 search results at 1604 user interface and presents information about 1718 number of search results items. 1715 & 1730 Categories search results comprises structured search query 1701 “Travelers Who are in Las Vegas & their activities” specific 1730 connections including matched, contextual, available, connectable, ranked, updated connections and/or associate updated status and/or allowable user data and/or associate allowable or accessible links. Search result items comprises accessible profile link of connectable or presented users, associate categories & keywords, accessible link of user actions including connect, status, rank, reviews, statistics, levels & points, wherein accessible link of user actions enables 1604 searching user or viewing user to connect said user, view availability status and/or presence information, view ranks & comments provided by other users of network(s), view shared contents including reviews of user, view statistics, levels & points associate with user. User can view 1735 particular page specific search results. Use can select one or more search result items (e.g. 1-10 of page 1) from 1730 search result and are enable to take one or more actions including 1750 connect or 1751 disconnect, 1752 Add to shopping cart and/or purchase selected purchasable connections based on payments, subscriptions, one or more types of payments modes & packages, 1753 Invite for adding to contacts and/or particular or created or dynamically created group(s) and/or particular or created or dynamically created social network(s), 1756 bookmark, 1756 share, suggest & refer to particular or selected user(s) or group(s) of user(s) of network(s), 1758 provide comments & ranks, 1759 re-search or search within search results, 1760 sort, 1761 filter & 1762 save.

In another embodiment users can 1785 dynamically add, attach, integrate, update, and remove one or more available buttons, user action links, functions, options, features associate with search results including for example 1763 refresh or update search result button for viewing or receiving updated connections and/or updated status and/or associated user data and/or associated links, 1764 sell or 1765 purchase curated connections button enables to re-sell curated connections to other users of networks based on making curated or aggregated or analyzed or tested connections searchable and publish for other users of network(s) and enable them to search, match, select & purchase curated connections and/or associate allowable or re-sharable user data based on one or more types of subscriptions and/or payment models, search user associate or related past, present & prospective connections button, 1767 compare connections button which enables user to compare one or more selected connections including prospective connections, connected users, actual, ranked, updated connections based on one or more criteria, match making preferences, rules, profile fields and/or values and parameters (e.g. locations, languages, gender, qualifications, age range, income range, quality, points or ranks or levels earned, number of hours participations, number of times participated or connected with other users),

In another embodiment user is enable to compare two or more connections or connectable users based on one or more selected factors, properties, attributes, qualities, values, qualifications, income, monthly expenses, student wealth, features, interests, location, language, age, gender, profile data, type of business, type of jobs, type of arts, type of skills, number of years of experience, level, ranks & points earned.

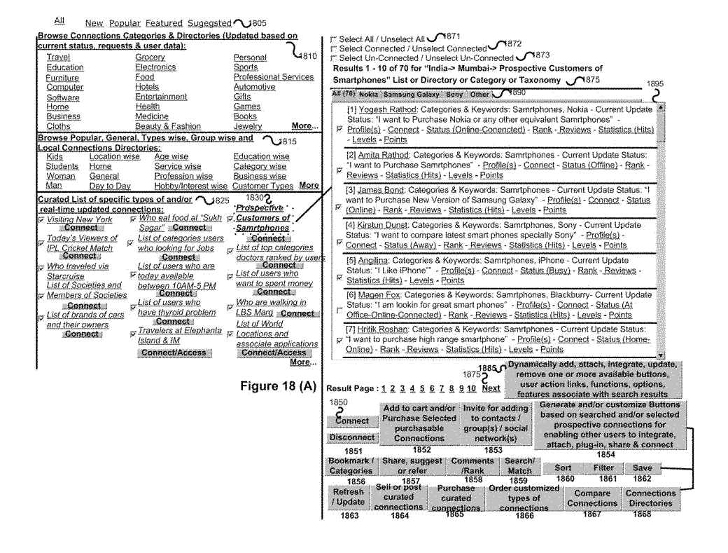

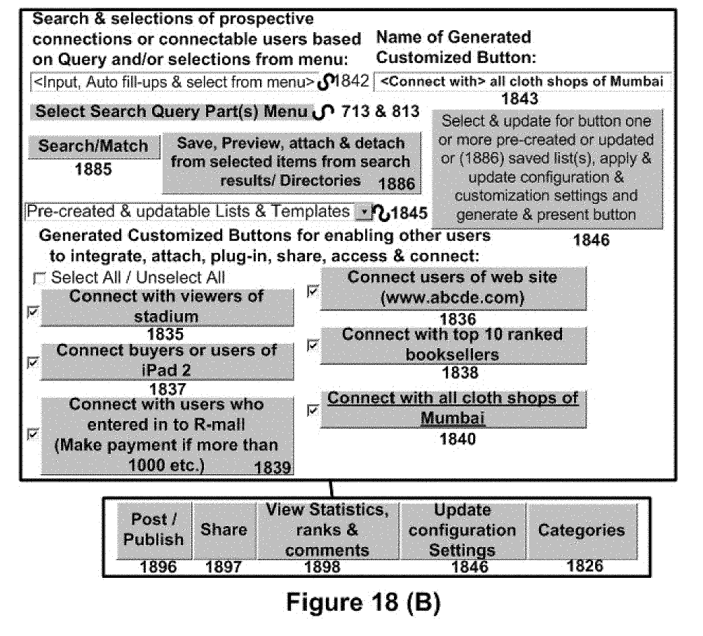

In another embodiment user can make 1766 order of particular type of models of connections or connectable users including one or more selected or targeted factors, properties, attributes, qualities, values, qualifications, income, monthly expenses, student wealth, features, interests, location, language, age, gender, profile data, type of business, type of jobs, type of arts, type of skills, number of years of experience, level, ranks & points earned of connections to domain(s) or subject(s) specific expert(s) or user(s) for accumulating, testing, ranking and one or more types of system as well as human mediated monitoring, tracking, analysis, mining, testing, experiments, actions, processing for identifying particular types of connections for one or more types of activities, actions, events, transactions, communications, collaborations, sharing & participations. In another embodiment user can access, use, select preferred connectable users from 1768 real time updated categories connections directories discuss in FIG. 18 in details.

FIG. 18 illustrates user interface for searching, matching, navigating, browsing, selecting, sorting, accessing, connecting, purchasing, generating button or link(s) of set of, filtering, sharing, referring categories, domain(s), keyword(s), subject(s), one or more type(s) of activity or activities, action(s), event(s), transaction(s), location(s), workflow(s), business(s), job(s), work(s), education(s) or qualification(s), task(s) specific or one or more query or logical formation specific real time updated & pre-created connections & connectable users or entities from categories or taxonomy wise directories 1805, 1810, 1815 & 1825. For example when user clicks on 1820 “Prospective Customers of Smartphones” user is presented with associate 1895 list(s) of prospective or suggested or candidate connections or connectable users accessible via tabs 1890. Use can select one or more items associate with presented list of particular category or taxonomy (e.g. 1-7 item of list of page 1) from 1895 listed or presented items and are enable to take one or more actions including 1850 connect or 1851 disconnect, 1852 Add to shopping cart and/or purchase selected purchasable connections based on payments, subscriptions, one or more types of payments modes & packages, 1853 Invite for adding to contacts and/or particular or created or dynamically created group(s) and/or particular or created or dynamically created social network(s), 1856 bookmark, 1856 share, suggest & refer to particular or selected user(s) or group(s) of user(s) of network(s), 1858 provide comments & ranks, 1859 re-search or search within search results, 1860 sort, 1861 filter & 1862 save.

In another embodiment users can 1885 dynamically add, attach, integrate, update, and remove one or more available buttons, user action links, functions, options, features associate with search results including for example 1863 refresh or update listed items button for viewing or receiving updated connections and/or updated status and/or associated user data and/or associated links, 1864 sell or 1865 purchase curated connections button enables to re-sell curated connections to other users of networks based on making curated or aggregated or analyzed or tested connections searchable and publish for other users of network(s) and enable them to search, match, select & purchase curated connections and/or associate allowable or re-sharable user data based on one or more types of subscriptions and/or payment models, search user associate or related past, present & prospective connections button, 1867 compare connections button which enables user to compare one or more selected connections including prospective connections, connected users, actual, ranked, updated connections based on one or more criteria, match making preferences, rules, profile fields and/or values and parameters (e.g. locations, languages, gender, qualifications, age range, income range, quality, points or ranks or levels earned, number of hours participations, number of times participated or connected with other users).

In another embodiment user is enable to compare 2 or more connections or connectable users based on one or more selected factors, properties, attributes, qualities, values, qualifications, income, monthly expenses, student wealth, features, interests, location, language, age, gender, profile data, type of business, type of jobs, type of arts, type of skills, number of years of experience, level, ranks & points earned.

In another embodiment user can make 1866 order of particular type of models of connections or connectable users including one or more selected or targeted factors, properties, attributes, qualities, values, qualifications, income, monthly expenses, student wealth, features, interests, location, language, age, gender, profile data, type of business, type of jobs, type of arts, type of skills, number of years of experience, level, ranks & points earned of connections to domain(s) or subject(s) specific expert(s) or user(s) for accumulating, testing, ranking and one or more types of system as well as human mediated monitoring, tracking, analysis, mining, testing, experiments, actions, processing for identifying particular types of connections for one or more types of activities, actions, events, transactions, communications, collaborations, sharing & participations.

In another embodiment user can 1871 select all or unselect all, 1872 Select Connected or Unselect Connected and 1873 Select Un-Connected or Unselect Un-Connected from presented 1895 list(s).

In another embodiment directories are updated based on real-time updates in users' updated status, connections among users, updates in user data including data related to user profile, user connections, user activities, user actions, user associate events, user associated transactions, updated in user's current location(s) or place(s).

In another embodiment user(s) is/are enable to 1754 and/or 1854 generate and/or customize buttons based on searched and/or selected prospective connections and/or connectable users for enabling other users to integrate, attach, plug-in, share buttons and/or enable other users to access, click on one or more or group(s) of buttons for connecting with button attached or associated or packaged or list(s) of prospective connections and/or connectable users.

In another embodiment user(s) is/are enable to search, match, filter, sort, update, select & preview one or more or group(s) or category or categories of prospective connections or connectable users based on one or more 1842 search queries, user inputs & selections, keywords, match making preferences and/or 1842 drafting of structured query or queries via 713 or 813 Select Search Query Part(s) Menu and 1885 send request for search to server(s). User(s) can view & 1730 select & add to button associate list(s) from presented search results and/or select from 1895 list of particular 1805, 1810, 1815 & 1830 directory or directories. User can also further preview, update, attach & detach items from list of items from search results/directories and creating (e.g. 1835-1840) button(s) via providing, inputting & selecting 1843 name of button and 1846 select for button or attach or associate with button one or more pre-created or updated or 1886 saved list(s), apply configuration & customization settings including privacy settings, preferences, access rights & privileges, security policies, subscription or payment modes and generating & 1840 presenting of 1843 named button and 1896 post, publish, 1826 categories & 1897 share one or more selected buttons, 1898 view button(s) associated statistics, ranks & comments, wherein generated and/or posted or shared or published button(s) enables other users to search, match, select one or more buttons and/or click & access button(s) associate prospective connections or connectable users and connect accessing user with button(s) associated list of prospective connections or connectable users for conducting one or more types of purposes, deals, tasks, workflow, activities, actions, events, transactions via accessing prospective connections or connectable users associate links of applications, services, objects, multimedia contents, databases, user actions or controls and interfaces. For example “Connect with all cloth shops of Mumbai” button enables button accessing user to connect with users or entities associate with cloths shop of Mumbai and conduct one or more types of deals, tasks, workflow, activities, actions, events, transactions with one or more connected users.

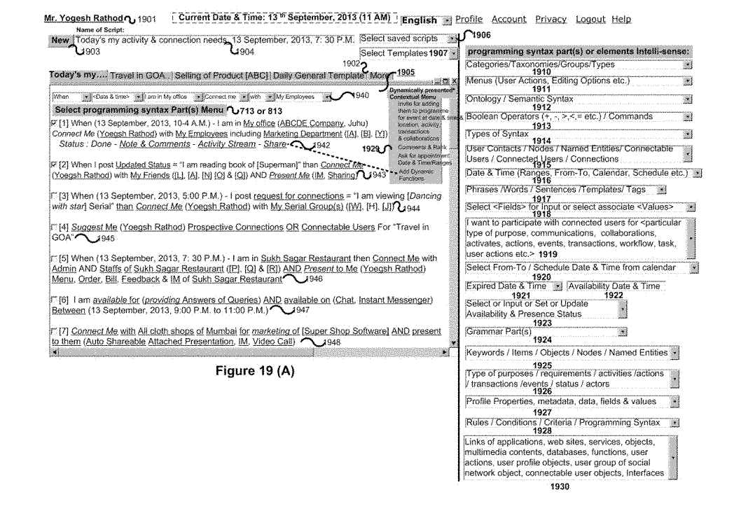

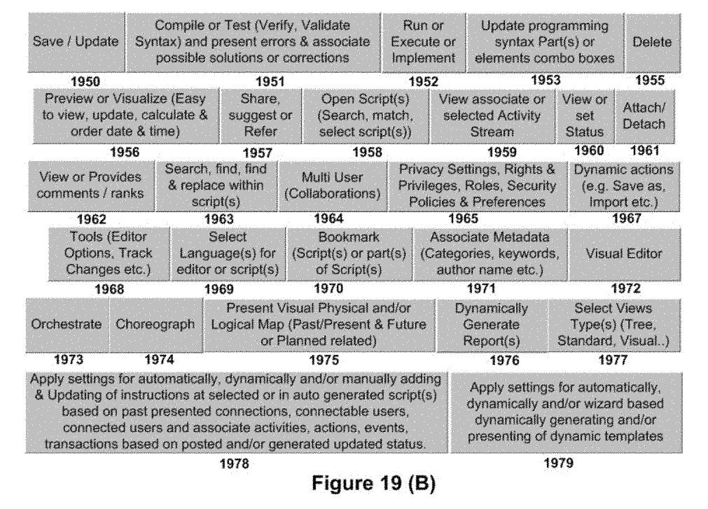

FIG. 19 illustrates user interface for enabling user(s) and/or group(s) of user(s) and/or server(s) and/or system(s) to manually and/or automatically adding, drafting, editing, updating, storing, saving, processing, formatting, ordering, sequencing, orchestrating, choreographing, real-time modifying, sharing, searching, matching, selecting, verifying, validating, compiling, detecting & present or correcting errors or suggesting for errors, executing, running, implementing programming instructions based on standardized syntax for programming of user's plurality types of connections needs for one or more types of purposes, requirements, activities, actions, events, transactions, behavior, interactions, tasks, workflows, jobs, updated status, requests, queries, senses, past, present or current or checked-in location(s) or place(s) including determining, searching, matching, identifying, selecting, purchasing, ranking, ordering, sorting, presenting programmed instruction(s) specific connections or connectable users & connected users including prospective, suggested, candidates, matched, inferred connections or connectable users & connected users and associate links of applications, services, objects, interfaces, contents, databases, profile objects, multimedia data, wherein programmed instruction(s) executed or implemented based on associate order(s) and/or group(s) and/or date and/or time and/or ranges of date and/or time and/or schedule(s) and/or calendar entries and/or customized or defined triggers or triggering of events and/or user meditated actions including user clicks, user(s) or admin(s) or group(s) of user(s) permission(s), authentications, authorization, identifying privacy settings, preferences, roles, rights & privileges, security policies and/or identification, detection, recognition of particular type of senses or sensors or devices and/or detection, recognition & identification of user's image in video or photo or sequence of image(s) or user's voice or user's and/or user associate or related or connected or contextual or nearness user(s)' or entities' location(s) and/or determined or selected or auto identified one or more type(s) or keyword(s) of user interaction(s), activity or activities, actions, events, purposes, requirements, transactions, behavior, shared contents, sharing, communications, collaborations, participations, nearness, connections, connected users, presented links of applications, services, objects, interfaces, databases & multimedia types of contents, interactions, tasks, workflows, jobs, updated status, requests, queries, senses, past, present or current or checked-in location(s) or place(s).

For example 1901 User(s) is/are enable to 1903 add new script or 1904 naming script(s) or 1906 select from saved scripts or 1907 select template(s) or 1905 or 1902 open or close, or select from list or cascade or tile or minimize or maximize one or more already exists scripts for adding, updating, drafting, (713, 813, 1910-1930) selecting or auto completing or auto identifying or auto filling standardized programming instructions via 1904 full features intelligent editor(s) for presenting and/or enable to connecting with and/or connecting user(s) or entity or entities with prospective, matched or suggested connections or connectable users and/or dynamically present associate links of applications, services, objects, interfaces & multimedia data for doing, conducting, planning, analyzing, getting information for, presenting, implementing, facilitating, establishing, fulfilling, assigning, executing one or more or selected or particular or set of or group(s) of purposes, requirements, activities, actions, events, interactions, transactions, locations, places, sharing, communications, collaborations, participations, workflows & tasks.

User can access, invoke & use 713 and/or 813 menu(s)/sub-menu(s) or integrated or interwoven or in-line or dynamic or customized or contextually filtered or real-time updated auto fill-ups or auto completion control(s) and/or intelligent sense or intelligent code sense (IntelliSense) from within editor for selecting or auto filling or auto completing one or more 1910 Categories, Taxonomies, Groups & Types, 1911 Menus including User Actions, Editing Options, Spell or grammars checking, ask for suggestion or options, connect for asking information, view node(s), named entities, items, links or contacts or objects associate metadata, system data, data, profile, privacy settings, preferences, availability, presence information, communicate, collaborate & invite them for adding them to script(s) 1912 domain or subject specific Ontology & Semantic Syntax, 1913 Boolean Operators including plus, minus, not, include, exclude, greater than, less than, equal to (+, −, >,<,=) and Commands, 1914 Various types of Syntax (Structured queries language (SQL), Standardize Language(s)), 1915 User associated or added or invited or suggested contacts, connections, nodes & named entities including brands, name of products and/or services, location names, local names, people or entities names, 1916 Date & Time including (Ranges, From-To, Calendar specific multiple entries, Schedule), 1917 Phrases, Words, Sentences, Templates & Tags, 1918 Select <Fields> for Input or select associate <Values>, 1919 particular type(s) of applications, services, workspaces, objects, multimedia contents, user actions, communications, collaborations, activities, actions, events, transactions, workflow & task user want to share or conduct or do with or participate with connected users, 1920 Select From-To, Schedule Date & Time from calendar, 1921 Expire Date & Time, 1922 Availability Date & Time, 1923 Select or Input or Set or Update Availability & Presence Status, 1924 Grammar Part(s), 1925 Keywords, Items, Nodes & Named Entities, 1926 Type of purposes, requirements, activities, actions, transactions, events, status & actors, 1927 Profile Properties, metadata, data, fields & values, 1928 Rules, Conditions Criteria & Programming Syntax and 1930 Links of applications, web sites, services, objects, multimedia contents, databases, functions, user actions, user profile objects, user group of social network object, connectable user objects, Interfaces.

User can 1950 save or update one or more 1905 or 1902 scripts of file of scripts. User can 1951 compile or test one or more or selected parts of 1905 or 1902 scripts including verify, validate, check syntax of script(s) and present or highlights errors with hints & associate possible solutions or corrections

In another embodiment intelligent sense or intelligent code sense (IntelliSense) provide suggestions to user while inputting, editing, updating & selecting of instructions or codes or script texts and presenting contextual auto completion popups when typing, querying parameters of functions, query hints related to syntax errors. IntelliSense serves as documentation and disambiguation for named entities, nodes, items, user actions, type of links, variable names, functions and methods using reflection. IntelliSense is a convenient way to access descriptions of functions, particularly their parameter lists. It speeds up software development by reducing the amount of name memorization needed and keyboard input required. It also allows for less reference to external documentation as interactive documentation on many symbols (i.e. variables and functions) in the active scope appears dynamically in the form of tooltips while programming.

IntelliSense works using an automatically generated in-memory database of parts of syntax, named entities, connectable nodes or nodes of network(s) connected in network environment, lists, categories, groups, objects, items, date & time, keywords, application name, service name, user actions, location name, user names, user contacts, user social graph, fields, type of activities, actions, events, transactions, classes, variable names, and other constructs that the application being edited defines or references. The “classic” implementation of IntelliSense works by detecting marker characters such as periods, or other separator characters, depending on the language. When the user types one of these characters immediately after the name of an entity having one or more accessible members (such as contained nodes, named entities, groups, functions, user actions, links, items, variables or functions), Intelli Sense suggests matches in a pop-up window. The user can either accept the suggestion by typing a statement completion character “Tab” or “Enter” or a language-specific marker, or continue typing the name. Over time, IntelliSense determines which named entities, connectable users or group(s), nodes, items, variable or function the user most likely wants. IntelliSense also displays a short description of a named entities, connectable users or group(s), nodes, items, variable or function in the pop-up window—depending on the amount of documentation in the function's source code.

As soon as the user types the period or other separator characters, for example after “Connect Me with”, IntelliSense automatically lists all the available named entities, group(s), member functions (i.e. connect with group and connect all) and all the available member attributes. The user can then select one by using the arrow keys and hitting a completion character when the correct member function is highlighted. When available, IntelliSense displays a short description of the member function as given in the source code documentation. IntelliSense goes further by indicating the required parameters in another pop-up window as the user fills in the parameters. As the user types a variable name, the feature also makes suggestions to complete the variable as they are typed. IntelliSense continues to show parameters, highlighting the pertinent one, as the user types. The user can “force” IntelliSense to show its pop-up list without context by using ctrl+J or ctrl+space or any other combination of keys or touch instructions.

In another embodiment editor is also enabled to syntax highlighting, it is a feature of text editors that displays text, especially source code, in different colors and fonts according to the category of terms. This feature facilitates writing in a structured language such as a programming language or a markup language as both structures and syntax errors are visually distinct. Highlighting does not affect the meaning of the text itself; it is intended only for human readers.

User can 1952 set, apply, select, input & update one or more script as/in running mode or run or execute or implement one or more or selected parts of one or more script(s). When user enables or set script in running or execution or enablement mode than system reads instruction or line(s) or group(s) of lines of standardized syntax or text codes (e.g. 1905 [1]-[7]) of one or more scripts and based on interpretation of instruction or line(s) or group(s) of lines of standardized syntax or text codes (e.g. 1905 [1]-[7]) and defined sequences of commands, rules and associate named entities, user actions, links & nodes, system presents to user(s) defined needs specific plurality types of connections for one or more types of purposes, requirements, activities, actions, events, transactions, behavior, interactions, tasks, workflows, jobs, updated status, requests, queries, senses, past, present or current or checked-in location(s) or place(s) including determining, searching, matching, identifying, selecting, purchasing, ranking, ordering, sorting, presenting programmed instruction(s) specific connections or connectable users & connected users including prospective, suggested, candidates, matched, inferred connections or connectable users & connected users and associate or instructed or programmed or suggested or defined links of applications, services, objects, interfaces, contents, databases, profile objects, multimedia data, wherein programmed instruction(s) executed or implemented based on associate order(s) and/or group(s) and/or date and/or time and/or ranges of date and/or time and/or schedule(s) and/or calendar entries and/or customized or defined triggers or triggering of events and/or user meditated actions including user clicks, user(s) or admin(s) or group(s) of user(s) permission(s), authentications, authorization, identifying privacy settings, preferences, roles, rights & privileges, security policies and/or identification, detection, recognition of particular type of senses or sensors or devices and/or detection, recognition & identification of user's image in video or photo or sequence of image(s) or user's voice or user's and/or user associate or related or connected or contextual or nearness user(s)' or entities' location(s) and/or determined or selected or auto identified one or more type(s) or keyword(s) of user interaction(s), activity or activities, actions, events, purposes, requirements, transactions, behavior, shared contents, sharing, communications, collaborations, participations, nearness, connections, connected users, presented links of applications, services, objects, interfaces, databases & multimedia types of contents, interactions, tasks, workflows, jobs, updated status, requests, queries, senses, past, present or current or checked-in location(s) or place(s).

User can 1953 add, save, edit, update, remove, attach, detach, search, match, select, sort, rank, order, update from global database, share, refer, suggest, select view type(s), update collaboratively by one or more connected or related or invited users, apply privacy settings & preferences for one or more items of one or more 1910-1930 list(s). User can also update Global Database including Suggest Keywords, Types, Categories, Names, phrases, metadata & update Activities, Actions, Locations, Places, Events, Transactions, Names entities, Data Fields or Data or Value.

User can 1955 delete or remove or 1961 attach or detach one or more 1905 ([1]-[7] selected part(s) of/with or one or more file(s) of 1902 script(s).

User can 1956 preview or visualize 1902 scripts in graphical mode, for enabling user to easily view instructions or codes of script(s), relationship among them, take one or more associated user actions, update the code, calculate date & time, orchestrate & choreograph process & order, calculate, determine date & time, including present images, links, videos, voice, audio, icons, photos, objects, identity of parts of instructions including named entities, groups, date & time, location, people, applications, service, object, functions, item and linking line which highlights relationship, order, sequence between them and associate dynamically presented & contextual user actions 1929 menu including select from list, invite within visual editor, ask for appointment date & time, attach contents, add comments, reviews, ranks and like.

User can also 1957 share, collaboratively share, suggest, real-time suggest, collaboratively suggest & refer one or more scripts and/or parts of scripts to one or more users.

User can also 1958 search, match, select, open, close, save, save as, import, export, send, send to, synchronize, make searchable, minimize, maximize, backup, restore, encrypt, decrypt, compress, uncompress, apply password for authenticating and authorizing others & print one or more 1902 script(s). User can dynamically 1967 add, remove, attach, detach, register & update one or more user actions, functions, features with 1905 editor from provided, searched, matched, selected, downloaded, purchased, subscribed, updated, uploaded more user actions, functions, features from one or more sources.

User can 1959 view & access one or more 1942 executed or implemented 1905 ([1]) instructions or part of script(s) or script(s) associated or selected activity stream including monitored, tracked, stored, processed activity, action, transaction, event, location, place specific activity stream and associate data including communications, messaging, conversations, application data, comments, reviews, ranks, notes, shared data, details of transactions, workflow & tasks & logs.

User can also 1960 view automatically and/or manually assigned, selected & updated status and can set, input, apply, configure, customize, define, select & update 1942 status for 1905 ([1]-[7]) one or more or set or group(s) of instructions or standardized code or text code.

User can also 1960 view, access & provide comments, reviews & ranks associate with or to 1905 ([1]-[7]) one or more part(s) of script(s) including one or more keywords, name entities, nodes, items, keywords, categories, applications, services, users, objects & links or one or more script(s) 1902.

User can 1963 search, find, find & replace text(s) or code(s) within 1905 and/or 1902 script(s).

User(s) can assign 1964 multi users and/or collaboration and/or workspace and/or workflow specific roles, rights & privileges, security policies, associate privacy settings & preferences for enabling each member for adding, editing, updating, compiling, verifying, validating, testing, sharing, suggesting, collaborating, providing comments & ranks, accessing editor options, Crete or remove members, applying privacy settings, setting status, searching, matching, executing, running or implementing scripts, accessing one or more features of editor(s), updating of part(s) of programming syntax including named entities, nodes, items, keywords, categories and viewing, using & accessing one or more applications, services, features, functions, objects, profiles, user data, updated status, requests, connections, contacts, links, communications data, activities streams & resources.

User(s) can 1965 set, apply, input, select & update one or more privacy settings, access roles, rights & privileges, security policies & preferences to/with/in one or more script(s) for authenticating and/or authorization other users for accessing & managing 1902 script(s).

User can 1968 use various tools associate with editor including editor options, track changes, presentation & formatting settings, customization settings.

User can 1969 select, set, switch one or more language(s) for 1905 editor or 1902 script(s).

User can 1970 bookmark one or more 1905 ([1]-[7]) part(s) of script(s) and/or 1902 script(s) and can add note, set status, set reminders or alarms, provide rank & priorities.

User can 1971 associate metadata including categories, keywords, author name with one or more or 1905 ([1]-[7]) part(s) of 1902 script(s)

User can 1972 use visual editor for writing, drafting, editing, updating instructions or standardized code syntaxes or text code in graphical or visual mode(s). User can search, match, sort, filter, brose, navigate, explore, select, visually relate, map, link, connect, interact, associate, attach or detach links, define, sequence, order, compare, rank, merge, split, assign, formation, 1973 orchestrate including sequence based on rules & business process, 1974 choreograph, drag and drop, take one or more associate actions & select images, icons, photos, videos of one or more 1910-1930 programming syntax part(s) or elements including named entities, nodes, users, calendar, applications, services, objects, links, locations, places, functions, actions, activities, events, transactions, groups, contacts, connectable users, connections, updated status.

User can 1975 view, manage & access (see FIG. 15 for details) visual physical and/or logical map(s) or presentation(s) of executes or pending to implemented script(s) including past, present & future or planned connections, connected users, associate links, associate connectable users, activities, actions, events, transactions, communications, collaborations, sharing, workflow & tasks based on one or more selected script(s).

User can 1977 Select views type(s) including Tree, Standard, Visual, Explorer, and Graphical.

User can 1978 apply settings for automatically, dynamically and/or manually adding & Updating of instructions at selected or in auto generated script(s) based on past presented connections, connectable users, connected users and associate activities, actions, events, transactions based on posted and/or generated updated status.

User can 1979 apply settings for automatically, dynamically and/or wizard based dynamically generating and/or presenting of dynamic templates.

User can 1976 dynamically generate report(s) including location and/or date & time and/or user(s) and/or associate named entity or entities or user(s) wise logs, activities stream, communications, shared data, comments, reviews, ranks, various types of statistics, transaction details, workflow details, status of workflow & tasks, information or structured data about marketing, e-commerce, selling, purchasing, booking, ordering, request for quotes, bidding, deals, auctions, sales leads based selection of one or more part(s) of scripts, scripts, dates & times, date & time ranges, locations, places, connectable, contacted, connected, suggested, associated or related user(s) or group(s) of users one or more types of activities, actions, events, status, communications, collaborations, searching, matching, sharing, participations, workflows, workspaces, tasks, jobs, procedures, processes, transactions and any combination of thereof.

FIG. 19 (1905 [1]-[7]) illustrates some of the examples including (1905 [1]) instructions or source code or sequence and/or meaningful or interpretable combinations of commands=“When (13 Sep. 2013, 10-4 A.M.)—I am in My office (ABCDE Company, Juhu) Connect Me (Yoegsh Rathod) with My Employees including Marketing Department ([A], [B], [Y])”, wherein compiler interprets instructions or source code in order or in any combinations and identify programming syntax including rules, conditions, commands including when, in, at, on, by, via, if, then, else, case, switch, loops, GoTo, for, do, with, not, without and functions, procedures, routine, method, sub-program, callable unit, statements, function calls, actions & commands including “Connect Me”, “Present”, “Ask for suggestion”, “Notify”, “Provide”, user selections including named entities, nodes of network(s), date & time ranges, location(s), profile fields & value(s), users, objects, items, list items, groups, applications, services, identities and user inputs including text of updated status. For example comelier automatically & in background mode read executed instructions of (1905 [1]) above mentioned example including reads “When < particular date & time> then compiler executes reaming parts of instructions of example (1905 [1]), for example if date & time=“13 Sep. 2013, 10-4 A.M.” then compiler reads next part of instructions of example (1905 [1]), for example “I am in My office (ABCDE Company, Juhu)” and infers that user's updated status=“I am in My office” or “In or at Office” and/or set date & time of user's availability at office and/or identify or detect or recognize user's images or voice from recorded video from connected video camera(s) at office and/or identify or detect or recognize user based on one or more types of sensors, devices, networks & like, If user is in office then compiler reads next part of instructions or source code of example (1905 [1]), for example compiler reads & interprets system or defined or standardized commands, functions or actions syntax “Connect Me” and identifies user, for example “Yogesh Rathod” based on user profile and user identity associate with interface & device or via identity of logging user with system or interface. After that compiler reads next remaining part of instructions or source code of example (1905 [1]), for example “with” and compiler infers or identified that “with” is related or associated with “Connect Me<with>” syntax of standardized system commands and compiler understand that compiler have to read next part of instructions or source code, for example Connect Me (Yoegsh Rathod) with My Employees, wherein “My Employees” is named identities of group(s) of connected users of user and compiler identifies “My Employees” group associated list of sub-groups (e.g. “Marketing Department”) and/or connected users of sub-group(s) (e.g. ([A], [B], [Y])) mentioned or select or input or updated by user. So based on interpretation of executed example (1905 [1]), compiler identified today's date & time, users availability or presence at office, user inputted or selected or preferred command “connect me” i.e. connect user with marketing department including users [A], [B] & [Y]. After establishing connections among them, they can communicate, collaborate, presentations, conduct one or more types of activities, actions, events, transactions, sharing, participations, workflow & tasks with each other based on shared, presented, attached, suggested & provided one or more links of applications, services, objects, interfaces, databases, multimedia types of content(s). User can set status for each set of instructions or commands, for example user set status=“Done” for example (1905 [1]) and provides Note & Comments, system automatically monitors, tracks, logs, recognize, records associate activities, actions, events, transactions, senses, sharing, communications or sharing of contents and stores, processes, formats and present said activity stream to user. User is also enable to to-do one or more users actions including share, add to track or monitor list, refer & suggest on said one or more selected executed or pending to executed set of instructions or commands including for example (1905 [1]-[7]). In another embodiment 1901 user can dynamically add, remove & update source code or instructions, for example 1901 user removes [B] and adds [Z] i.e. updated set of source code or instructions now is “When (13 Sep., 2013, 10-4 A.M.)—I am in My office (ABCDE Company, Juhu) Connect Me (Yoegsh Rathod) with My Employees including Marketing Department ([A], [Y], [Z])”. So compiler dynamically disconnects User [B] and connects User [Z] with 1901 User [Yogesh Rathod].

Similarly in another (1905—[2]) example, when user instructs compiler or interpreter that “[2] When I post Updated Status=“I am reading book of [Superman]” than Connect Me

(Yoegsh Rathod) with My Friends ([L], [A], [N] [0] & [Q]) AND Present Me (IM, Sharing)”, then compiler or interpreter in background mode matches & automatically identifies user status=“I am reading book of [Superman]” and connect 1901 user with user's friends ([L], [A], [N] [0] & [Q]) from list of user's contacts or connections or group(s) or pre-created categories list of connections and present or provide or install to said group of users instant messenger application & sharing application or link or interface or web page or function or button or control(s) for enabling group to send and/or receive instant messages and/or share contents. User can access, use, communicate, share links of user's profile object, nodes, connections, contacts, connectable user, social graph, named entities, applications, services, objects, interfaces, search results, database records, database, items, calendar, groups, web site, web page, controls, forms, lists, multimedia data or contents including text, video, audio, voice, photo, image, graphic, icon, document, file, controls, binary codes or source code, URLs or links, attachments & like.

Similarly in another (1905—[3]) example, when user instructs compiler or interpreter that “[3] When (13 Sep. 2013, 5:00 P.M.)—I post request for connections=“I am viewing [Dancing with star] Serial” than Connect Me (Yoegsh Rathod) with My Serial Group(s) ([W], [H], [J]), then compiler or interpreter on particular date and in background mode reads user request for connections=“I am viewing [Dancing with star] Serial” and matched or determine prospective connections based on request including viewers, producers of “[Dancing with star] Serial” and present prospective or suggested connections to user(s) for enabling user(s) to communicate with them including sending and/or receiving comments, reviews, toughs, shared contents and questions & answers.

Similarly in another (1905—[4]) example, when user instructs compiler or interpreter that “[4] Suggest Me (Yoegsh Rathod) Prospective Connections OR Connectable Users For “Travel in GOA”, then compiler or interpreter searches, matches, determines & presents categories or types of prospective or candidate or matched or updated or contacted or suggested connections or connectable users or entities to user(s) including presenting selected or contextual users who visited in Goa, shops of Goa, Hotels of Goa & travel or travel categories related users or entities.

Similarly in another (1905—[5]) example, when user instructs compiler or interpreter that “[5] When (13 Sep. 2013, 7: 30 P.M.)—I am in Sukh Sagar Restaurant then Connect Me with Admin AND Staffs of Sukh Sagar Restaurant ([P], [Q] & [R]) AND Present to Me (Yoegsh Rathod) Menu, Order, Bill, Feedback & IM of Sukh Sagar Restaurant, then compiler or interpreter based on user's updated status determine that at particular date & time user(s) is/are in “Sukh Sagar Restaurant, Mumbai” and based on unique identity, profile, user data and associated applications of “Sukh Sagar Restaurant” compiler or interpreter connect with user(s) and as per user's instruction present to user applications, services, objects, functions including share, refer, suggest, ask, comment & like, interfaces including interactive menus, links, control including buttons, forms including feedbacks, suggestions & complaints forms & multimedia data or contents provided by “Sukh Sagar Restaurant”.

Similarly in another (1905—[6]) example, when user instructs compiler or interpreter that “[6] I am available for (providing Answers of Queries) AND available on (Chat, Instant Messenger) Between (13 Sep. 2013, 9:00 P.M. to 11:00 P.M.), then compiler or interpreter connects other users with user between 13 Sep. 2013, 9:00 P.M. to 11:00 P.M for asking questions to user for receiving answers from user via chat and/or instant messenger.

Similarly in another (1905—[7]) example, when user instructs compiler or interpreter that “[7] Connect Me with All cloth shops of Mumbai for marketing of [Super Shop Software] AND present to them (Auto Shareable Attached Presentation, IM, Video Call).), then compiler or interpreter connects user or present user as connectable user to/with available or prospective users or entities related to cloth shops of Mumbai for enabling them to connect with user and/or allow to connect user with them based on user(s) profile(s) and presence & availability information.

Similarly in another (1905—[Not shown in figure]) example, when user instructs compiler or interpreter that “[8] If Users of Network(s) Updated Status=“Looking for Smartphone” AND “I want to Purchase Smartphone” than Connect Me 1901 (Yogesh Rathod) and Present My Advertisements & Offers AND IM To Users of Network(s)”, then compiler or interpreter matches all users of networks whose Updated Status comprises “Looking for Smartphone”, “I want to Purchase Smartphone” and similar or contextual or relevant or other matched updated status and present to user 1901 (Yogesh Rathod) and as per instruction of user 1901 (Yogesh Rathod), present & provide advertisements & offers and instant messenger application posted by user 1901 (Yogesh Rathod) to presented or selected users or connectable users or prospective or suggested connections.

Similarly in another (1905—[Not shown in figure]) example, when user instructs compiler or interpreter that “[9] If Connected User [Amita]'s Updated Status=“I am in Mumbai” than Send Me Notification”, then compiler or interpreter checks Updated Status of unique User [Amita] that weather updated status comprises “I am in Mumbai” text and if Updated Status of unique User [Amita] comprises “I am in Mumbai” text then send notification or reminder or alert with pre-configure text or note to user 1901 (Yogesh Rathod).

Similarly in another (1905—[Not shown in figure]) example, when user instructs compiler or interpreter that “[10] If Health Report are updated and/or ranges are not proper then send Health Report to My Doctor [ABC] AND Present (Q & A AND IM)”, then compiler or interpreter in the triggering of event of updating of health report and comparing values & ranges of health report(s), send health report to user specific doctor [ABC] and present question & answers and instant messenger applications to user as well as doctor(s).

Similarly in another (1905—[Not shown in figure]) example, when user instructs compiler or interpreter that “[11] Present Collaborative Account Management Application when Members of Account Department Logged-In and connected”, then compiler or interpreter checks logged in users and connects them and present to them Collaborative Account Management Application.

Similarly in another (1905—[Not shown in figure]) example, when user instructs compiler or interpreter that “[12] When Member(s) of Group [A] are in R-Mall for shopping then Connect Me AND Present to All Voice Call & Chat”, then compiler or interpreter matched updated status of users or members of Group[A] and based on that identifies users who are in R-Mall and their activity type is “Shopping” and connect user with them and present Voice Call & Chat applications to use and them.

Similarly in another (1905—[Not shown in figure]) example, when user instructs compiler or interpreter that “[13] If I Spoke about Brands <List e.g. Nokia> then share to public or connected users including [A], [B] & [T] or related users including [Brand Owner]”, then compiler or interpreter attached or associate devices or sensors or video camera or voice recorder applications monitors, tracks, records, stores user's voice or conversations or talks and convert & process it into text and identifies named entities including brand names, people name, local names and like. Compiler or interpreter checks, matches & identifies brand [Nokia] from set of keywords converted from voice to text and share to connected users or users of network(s) or related users like seller or manufacturer of brands and establishing connections among them and present or provide or share or suggest one or more applications, services, objects, multimedia contents & interfaces for conduction one or more types of activities, actions, events & transactions.

Similarly in another (1905—[Not shown in figure]) example, when user instructs compiler or interpreter that “[14] What I/we or Group [Family] View (via wearable video device(s)) between 13-15 Sep. 2013 share with All Friends”, then compiler or interpreter automatically share or post auto recorded video(s) between 13-15 Sep. 2013 to all friends of user.

Similarly in another (1905—[Not shown in figure]) example, when user instructs compiler or interpreter that “[15] When availability status of users of networks=“Free” and presence information of users of networks=“At Home” then Connect Me and present to all Voice & Video Advertisement(s)”, then compiler or interpreter matches availability status=“Free” and presence information of users of networks=“At Home” of all users of network(s) from 115 server(s) and connect user with them or present user object link or user connection object link at their interface for enabling them to connect with user and present Voice & Video Advertisement(s) to connected users.

Similarly in another (1905—[Not shown in figure]) example, when user instructs compiler or interpreter that “[16] When My Updated Status=“Watching television” Then Connect Me with All Viewers and My Friends and Present IM”, then compiler or interpreter

Connect all users who posted Updated Status=“Watching television” within date & time ranges and/or locations and establish connections among them or enable them to connect with user and present to connected user instant messenger application for sharing comments & reviews of television programmes.

Similarly in another (1905—[Not shown in figure]) example, when user instructs compiler or interpreter that “[17] When Updated Status associate keywords of users of networks who are in Mulund=“Shopping” and Purchased=“ABC Smartphone” Then Connect Me and Present Advertisement and provided service(s)=Answer of Questions related to “Smartphone”, then compiler or interpreter querying database of 115 server(s) for searching & matching users who are from Mulund and whose updated status associate keywords comprises “Shopping” and activity type=purchased and brand or item=“ABC Smartphone” and enables them to connect with user and use user provided or offered services including ask question related to “Smartphone”.

Similarly in another (1905—[Not shown in figure]) example, when user instructs compiler or interpreter that “[18] Present Connections or Connectable Users whose Activity Types=“Purchased”, “Purchasing” & “Want to Purchase”, Participations Types=Share & View Advertisements, Information, Comments & Reviews, Sharing, Video call & Instant Messaging, Locations=Mumbai, New York Dates & Times From 1 Sep. 2013 To 30 Sep. 2013”, then compiler or interpreter searches, matches & identifies users of network(s) whose activity type(s) associate keywords comprises or includes “Purchased”, “Purchasing” & “Want to Purchase” keywords and who are ready to participate for providing and/or receiving information or advertisements, comments, reviews, video calls & instant messages.

In another embodiment 1905 compiler or linker or parser or interpreter or editor or FIG. 19 user interface may connected with plurality types of users, user's connections, social graphs, databases, multimedia types of contents, sources, destinations, automated digital sources and/or destinations, servers, devices, sensors, networks, web sites, smart clients, applications, operating systems, 3^{rd} parties services, web services, objects, functions, user actions objects or links, social networks, groups, profiles, user data from one or more sources, data about user interacted or connected or connectable users or entities and any combination thereof.

In an embodiment programming based on standardized or customized syntax for instructing dynamic connections server(s) to verify, validate, present and/or rectify errors and/or execute sequences of commands or instructions for enabling user(s) or group(s) of user(s) for searching, matching, selecting & presenting prospective connections or contextual connectable users based on one or more types of planned or prospective or suggested updated status, requirements, activities, actions, events, transactions, locations or places and connecting one or more prospective connections or contextual connectable users and search, match, select, present & access one or more links.

In an embodiment a program is written as a series of human understandable computer instructions that can be read by a compiler and linker, and translated into machine code so that a computer can understand and run it. A program is a list of instructions written in a programming language that is used to control the behavior of a machine, often a computer (in this case it is known as a computer program). A programming language's surface form is known as its syntax. Most programming languages are purely textual; they use sequences of text including words, numbers, and punctuation, much like written natural languages. On the other hand, there are some programming languages which are more graphical in nature, using visual relationships between symbols to specify a program. In computer science, the syntax of a computer language is the set of rules that defines the combinations of symbols that are considered to be a correctly structured document or fragment in that language. This applies both to programming languages, where the document represents source code, and markup languages, where the document represents data. The syntax of a language defines its surface form. Text-based computer languages are based on sequences of characters, while visual programming languages are based on the spatial layout and connections between symbols (which may be textual or graphical or flowchart(s)). Documents that are syntactically invalid are said to have a syntax error. Syntax—the form—is contrasted with semantics—the meaning. In processing computer languages, semantic processing generally comes after syntactic processing, but in some cases semantic processing is necessary for complete syntactic analysis, and these are done together or concurrently. In a compiler, the syntactic analysis comprises the frontend, while semantic analysis comprises the backend (and middle end, if this phase is distinguished). There are millions of possible combinations, sequences, ordering, permutations & formations of inputs, interpretations, and outputs or outcomes of set of instructions of standardized or specialized or generalized or structured or functional or object oriented programming language(s).

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Furthermore, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. Additionally, although the foregoing embodiments have been described in the context of a social network website, it will apparent to one of ordinary skill in the art that the invention may be used with any social network service, even if it is not provided through a website. Any system that provides social networking functionality can be used in accordance with the present invention even if it relies, for example, on e-mail, instant messaging or any other form of peer-to-peer communications, or any other technique for communicating between users. Systems used to provide social networking functionality include a distributed computing system, client-side code modules or plug-ins, client-server architecture, a peer-to peer communication system or other systems. The invention is thus not limited to any particular type of communication system, network, protocol, format or application.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

What is claimed is:

1. A system for sharing digital user-originating content via a content sharing platform using a camera-enabled user client mobile device, the system comprising:
a network-accessible storage having stored thereon a plurality of different specifically selectable external content items associated with respective distinct external content sources;
a dedicated client application locally operable on a given camera-enabled user client mobile device of a given user to render a dedicated graphical user interface (GUI) and execute a posting function that invokes a user-originating content selection, integration and posting process, wherein said dedicated GUI comprises:
a dedicated user-originating content selection function that invokes a mobile client camera function of said given user client device through a dedicated GUI preview window to acquire new image or video content therewith as a user-originating content file to be shared by said given user;
a dedicated external content item selection function receiving as input user-selection of a specific external content item distinct from said user-originating content file and selectable by said given user from said plurality of different specifically selectable external content items for being associated with a user-selected one of said distinct respective external content sources as a function of a location of said given user and for visible digital integration within said user-originating content file as a sharable digitally integrated content file, wherein a preview of said sharable digitally integrated content file is rendered in said dedicated preview window as a result of said user-selection to preview said visible digital integration of said selected external content item within said user-originating content file prior to sharing; and
a dedicated sharing function receiving an integrated content file sharing instruction from said given user to share said integrated content file; and
an integration engine operated by a digital data processor to visibly integrate said specific external content item within said user-originating content file to output said sharable digitally integrated content file, wherein said integration engine digitally overlays or embeds said external content item within said user-originating content file; and
an output interface to share said sharable integrated content file via the content sharing platform on behalf of said given user as originating therefrom in response to said dedicated sharing function;
wherein said specific user-selected external content item comprises a specific locally sourced content item selectable by said given user amongst distinctly locally sourced content items corresponding with said location.

2. The system of claim 1, wherein at least one of said plurality of different specifically selectable external content items is associated with a prescribed period defined by a start date and end date, and wherein said at least one of said plurality of different specifically selectable external content items is only selectable as said user-selected external content item as a function of said location during said prescribed period.

3. The system of claim 1, wherein said distinctly locally sourced content items correspond with distinct local enterprises and wherein said specific locally sourced content item corresponds with a specific one of said distinct local enterprises.

4. The system of claim 1, wherein said distinctly locally sourced content items correspond with distinct local brands and wherein said specific locally sourced content item corresponds with a specific one of said distinct local brands.

5. The system of claim 1, wherein said location comprises a city, an area, an address.

6. The system of claim 1, wherein said output interface relays said integrated or packaged content to respective contacts of said given user as defined on the content sharing platform.

7. The system of claim 1, wherein said distinctly locally sourced content items correspond with at least one of distinct local brands or distinct local enterprises, wherein said specific locally sourced external content item corresponds with a specific one of said distinct local brands or distinct local enterprises.

8. A non-transitory computer-readable medium comprising instructions executable by a digital processor of a camera-enabled mobile device to share digital user-originating content from the mobile device via a server-based content sharing platform wherein execution of the instructions by the digital processor causes the processor to carry out the method of:
rendering a dedicated graphical user interface (GUI) on the mobile device to invoke a user content selection, integration and posting process, wherein said dedicated GUI comprises:
a dedicated user content selection function that invokes a mobile client camera function of the mobile device through a dedicated GUI preview window to acquire new content therewith as the user-originating content to be shared via the sharing platform;
a dedicated external content item selection function receiving as input user selection of a specific digital external content item from a plurality of different specifically selectable digital external content items, distinct from the user-originating content, associated with a user location and with respective external content sources, wherein said specific digital external content item is selected for being associated with a user-selected one of said respective external content sources, to be visibly digitally integrated within said user-originating content for sharing as an integrated content item, wherein at least one of said plurality of external content items is selectable as a function of a user location, and wherein said integrated content item is previewed in said dedicated preview window as a result of said user-selection to preview said visible digital integration of said selected external content item within said user-originating content prior to sharing; and
a dedicated sharing function receiving as input an integrated content sharing instruction from the user to share said integrated content item as previewed in said preview window; and
relaying said integrated content sharing instruction to the content sharing platform to share said integrated content item on behalf of the user as originating therefrom;
wherein said specific user-selected external content item comprises a specific locally sourced content item selectable by said given user amongst distinctly locally sourced content items corresponding with said location.

9. The non-transitory computer-readable medium of claim 8, wherein said at least one of said external content items selectable as a function of said user location is further associated with a prescribed period defined by a start date and end date and is only selectable as said specific external content item during said prescribed period.

10. The non-transitory computer-readable medium of claim 8, wherein said distinctly locally sourced content items correspond with at least one of distinct local brands or distinct local enterprises, wherein said specific locally sourced external content item corresponds with a specific one of said distinct local brands or distinct local enterprises.

11. The non-transitory computer-readable medium of claim 8, wherein said integrated content is shared with respective contacts of the user as defined on the content sharing platform.

12. The non-transitory computer-readable medium of claim 8, wherein said specific external content item is overlaid onto or integrated with or embedded within said user-originating content.

13. The non-transitory computer-readable medium of claim 8, wherein said distinctly locally sourced content items correspond with distinct local enterprises and wherein said specific locally sourced content item corresponds with a specific one of said distinct local enterprises.

14. The non-transitory computer-readable medium of claim 8, wherein said distinctly locally sourced content items correspond with distinct local brands and wherein said specific locally sourced content item corresponds with a specific one of said distinct local brands.

15. A server, comprising: an external content module with instructions executed by a processor to: select one or more types of external contents based on one or more factors including location or geolocation of the client device; supply the selected external contents to the client device, wherein the supplied external contents are configured to be independently selectable by a user; receive a selection of one or more of the supplied external contents; and route the one or more selected external contents and the user generated or user created content including photograph to another client device.

16. The server of claim 15 wherein select one or more types of external contents based on one or more factors including suggestion, bookmarks, categories, filters, sharing, rank, auto matchmaking, provided or shared or referred by connected users of user and location or geolocation of the client device.

17. The server of claim 15 wherein integrate or package one or more selected external contents with user generated or user created content including photograph.

18. The server of claim 17 wherein display said integrated or packaged content to another client device.
